(19) United States
(12) Patent Application Publication
(10) Pub. No.: US 2026/0344657 A1
(43) Pub. Date: Nov. 5, 2026

(54) SYSTEMS AND METHODS FOR UTILIZING PHOSPHODIESTERASE-3 INHIBITORS IN EX-VIVO ORGAN PRESERVATION

(71) Applicants: TransMedics, Inc., Andover, MA (US); University of Pittsburgh - Of the Commonwealth System of Higher Education, Pittsburgh, PA (US)

(72) Inventors: Waleed H. HASSANEIN, North Andover, MA (US); Farhan ZAFAR, Andover, MA (US); Omar ELBETANONY, Medford, MA (US); Aya RAOUF, Manchester, NH (US); Garrett HILLARD, Nashua, NH (US); Mohamed ABDULLAH, Pittsburgh, PA (US); David KACZOROWSKI, Pittsburgh, PA (US)

(21) Appl. No.: 19/658,032

(22) Filed: Apr. 24, 2026

Related U.S. Application Data
(60) Provisional application No. 63/795,076, filed on Apr. 25, 2025.

(51) Int. Cl. A01N 1/143; A01N 1/126

(52) U.S. Cl. CPC A01N 1/143; A01N 1/126

(57) ABSTRACT

The invention provides, in various embodiments, systems, devices, and methods relating to ex-vivo organ care. In certain embodiments, the invention relates to maintaining an organ ex-vivo at physiologic or near physiologic conditions, and providing the ex-vivo organ with particular compounds that help improve the functionality and preservation of cells. In certain embodiments, systems, devices, and methods are disclosed related to a perfusion circuit that includes a pump configured to pump a perfusion fluid through an ex-vivo organ; a first interface configured to connect to a first vessel of the ex-vivo organ; and a second interface configured to connect to a second vessel of the ex-vivo organ, wherein the perfusion fluid comprises a PDE3 inhibitor. In some embodiments, the PDE3 inhibitor can be infused into the perfusion fluid at different doses throughout perfusion.

### CROSS-REFERENCE TO RELATED APPLICATIONS

This application claims the benefit under 35 U.S.C. § 119 (e), of provisional application U.S. Ser. No. 63/795,076, filed on Apr. 25, 2025, entitled “SYSTEMS AND METHODS FOR UTILIZING PHOSPHODIESTERASE-3 INHIBITORS IN EX-VIVO ORGAN PRESERVATION,” the entire subject matter of which is incorporated herein by reference.

### FIELD

The invention generally relates to systems, methods, and devices for ex-vivo organ care. In various embodiments, the invention relates to caring for an organ ex-vivo (e.g., heart, lung, liver, kidney) at physiologic or near-physiologic conditions, and providing the ex-vivo organ with particular compounds, especially phosphodiesterase-3 inhibitors (e.g., milrinone), that help improve the functionality and preservation of cells.

### BACKGROUND

Current organ preservation techniques typically involve hypothermic storage of the organ in a chemical perfusate solution on ice. In the case of a heart, it is typically arrested, and cooled with the storage/cardioplegic solution in a hypothermic, non-functioning state. These techniques utilize a variety of cardioplegic solutions, none of which sufficiently protect the heart from myocardial damage resulting from ischemia and edema. Such injuries are particularly undesirable when an organ, such as a heart, is intended to be transplanted from a donor into a recipient. In addition to myocardial damage resulting from ischemia and edema, reperfusion of a heart may exacerbate the myocardial injury and may cause coronary vascular endothelial and smooth muscle injury, which may lead to coronary vasomotor dysfunction.

Using conventional approaches, such injuries increase as a function of the length of time an organ is maintained ex-vivo. For example, in the case of a heart, a lung, a liver, or a kidney, typically it may be maintained ex-vivo for only a few hours before it becomes unusable for transplantation. This relatively brief time period limits the number of recipients who can be reached from a given donor site, thereby restricting the recipient pool for a harvested heart, lung, liver, or kidney. Even within the few hour time limit, the heart, lung, liver, or kidney may nevertheless be significantly damaged. A significant issue is that there may not be any apparent indication of the damage. Because of this, less-than-optimal organs may be transplanted, resulting in post-transplant organ dysfunction or other injuries. Thus, it would be desirable to develop techniques that can extend the time during which an organ (e.g., heart, lung, liver, kidney) can be preserved in a healthy state ex-vivo. Such techniques would reduce the risk of transplantation failure and enlarge potential donor and recipient pools.

Effective preservation of an ex-vivo organ (e.g., heart, lung, liver, kidney) would also provide numerous other benefits. For instance, prolonged ex-vivo preservation would permit more careful monitoring and functional testing of the harvested organ. This would in turn allow earlier detection and potential repair of defects in the harvested organ, further reducing the likelihood of transplantation failure. The ability to perform simple repairs on the organ would also allow many organs with minor defects to be saved, whereas current transplantation techniques require them to be discarded.

In addition, more effective matching between the organ (e.g., heart, lung, liver, kidney) and a particular recipient may be achieved, further reducing the likelihood of eventual organ rejection. Current transplantation techniques rely mainly on matching donor and recipient blood types, which by itself is a relatively unreliable indicator of whether or not the organ will be rejected by the recipient. A more preferred test for organ compatibility is a Human Leukocyte Antigen (HLA) matching test, but current cold ischemic organ preservation approaches preclude the use of this test, which can often require 12 hours or more to complete.

Prolonged and reliable ex-vivo organ care would also provide benefits outside the context of organ transplantation. For example, a patient's body, as a whole, can typically tolerate much lower levels of chemo-, bio- and radiation therapy than many particular organs. An ex-vivo organ care system would permit an organ to be removed from the body and treated in isolation, reducing the risk of damage to other parts of the body.

There exists a need for improved preservation solutions for use with ex-vivo organ care systems to maintain a donor organ in an optimal state for extended periods (e.g., for 12 or more hours). Current ex-vivo organ care systems use continuous infusion of glucose as an energy-rich component for metabolism of ex-vivo organs. However, there exists a need for improved infusion compositions of other energy-rich components, nutritional supplements, and/or therapeutic compounds that have advantageous preservation properties compared to using only glucose.

There also exists a need for a sensitive indicator for determining the status of a donor organ, especially the perfusion status. Lactate, also called lactic acid, is a byproduct/end product of anaerobic metabolism in living cells/tissues/organs. Lactate is generated when there is no or low oxygen in the cell to metabolize glucose for basic energy production through the glycolysis pathway. The measurement of total lactate can be used as an indication of body stress, trauma, injury or some form of hypo-perfusion state. However, there exists a need in methods that allow for ex-vivo perfusion using infusion of optimal energy-source components, nutritional supplements, and/or therapeutic compounds while being able to independently monitor lactate levels for determining the status of a donor organ, such as a heart.

There also exists a need to improve overall organ functionality during preservation. Organs are best preserved in a near-physiologic state, which requires ex-vivo perfusion, such as using an organ care system (OCS). During organ procurement, some degree of ischemic injury is inevitable. From the moment circulation is interrupted, tissues experience a period of oxygen deprivation, while current strategies aim to minimize this damage complete prevention remains unattainable. Therefore, an approach to improving overall organ functionality during the preservation period is needed.

Known organ perfusion systems and their components are disclosed in U.S. Pat. Nos. 8,465,970; 8,304,181; 9,301,519; 9,078,428; and 9,457,179, each of which is incorporated by reference in its entirety herein.

In view of the foregoing, improved systems, methods, and devices for caring for and evaluating the perfusion status of an organ ex-vivo are needed.

### SUMMARY

In one aspect, provided herein is an organ care system comprising a perfusion circuit comprising: a pump configured to pump a perfusion fluid through an ex-vivo organ; a first interface configured to connect to a first vessel of the ex-vivo organ; and a second interface configured to connect to a second vessel of the ex-vivo organ, wherein the perfusion fluid comprises a phosphordiesterase-3 (PDE3) inhibitor. In some embodiments, the ex-vivo organ is an ex-vivo heart.

In another aspect, provided herein is an organ care system comprising a perfusion circuit comprising: a pump configured to pump a perfusion fluid through an ex-vivo heart; a first interface configured to connect to an aorta of the ex-vivo heart; and a second interface configured to connect to a vessel of the ex-vivo heart, wherein the perfusion fluid comprises a phosphordiesterase-3 (PDE3) inhibitor.

In some embodiments, the vessel is a pulmonary artery of the ex-vivo heart.

In some embodiments, the PDE3 inhibitor is enoximone, milrinone, amrinone, cilostamide, cilostazol, anagrelide, trequinsin, an acid thereof, a salt thereof, or a combination thereof.

In some embodiments, the PDE3 inhibitor is milrinone.

In some embodiments, the perfusion fluid comprises the PDE3 inhibitor in an effect amount configured to maintain a concentration of the PDE3 inhibitor at between about 0.3 mg per 100 g of tissue of the ex-vivo heart and about 1 mg per 100 g of tissue of the ex-vivo heart.

In some embodiments, a concentration of the PDE3 inhibitor in the perfusion fluid is between about 0.5 mg/L and about 1.5 mg/L.

In some embodiments, the perfusion fluid further comprises glucose.

In some embodiments, the organ care system further comprises an infusion pump in fluid communication with the perfusion circuit.

In some embodiments, the infusion pump is configured to infuse a first solution comprising the PDE3 inhibitor into the perfusion fluid.

In some embodiments, the infusion pump is configured to infuse the first solution at an infusion rate of between about 0.001 mg/min and about 0.1 mg/min.

In some embodiments, the infusion rate is between about 0.005 mg/min and about 0.015 mg/min.

In some embodiments, a concentration of the PDE3 inhibitor in the first solution is between about 0.25 mg/L and about 1.5 mg/L.

In some embodiments, the concentration of the PDE3 inhibitor in the first solution is between about 0.5 mg/L and about 1.5 mg/L.

In some embodiments, the organ care system further comprises: a first lactate sensor configured to measure a first lactate value at the first interface; a second lactate sensor configured to measure a second lactate value at the second interface; and a processor configured to: calculate a lactate differential using the first lactate value and the second lactate value; and obtain a plurality of lactate differentials by calculating the lactate differential at two different times, wherein the organ care system is configured to use the plurality of lactate differentials to determine a suitability of the ex-vivo heart for transplantation.

In some embodiments, the processor is configured to calculate the lactate differential by subtracting the first lactate value from the second lactate value.

In some embodiments, the processor is configured to calculate the lactate differential at a periodic time interval.

In some embodiments, the periodic time interval is about once per hour or about every 30 minutes.

In some embodiments, the periodic time interval is about once every 30 minutes.

In some embodiments, the organ care system further comprises an aortic pressure sensor configured to measure an aortic pressure of the ex-vivo heart.

In some embodiments, the processor is further configured to: receive at least two aortic pressure measurements from the aortic pressure sensor; and calculate a mean aortic pressure of the ex-vivo heart using the at least two aortic pressure measurements.

In some embodiments, the organ care system is configured to evaluate a coronary vascular patency of the ex-vivo heart using the at least two aortic pressure measurements.

In some embodiments, the organ care system is configured to maintain the mean aortic pressure between about 25 mmHg and about 100 mmHg.

In some embodiments, the organ care system is configured to maintain the mean aortic pressure below 40 mmHg.

In some embodiments, the organ care system further comprises: an aortic pressure sensor configured to measure an aortic pressure of the ex-vivo heart; and the processor is further configured to receive at least two aortic pressure measurements from the aortic pressure sensor, wherein the organ care system is configured to use the plurality of lactate differentials and the at least two aortic pressure measurements to determine the suitability of the ex-vivo heart for transplantation.

In some embodiments, the organ care system further comprises a coronary flow rate sensor configured to measure a coronary flow rate of the ex-vivo heart.

In some embodiments, the processor is further configured to: receive a coronary flow rate measurement from the coronary flow rate sensor.

In some embodiments, the organ care system is configured to maintain the coronary flow rate between about 300 mL/min and 600 mL/min.

In some embodiments, the organ care system is configured to maintain the coronary flow rate between about 400 mL/min and 500 mL/min.

In some embodiments, the organ care system is configured to maintain a target blood level of the PDE3 inhibitor in the ex-vivo heart.

In some embodiments, the target blood level of the PDE3 inhibitor is between about 0.5 mg/L and about 1.5 mg/L.

In some embodiments, the target blood level of the PDE3 inhibitor is between about 0.25 mg/mL and about 1.5 mg/mL.

In some embodiments, the infusion pump is configured to infuse the PDE3 inhibitor for a period of time comprising a first subperiod and a second subperiod, wherein a first dose of PDE3 inhibitor is administered during the first subperiod and a second dose of PDE3 inhibitor is administered during the second subperiod.

In some embodiments, the first dose of PDE3 inhibitor is higher than the second dose of the PDE3 inhibitor.

In some embodiments, the first dose of PDE3 inhibitor is lower than the second dose of PDE3 inhibitor.

In some embodiments, the duration of the first subperiod is the same or longer than the duration of the second subperiod.

In some embodiments, the duration of the first subperiod is the same or shorter than the duration of the second subperiod.

In some embodiments, the pump is configured to pump the perfusion fluid toward the first interface and away from the second interface.

In some embodiments, the pump is configured to pump the perfusion fluid toward the second interface and away from the first interface.

In some embodiments, a measured dP/dt max value of the ex-vivo heart is between about 1000 mmHg/s and about 4000 mmHg/s.

In some embodiments, a measured dP/dt max value of the ex-vivo heart is between about 2000 mmHg/s and about 3000 mmHg/s.

In some embodiments, a measured Tau (t) value of the ex-vivo heart is between about 10 ms and about 80 ms.

In some embodiments, a measured Tau (t) value of the ex-vivo heart is between about 20 ms and about 40 ms.

In some embodiments, the organ care system further comprises a filter.

In some embodiments, the filter filters the PDE3 inhibitor out of the perfusion fluid at a filtration rate between about 0.1 mL/min and about 30 mL/min.

In some embodiments, the filtration rate is between about 5 mL/min and about 15 mL/min.

In some embodiments, a replacement dose of the PDE3 inhibitor is administered to the ex-vivo heart.

In some embodiments, the replacement dose of the PDE3 inhibitor is infused into the perfusion fluid at an infusion rate of between about 0.001 mg/min and about 0.1 mg/min.

In some embodiments, the infusion rate is between about 0.005 mg/min and about 0.015 mg/min.

In some embodiments, the replacement dose of the PDE3 inhibitor is infused at a rate configured to maintain a concentration of the PDE3 inhibitor in the perfusion fluid at between about 0.3 mg per 100 g of tissue of the ex-vivo heart and about 1 mg per 100 g of tissue of the ex-vivo heart.

In some embodiments, the replacement dose of the PDE3 inhibitor is an amount configured to maintain a concentration of the PDE3 inhibitor in the perfusion fluid between about 0.5 mg/L and about 1.5 mg/L.

In one aspect, provided herein is a method of perfusing an ex-vivo organ using an organ care system, the method comprising: placing an ex-vivo organ in an organ chamber assembly; connecting a first vessel of the ex-vivo organ to a first interface of a perfusion circuit; connecting a second vessel of the ex-vivo organ to a second interface of a perfusion circuit; pumping a perfusion fluid comprising a PDE3 inhibitor through the perfusion circuit.

In another aspect, provided herein is a method of perfusing an ex-vivo heart using an organ care system, the method comprising: placing an ex-vivo heart in an organ chamber assembly; connecting an aorta of the ex-vivo heart to a first interface of a perfusion circuit; connecting a vessel of the ex-vivo heart to a second interface of a perfusion circuit; pumping a perfusion fluid comprising a PDE3 inhibitor through the perfusion circuit.

In some embodiments, the vessel is a pulmonary artery of the ex-vivo heart.

In some embodiments, the PDE3 inhibitor is enoximone, milrinone, amrinone, cilostamide, cilostazol, anagrelide, trequinsin, an acid thereof, a salt thereof, or a combination thereof.

In some embodiments, the PDE3 inhibitor is milrinone.

In some embodiments, the method further comprises maintaining a concentration of the PDE3 inhibitor at between about 0.3 mg per 100 g of tissue of the ex-vivo heart and about 1 mg per 100 g of tissue of the ex-vivo heart.

In some embodiments, a concentration of the PDE3 inhibitor in the perfusion fluid is between about 0.5 mg/L and about 1.5 mg/L.

In some embodiments, the method further comprises infusing glucose into the perfusion fluid.

In some embodiments, the method further comprises infusing the PDE3 inhibitor into the perfusion fluid.

In some embodiments, the method further comprises infusing the PDE3 inhibitor into the perfusion fluid at an infusion rate of between about 0.001 mg/min and about 0.1 mg/min.

In some embodiments, the method further comprises infusing the PDE3 inhibitor into the perfusion fluid at an infusion rate of between about 0.005 mg/min and about 0.015 mg/min.

In some embodiments, infusing the PDE3 inhibitor into the perfusion fluid comprises: providing the PDE3 inhibitor in a first solution; and infusing the first solution into the perfusion fluid.

In some embodiments, a concentration of the PDE3 inhibitor in the first solution is between about 0.25 mg/L and about 1.5 mg/L.

In some embodiments, the concentration of the PDE3 inhibitor in the first solution is between about 0.5 mg/L and about 1.5 mg/L.

In some embodiments, the method further comprises: measuring a first lactate value using a first lactate sensor located at the first interface; measuring a second lactate value using a second lactate sensor located at the second interface; calculating, using a processor, a lactate differential based on the first lactate value and the second lactate value; obtaining a plurality of lactate differentials by calculating the lactate differential at two different times; and determining a suitability of the ex-vivo heart for transplantation using the plurality of lactate differentials.

In some embodiments, calculating the lactate differential comprises subtracting the first lactate value from the second lactate value.

In some embodiments, the method further comprises calculating the lactate differential at a periodic time interval.

In some embodiments, the periodic time interval is about once per hour or about every 30 minutes.

In some embodiments, the periodic time interval is about once every 30 minutes.

In some embodiments, the method further comprises measuring an aortic pressure of the ex-vivo heart using an aortic pressure sensor.

In some embodiments, the method further comprises receiving, using the processor, at least two aortic pressure measurements from the aortic pressure sensor; and calculating a mean aortic pressure of the ex-vivo heart using the at least two aortic pressure measurements.

In some embodiments, the method further comprises evaluating a coronary vascular patency of the ex-vivo heart using the at least two aortic pressure measurements.

In some embodiments, the method further comprises maintaining a mean aortic pressure between about 25 mmHg and about 100 mmHg.

In some embodiments, the method further comprises maintaining a mean aortic pressure below about 40 mmHg.

In some embodiments, the method further comprises measuring an aortic pressure of the ex-vivo heart using an aortic pressure sensor; receiving, using the processor, at least two aortic pressure measurements from the aortic pressure sensor; and determining a suitability of the ex-vivo heart for transplantation using the plurality of lactate differentials and the at least two aortic pressure measurements.

In some embodiments, the method further comprises measuring a coronary flow rate of the ex-vivo heart using a coronary flow rate sensor.

In some embodiments, the method further comprises receiving, using the processor, a coronary flow rate measurement from the coronary flow rate sensor.

In some embodiments, the method further comprises maintaining the coronary flow rate between about 300 mL/min and 600 mL/min.

In some embodiments, the method further comprises maintaining the coronary flow rate between about 400 mL/min and 500 mL/min.

In some embodiments, the method further comprises maintaining a target blood level of the PDE3 inhibitor in the ex-vivo heart.

In some embodiments, the target blood level of the PDE3 inhibitor is between about 0.5 mg/L and about 1.5 mg/L.

In some embodiments, the target blood level of the PDE3 inhibitor is between about 0.5 mg/mL and about 1 mg/mL.

In some embodiments, the method further comprises infusing the PDE3 inhibitor for a period of time comprising a first subperiod and a second subperiod, wherein a first dose of PDE3 inhibitor is administered during the first subperiod and a second dose of PDE3 inhibitor is administered during the second subperiod.

In some embodiments, the first dose of PDE3 inhibitor is higher than the second dose of the PDE3 inhibitor.

In some embodiments, the first dose of PDE3 inhibitor is lower than the second dose of PDE3 inhibitor.

In some embodiments, the duration of the first subperiod is the same or longer than the duration of the second subperiod.

In some embodiments, the duration of the first subperiod is the same or shorter than the duration of the second subperiod.

In some embodiments, pumping the perfusion fluid through the perfusion circuit comprises pumping the perfusion fluid toward the second interface and away from the first interface.

In some embodiments, pumping the perfusion fluid through the perfusion circuit comprises pumping the perfusion fluid toward the second interface and away from the first interface.

In some embodiments, the method further comprises measuring a dP/dt max value of the ex-vivo heart; and maintaining the dP/dt max value at between about 1000 mmHg/s and about 4000 mmHg/s by adjusting an amount of the PDE3 inhibitor in the perfusion fluid.

In some embodiments, the method further comprises measuring a dP/dt max value of the ex-vivo heart; and maintaining the dP/dt max value at between about 2000 mmHg/s and about 3000 mmHg/s by adjusting an amount of the PDE3 inhibitor in the perfusion fluid.

In some embodiments, the method further comprises: measuring a Tau (t) value of the ex-vivo heart; and maintaining the Tau (t) value at between about 10 ms and about 80 ms by adjusting an amount of the PDE3 inhibitor in the perfusion fluid.

In some embodiments, the method further comprises: measuring a Tau (t) value of the ex-vivo heart; and maintaining the Tau (t) value at between about 20 ms and about 40 ms by adjusting an amount of the PDE3 inhibitor in the perfusion fluid.

In some embodiments, the method further comprises filtering the PDE3 inhibitor out of the perfusion fluid.

In some embodiments, the method further comprises filtering the PDE3 inhibitor out of the perfusion fluid at a filtration rate between about 0.1 mL/min and about 30 mL/min.

In some embodiments, the filtration rate is between about 5 mL/min and about 15 mL/min.

In some embodiments, the method further comprises administering a replacement dose of the PDE3 inhibitor to the ex-vivo heart.

In some embodiments, the replacement dose of the PDE3 inhibitor is infused into the perfusion fluid at an infusion rate of between about 0.001 mg/min and about 0.1 mg/min.

In some embodiments, the infusion rate is between about 0.005 mg/min and about 0.015 mg/min.

In some embodiments, the method further comprises administering the replacement dose of the PDE3 inhibitor by infusing into the perfusion fluid at a rate configured to maintain a concentration of the PDE3 inhibitor in the perfusion fluid at between about 0.3 mg per 100 g of tissue of the ex-vivo heart and about 1 mg per 100 g of tissue of the ex-vivo heart.

In some embodiments, the method further comprises administering the replacement dose of the PDE3 inhibitor by infusing into the perfusion fluid at a rate configured to maintain a concentration of the PDE3 inhibitor in the perfusion fluid between about 0.5 mg/L and about 1.5 mg/L.

In one aspect, provided herein is a method of perfusing an ex-vivo heart using an organ care system, the method comprising: pumping a perfusion fluid through a perfusion circuit, wherein the perfusion circuit comprises: a first interface configured to connect to an aorta of an ex-vivo heart; and a second interface configured to connect to a vessel of the ex-vivo heart; and infusing a PDE3 inhibitor into the perfusion fluid.

In some embodiments, the vessel is a pulmonary artery of the ex-vivo heart.

In one aspect, provided herein is an organ care system comprising: a perfusion circuit comprising a pump configured to pump a perfusion fluid through an ex-vivo organ; a first interface configured to connect to a first vessel of the ex-vivo organ; and a second interface configured to connect to a second vessel of the ex-vivo organ, wherein the perfusion fluid comprises a phosphordiesterase-3 (PDE3) inhibitor.

In some embodiments, the ex-vivo organ is an ex-vivo heart, an ex-vivo lung, is an ex-vivo liver, is an ex-vivo kidney.

In some embodiments, the PDE3 inhibitor is enoximone, milrinone, amrinone, cilostamide, cilostazol, anagrelide, trequinsin, an acid thereof, a salt thereof, or a combination thereof.

In some embodiments, the PDE3 inhibitor is milrinone.

In some embodiments, the perfusion fluid comprises the PDE3 inhibitor in an effect amount configured to maintain a concentration of the PDE3 inhibitor at between about 0.3 mg per 100 g of tissue of the ex-vivo organ and about 1 mg per 100 g of tissue of the ex-vivo organ.

In some embodiments, a concentration of the PDE3 inhibitor in the perfusion fluid is between about 0.5 mg/L and about 1.5 mg/L.

In some embodiments, the perfusion fluid further comprises glucose.

In some embodiments, the organ care system further comprises an infusion pump in fluid communication with the perfusion circuit.

In some embodiments, the infusion pump is configured to infuse a first solution comprising the PDE3 inhibitor into the perfusion fluid.

In some embodiments, the infusion pump is configured to infuse the first solution at an infusion rate of between about 0.125 mL/hr and about 0.67 mL/hr.

In some embodiments, the organ care system further comprises: a first lactate sensor configured to measure a first lactate value at the first interface; a second lactate sensor configured to measure a second lactate value at the second interface; and a processor configured to: calculate a lactate differential using the first lactate value and the second lactate value; and obtain a plurality of lactate differentials by calculating the lactate differential at two different times, wherein the organ care system is configured to use the plurality of lactate differentials to determine a suitability of the ex-vivo organ for transplantation.

In some embodiments, the processor is configured to calculate the lactate differential by subtracting the first lactate value from the second lactate value.

In some embodiments, the processor is configured to calculate the lactate differential at a periodic time interval.

In some embodiments, the periodic time interval is about once per hour or about every 30 minutes.

In some embodiments, the periodic time interval is about once every 30 minutes.

In some embodiments, the organ care system is configured to maintain a target blood level of the PDE3 inhibitor in the ex-vivo organ.

In some embodiments, the target blood level of the PDE3 inhibitor is between about 0.05 mg/L and about 1.5 mg/L.

In some embodiments, the target blood level of the PDE3 inhibitor is between about 0.25 mg/mL and about 1.5 mg/mL.

In one aspect, provided herein is a method of perfusing an ex-vivo organ using an organ care system, the method comprising: placing an ex-vivo organ in an organ chamber assembly; connecting a first vessel of the ex-vivo organ to a first interface of a perfusion circuit; connecting a second vessel of the ex-vivo organ to a second interface of a perfusion circuit; pumping a perfusion fluid comprising a PDE3 inhibitor through the perfusion circuit.

In some embodiments, the ex-vivo organ is an ex-vivo heart, is an ex-vivo lung, is an ex-vivo liver, or is an ex-vivo kidney.

In some embodiments, the PDE3 inhibitor is enoximone, milrinone, amrinone, cilostamide, cilostazol, anagrelide, trequinsin, an acid thereof, a salt thereof, or a combination thereof.

In some embodiments, the PDE3 inhibitor is milrinone.

In some embodiments, the perfusion fluid comprises the PDE3 inhibitor in an effect amount configured to maintain a concentration of the PDE3 inhibitor at between about 0.3 mg per 100 g of tissue of the ex-vivo organ and about 1 mg per 100 g of tissue of the ex-vivo organ.

In some embodiments, a concentration of the PDE3 inhibitor in the perfusion fluid is between about 0.5 mg/L and about 1.5 mg/L.

In some embodiments, the perfusion fluid further comprises glucose.

In some embodiments, the method further comprises infusing, using a infusion pump, a first solution comprising the PDE3 inhibitor into the perfusion fluid.

In some embodiments, the infusion pump is configured to infuse the first solution at an infusion rate of between about 0.125 mL/hr and about 0.67 mL/hr.

In some embodiments, the method further comprises: measuring a first lactate value using a first lactate sensor located at the first interface; measuring a second lactate value using a second lactate sensor located at the second interface; calculating, using a processor, a lactate differential based on the first lactate value and the second lactate value; obtaining a plurality of lactate differentials by calculating the lactate differential at two different times; and determining a suitability of the ex-vivo organ for transplantation using the plurality of lactate differentials.

In some embodiments, the processor is configured to calculate the lactate differential by subtracting the first lactate value from the second lactate value.

In some embodiments, the processor is configured to calculate the lactate differential at a periodic time interval.

In some embodiments, the periodic time interval is about once per hour or about every 30 minutes.

In some embodiments, the periodic time interval is about once every 30 minutes.

In some embodiments, the organ care system is configured to maintain a target blood level of the PDE3 inhibitor in the ex-vivo organ.

In some embodiments, the target blood level of the PDE3 inhibitor is between about 0.05 mg/L and about 1.5 mg/L.

In some embodiments, the target blood level of the PDE3 inhibitor is between about 0.25 mg/mL and about 1.5 mg/mL.

### BRIEF DESCRIPTION OF THE DRAWINGS

The following figures depict illustrative embodiments of the invention in which reference numerals refer to like elements. These depicted embodiments may not be drawn to scale and are to be understood as illustrative of the invention and not as limiting, the scope of the invention instead being defined by the appended claims.

FIG. 1 is a schematic diagram of a portable organ care system according to an illustrative embodiment of the invention.

FIG. 2 is a diagram depicting a harvested heart.

FIG. 3 is a conceptual diagram depicting the harvested heart of FIG. 2 interconnected with the organ care system of FIG. 1 in a normal flow mode configuration according to an illustrative embodiment of the invention.

FIG. 4 is a conceptual diagram depicting the harvested heart of FIG. 2 interconnected with the organ care system of FIG. 1 in a retrograde flow mode configuration according to an illustrative embodiment of the invention.

FIG. 5 depicts an illustrative diagram of a harvested heart of FIG. 2 connected to exemplary components of an organ care system.

FIG. 6 depicts a block diagram of an illustrative control scheme for controlling operation of the organ care system of FIG. 1.

FIG. 7 is a block diagram of an exemplary data acquisition subsystem of the type that may be employed with an illustrative organ care system of FIG. 1.

FIG. 8 is a block diagram of an exemplary pumping control subsystem of the type that may be employed for controlling operation of a perfusion fluid pump assembly in the illustrative organ care system of FIG. 1.

FIG. 9 is a graph depicting an r-wave with which the pumping control subsystem of FIG. 8 synchronizes according to an illustrative embodiment of the invention.

FIG. 10 depicts an exemplary display screen of the type that may be employed with an operator interface according to an illustrative embodiment of the invention.

FIGS. 11A and 11B show an exemplary implementation of the system of FIG. 1 according to an illustrative embodiment of the invention.

FIGS. 12A-12C show various views of the system of FIGS. 11A and 11B with its top off and front panel open according to an illustrative embodiment of the invention.

FIGS. 13A-13E show various top perspective views of a single use disposable module according to an illustrative embodiment of the invention.

FIGS. 14A-14C show various bottom perspective views of the illustrative single use disposable module of FIGS. 13A-13D.

FIGS. 15A-15C show various views of an exemplary hematocrit and oxygen saturation sensor of the type employed in the illustrative single use disposable module of FIGS. 12A-12C.

FIGS. 16-21 show various views of a single use disposable module according to an illustrative embodiment of the invention.

FIG. 22 shows exemplary heart chamber latches of a single use disposable module according to an illustrative embodiment of the invention.

FIG. 23 shows exemplary heart chamber ECG/Defib binding posts and wiring of a single use disposable module according to an illustrative embodiment of the invention.

FIG. 24 shows an exploded view of an exemplary solution delivery system (SDS).

FIGS. 25A-D show different views of a housing of a mechanical implementation of the system of FIG. 1, according to illustrative embodiments of the invention.

FIGS. 26A-B are flow diagrams depicting a donor-side process for removing an organ from a donor and placing it into the organ care system of FIG. 1 according to an illustrative embodiment of the invention.

FIG. 26C is a diagram depicting a harvested heart with suture and cannulation sites according to an illustrative embodiment of the invention.

FIG. 27 is a flow diagram depicting a recipient-side process for removing an organ from the organ care system of FIG. 1 and transplanting it into a recipient according to an illustrative embodiment of the invention.

FIG. 28 depicts a chart demonstrating electrolyte stability for an organ undergoing perfusion in forward mode according to an embodiment of the invention.

FIG. 29 depicts a chart demonstrating electrolyte stability for an organ undergoing perfusion in retrograde mode according to another embodiment of the invention.

FIG. 30 depicts a chart demonstrating the arterial blood gas profile for an organ undergoing perfusion according to an embodiment of the invention.

FIG. 31 depicts a chart demonstrating adequate perfusion in a transplant organ.

FIG. 32 depicts a chart demonstrating inadequate perfusion in a transplant organ.

FIG. 33 depicts an illustrative diagram of an ex-vivo lung connected to exemplary components of an organ care system

FIG. 34 is a schematic diagram of a lung perfusion circuit of an embodiment.

FIG. 35 is an illustration of an organ care system drawn from a 45-degree angle from the front view, according to an embodiment.

FIG. 36 is an illustration of the lung perfusion module, according to an embodiment.

FIG. 37 is an exploded illustration of the lung chamber, according to an embodiment.

FIG. 38 is a schematic diagram of an embodiment of a portable organ care system including the gas-related components of the lung perfusion module.

FIG. 39 is a schematic diagram of the perfusion circuit and the ventilation circuit of an ex-vivo lung perfusion system.

FIG. 40 is an illustrative diagram of an ex-vivo liver connected to exemplary components of an organ care system.

FIG. 41 shows an exemplary system that can be used within an embodiment of the organ care system for liver.

FIG. 42A shows an exemplary organ care system for liver and components thereof.

FIGS. 42B-G shows another exemplary organ care system for liver and components thereof.

FIG. 43 illustrates a schematic diagram of an exemplary organ care system for a kidney (OCS Kidney).

FIG. 44A illustrates an exterior appearance of an exemplary OCS for kidney.

FIG. 44B illustrates an exemplary perfusion module for use in an OCS for kidney.

FIG. 44C illustrates exemplary components of the perfusion module in FIG. 64B.

FIG. 44D illustrates an exemplary console for use in an OCS for kidney.

FIG. 44E illustrates a portion of the exemplary components of the console in FIG. 2D.

FIG. 45A illustrates a perspective view of a perfusion circuit for use in an OCS for kidney.

FIG. 45B illustrates a top view of a perfusion circuit for use in an OCS for kidney.

FIG. 45C illustrates a side view from the right of a perfusion circuit for use in an OCS for kidney.

FIG. 45D illustrates a front view of a perfusion circuit for use in an OCS for kidney.

FIG. 46 depicts the dP/dt max values (mmHg/s) for hearts perfused using a perfusion fluid without milrinone (“w/out MIL”) or with milrinone (“w/MIL”) before the hearts were explanted (“In-situ”), at 30-minutes of perfusion (0030 PT), and at 6-hours of perfusion (0600 PT).

FIG. 47 depicts the Tau values (ms) for hearts perfused using a perfusion fluid without milrinone (“w/out MIL”) (“OCS”) or with milrinone (“w/MIL”) before the hearts were explanted (“In-situ”), at 30-minutes of perfusion (0030 PT), and at 6-hours of perfusion (0600 PT).

### DESCRIPTION

U.S. Pat. Nos. 8,304,181 and 8,465,970 describe systems and methods for ex-vivo organ care and are incorporated by reference herein in their entireties.

When PDE3 inhibitors are administered in vivo, there are undesired effects of the PDE3 inhibitors (e.g., milrinone) on the peripheral vascular system causing, for example, unwanted hemodynamic instability and vasoplegia. This limits the use of PDE3 inhibitors in vivo to a very low dose that is incapable of providing the full benefits of functional improvement and reduction to ischemia-reperfusion injury. Surprisingly, as described herein, the PDE3 inhibitor improves ex-vivo organ preservation even at doses that could be harmful if administered to an organ (e.g., heart, lung, liver, kidney) in-vivo.

Described herein are improved approaches to ex-vivo organ care, organ preservation and overall functionality during ex-vivo perfusion. More particularly, in various embodiments, the invention is directed to improved systems, methods and devices relating to maintaining or improving the overall functionality of an organ, for example an ex-vivo heart, ex-vivo lung, ex-vivo liver, or ex-vivo kidney, in an ex-vivo portable environment by administering a phosphordiesterase-3 (PDE3) inhibitor (e.g., milrinone). In some embodiments, the PDE3 inhibitor is administered by circulating a perfusion fluid that includes a PDE3 inhibitor in a perfusion circuit of an ex-vivo organ care system. In some embodiments, the PDE3 inhibitor is administered by including the PDE3 inhibitor in a priming solution used to prime the organ care system prior to instrumenting an ex-vivo organ, preferably a heart, a lung, a liver, or a kidney, onto the organ care system. In some embodiments, the PDE3 inhibitor is administered by including the PDE3 inhibitor in a priming solution and then infusing additional amounts of the PDE3 inhibitor into the perfusion fluid after instrumenting an ex-vivo organ (e.g., heart, lung, liver, kidney) into an organ care system to maintain PDE3 inhibitor at target blood concentration levels. According to one improvement, the organ preservation system of the invention maintains an ex-vivo organ viable at or near normal physiological conditions. To this end, the system circulates an oxygenated, nutrient enriched perfusion fluid comprising a PDE3 inhibitor to the organ at near physiological temperature, pressure and flow rate. According to another improvement, the organ preservation system of the invention maintains an ex-vivo heart beating at or near normal physiological conditions. To this end, the system circulates an oxygenated, nutrient enriched perfusion fluid comprising a PDE3 inhibitor to the heart at near physiological temperature, pressure and flow rate.

In some embodiments, a PDE3 inhibitor is administered to an ex-vivo organ (e.g., heart, lung, liver, kidney) to modulate vascular tone and improve microcirculatory perfusion within the organ tissue. In some embodiments, the PDE3 inhibitor administered to the ex-vivo organ increases intracellular cyclic adenosine monophosphate (cAMP) levels, thereby promoting smooth muscle relaxation and vasodilation within arterial, venous, or microvascular structures of the ex-vivo organ. In some embodiments, the PDE3 inhibitor administered to the ex-vivo organ improves oxygen and nutrient delivery by reducing vascular resistance and enhancing capillary flow. In some embodiments, the PDE3 inhibitor administered to the ex-vivo organ reduces ischemia-reperfusion injury by attenuating endothelial dysfunction and inflammatory signaling pathways. In some embodiments, the PDE3 inhibitor administered to the ex-vivo organ preserves organ function by mitigating edema formation, cellular hypoxia, or metabolic stress. In some embodiments, the PDE3 inhibitor administered to the ex-vivo organ is delivered continuously or intermittently via a perfusion fluid circulating through an ex-vivo organ care system. In some embodiments, administration of the PDE3 inhibitor to the ex-vivo organ improves suitability of the organ for transplantation. In some embodiments, the PDE3 inhibitor is included in a priming solution used to prime the organ care system prior to instrumentation of the organ (e.g., heart, lung, liver, kidney). Utilizing PDE3 inhibitors for ex-vivo organ preservation is novel.

In some embodiments, a PDE3 inhibitor administered to an ex-vivo heart has dual vasodilatory and inotropic effects. In some embodiments, a PDE3 inhibitor acts as vasodilator widening blood vessels, increases left ventricular filling pressure, and alleviates high perfusion pressure during ex-vivo perfusion. In some embodiments, administration of the PDE3 inhibitor to an ex-vivo heart provides benefits including improving the heart's ability to pump blood and contractility of the heart muscle by increasing cyclic adenosine monophosphate (cAMP). Besides its direct impact on heart function, increased cAMP also prevents ischemia-reperfusion injury by reducing vascular resistance and improving microvascular permeability. In some embodiments, administration of the PDE3 inhibitor to an ex-vivo heart reduces pulmonary artery pressures, pulmonary capillary wedge pressure, and pulmonary vascular resistance; and facilitates hemodynamic stability. Utilizing PDE3 inhibitors for ex-vivo organ preservation is novel.

According to one implementation, the system employs a perfusion fluid solution, into which a PDE3 inhibitor is infused, that more accurately mimics normal physiologic conditions. In another embodiment, the PDE3 inhibitor is included in the priming solution used to prime the organ care system prior to instrumentation of the organ (e.g., heart, lung, liver, kidney). In some embodiments, once the organ is instrumented, there is sufficient supply of the PDE3 inhibitor that was in the priming solution to maintain the benefits of the PDE3 inhibitor throughout the duration of the organ perfusion.

In one embodiment, the perfusion fluid is blood-product based. In alternative embodiments, the solution is synthetic blood substitute based. In other embodiments the solution may contain a blood product in combination with a blood substitute product.

In some embodiments, the PDE3 inhibitor is infused intermittently or continuously into the perfusion fluid for administration to the ex-vivo organ. In some embodiments, the PDE3 inhibitor is infused at different doses throughout perfusion. For example, the PDE3 inhibitor can be infused at a given dose for a period of time during perfusion and then the dose can be increased or decreased for a second period of time during perfusion. In some embodiments, two or more different doses of the PDE3 inhibitor can be infused into the perfusion fluid throughout the duration of organ perfusion. In some embodiments, perfusion is maintained at a given dose of the PDE3 inhibitor and prior to the end of perfusion, a higher dose is infused prior to disconnecting the organ (e.g., heart, lung, liver, kidney) from the organ care system for transplantation into a recipient. In some embodiments, providing a higher dose of the PDE3 inhibitor immediately prior to disconnecting the organ from the organ care system can provide advantages to organ function to the recipient.

In some embodiments, the PDE3 inhibitor (e.g., milrinone) is added to the perfusate prior to instrumenting the organ (e.g., heart, lung, liver, kidney). In some embodiments, a desired dose of the PDE3 inhibitor is delivered to the organ as it is re-perfused post-ischemia. In some embodiments, the desired dose of the PDE3 inhibitor is optimized for ex-vivo perfusion. In some embodiments, the desired dose of the PDE3 inhibitor is between about 0.3 mg per 100 g of organ tissue and about 1 mg per 100 g of organ tissue. In some embodiments, no replacement dose of the PDE3 inhibitor is infused for the duration of the preservation. In some embodiments, the PDE3 inhibitor is filtered by the organ care system (e.g., by a filter in the perfusion circuit of the organ care system). In some embodiments, a replacement dose of the PDE3 inhibitor is infused based on the filtration rate. In some embodiments, the PDE3 inhibitor is continuously infused at a one-to-one replacement ratio (i.e., replaced at the same rate that the PDE3 inhibitor is being filtered out at).

In some embodiments, the PDE3 inhibitor increases the strength of the ex-vivo heart's muscles. In some embodiments, the PDE3 inhibitor improves the ex-vivo heart's contractility. In some embodiments, the PDE3 inhibitor acts as a vasodilator. In some embodiments, the PDE3 inhibitor widens the ex-vivo heart's blood vessels. In some embodiments, the PDE3 inhibitor alleviates high perfusion pressure during ex-vivo perfusion. In some embodiments, the PDE3 inhibitor allows safe preservation of the ex-vivo heart for at least 6 hours. In some embodiments, the PDE3 inhibitor allows safe preservation of the ex-vivo heart for at least 24 hours. In some embodiments, the PDE3 inhibitor acts as an inotropic agent for the ex-vivo heart's muscles.

In some embodiments, the PDE3 inhibitor administered to an ex-vivo lung reduces pulmonary vascular resistance. In some embodiments, the PDE3 inhibitor improves pulmonary vasodilation within the ex-vivo lung. In some embodiments, the PDE3 inhibitor widens pulmonary blood vessels of the ex-vivo lung to enhance microvascular perfusion. In some embodiments, the PDE3 inhibitor alleviates elevated pulmonary perfusion pressure during ex-vivo lung perfusion. In some embodiments, the PDE3 inhibitor reduces endothelial dysfunction and vascular leak during ex-vivo perfusion. In some embodiments, the PDE3 inhibitor allows safe preservation of the ex-vivo lung.

In some embodiments, the PDE3 inhibitor administered to an ex-vivo liver improves hepatic perfusion. In some embodiments, the PDE3 inhibitor promotes vasodilation within hepatic arterial and sinusoidal vasculature of the ex-vivo liver. In some embodiments, the PDE3 inhibitor widens hepatic blood vessels to enhance microcirculatory flow through hepatic sinusoids. In some embodiments, the PDE3 inhibitor alleviates elevated perfusion pressure during ex-vivo liver perfusion. In some embodiments, the PDE3 inhibitor improves oxygen and nutrient delivery to hepatocytes during ex-vivo perfusion. In some embodiments, the PDE3 inhibitor reduces ischemia-reperfusion injury and endothelial dysfunction within the ex-vivo liver. In some embodiments, the PDE3 inhibitor allows safe preservation of the ex-vivo liver.

In some embodiments the PDE3 inhibitor administered to an ex-vivo kidney improves renal blood flow. In some embodiments, the PDE3 inhibitor promotes vasodilation of renal arterial and microvascular structures within the ex-vivo kidney. In some embodiments, the PDE3 inhibitor widens renal blood vessels to enhance cortical and medullary perfusion. In some embodiments, the PDE3 inhibitor alleviates elevated perfusion pressure during ex-vivo kidney perfusion. In some embodiments, the PDE3 inhibitor improves preservation of glomerular and tubular function during ex-vivo perfusion. In some embodiments, the PDE3 inhibitor reduces ischemic injury and metabolic stress within the ex-vivo kidney. In some embodiments, the PDE3 inhibitor allows safe preservation of the ex-vivo kidney.

According to various illustrative embodiments, the improvements of the invention enable an organ, such as a heart, a lung, a liver, or a kidney, to be maintained ex-vivo for extended periods of time, for example, exceeding 3, 4, 5, 6, 8, 10, 12, 14, 16, 18, 20, 22, 24 or more hours. Such extended ex-vivo maintenance times expand the pool of potential recipients for donor organs, making geographical distance between donors and recipients less important. Extended ex-vivo maintenance times of the invention also provide the time needed for better genetic and HLA matching between donor organs and organ recipients, increasing the likelihood of a favorable outcome. The ability to maintain the organ in a near physiologic functioning condition also enables a clinician to evaluate the organ's function ex-vivo, further increasing the likelihood of transplantation success. In some instances, the extended maintenance time enables medical operators to perform repairs on donor organs with minor defects. According to another advantage, the increased ex-vivo organ maintenance times of the invention enable an organ to be removed from a patient, treated in isolation ex-vivo, and then put back into the body of a patient. Such treatment may include, without limitation, surgical treatments, chemo-, bio-, gene and/or radiation therapies.

### Exemplary Heart Organ Care System (OCS)

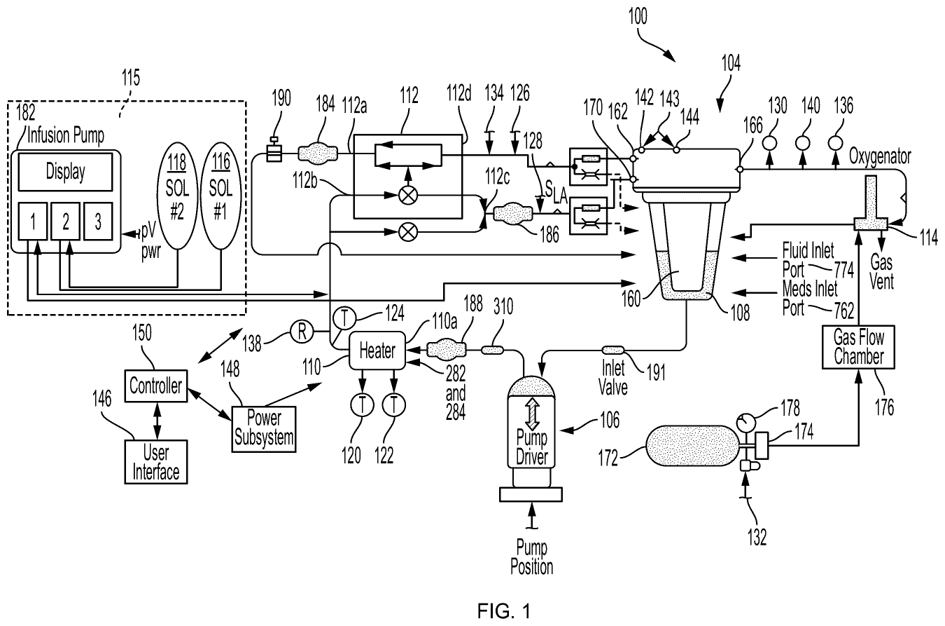

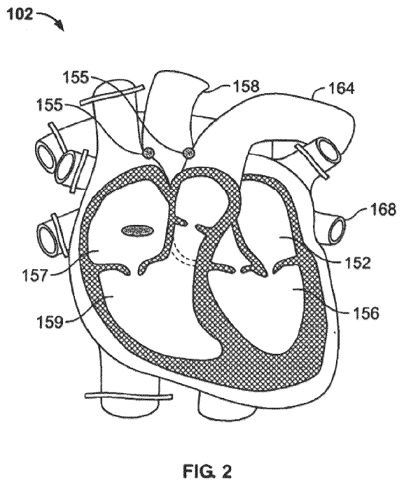

Turning to the illustrative embodiments, FIG. 1 depicts a schematic diagram of a portable organ care system 100 according to an illustrative embodiment of the invention. FIG. 2 shows a conceptual drawing of a heart 102, which may be preserved/maintained ex-vivo by the organ care system 100 of the invention. Referring to FIGS. 1 and 2, the illustrative system 100 includes an organ chamber assembly 104 for containing the heart 102 during ex-vivo maintenance, a reservoir 160 for holding, defoaming and filtering the perfusion fluid 108, portal 774 for loading perfusion fluid 108 into the reservoir 160 and a portal 762 for applying therapeutics to the fluid 108 contained in the reservoir 160, a perfusion fluid pump 106 for pumping/circulating perfusion fluid 108 to and from the harvested heart 102; a heater assembly 110 for maintaining the temperature of the perfusion fluid 108 at or near physiological temperatures; a flow mode selector valve 112 for switching between normal and retrograde aortic flow modes (also referred to as “normal flow mode” and “retrograde flow mode,” respectively); an oxygenator 114 for re-oxygenating the perfusion fluid 108 subsequent to it being expelled by the heart 102; a nutritional subsystem 115 for replenishing nutrients 116 (e.g., glucose) in the perfusion fluid 108 as they are metabolized by the heart 102 and for providing additional preservatives 118 to the perfusion fluid to reduce, for example, ischemia and/or other re-perfusion related injuries to the heart 102. In some embodiments, nutritional subsystem 115 can also replenish other components, such as a PDE3 inhibitor, or other therapeutic/pharmaceutical compounds. The illustrative system 100 also includes a plurality of sensors, including without limitation: temperature sensors 120, 122 and 124; pressure sensors 126, 128, 130 and 132; perfusion flow rate sensors 134, 136 and 138; a perfusion fluid oxygenation sensor 140; and sensor electrodes 142 and 144, and defibrillation source 143. In some embodiments, flow rate sensor 134 measures the aortic flow rate, pressure sensor 126 measures the aortic pressure, pressure sensor 130 measures the pulmonary artery pressure, and the flow rate sensor 136 measures the pulmonary artery flow or coronary flow. The system 100 further includes: various components employed for maintaining suitable flow conditions to and from the heart 102; an operator interface 146 for assisting an operator in monitoring operation of the system 100, and the condition of the heart 102, and for enabling the operator to select various operating parameters; a power subsystem 148 for providing fault tolerant power to the system 100; and a controller 150 for controlling operation of the organ care system 100.

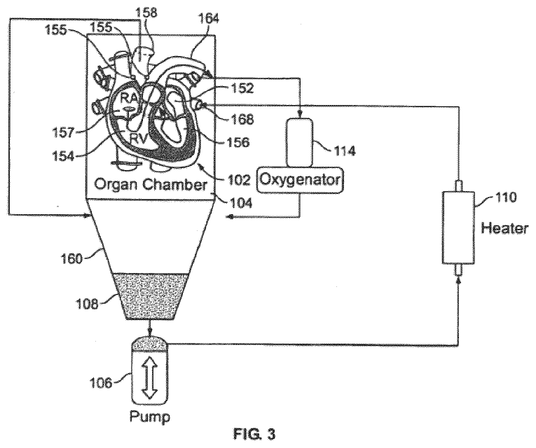

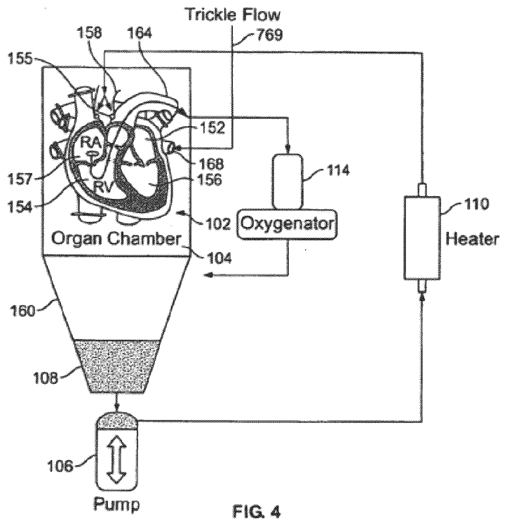

Referring also to FIGS. 3 and 4, according to the illustrative embodiment, the system 100 can maintain the heart 102 in two modes of operation—a normal flow mode, shown in FIG. 3, and a retrograde flow mode shown in FIG. 4. In some embodiments, normal flow mode is used during priming with a solution that includes a PDE3 inhibitor or during infusion of a PDE3 inhibitor into the perfusion fluid 108 after a heart has been instrumented onto the organ care system. In some embodiments, retrograde flow mode is used during priming with a solution that includes a PDE3 inhibitor or during infusion of a PDE3 inhibitor into the perfusion fluid 108 after a heart has been instrumented onto the organ care system. Generally, in the normal flow mode of FIG. 3, the system 100 circulates the perfusion fluid 108 to the heart 102 in the same manner as blood would circulate in the human body. More particularly, referring to FIGS. 1-3, the perfusion fluid enters the left atrium 152 of the heart 102 via the pulmonary vein 168. The perfusion fluid 108 is flowed away from the right ventricle 154 via the pulmonary artery 164 and away from the left 156 ventricle via the aorta 158. In normal flow mode, the system 100 pumps the perfusion fluid to the heart 102 at a near physiological rate of between about 1 liter/min and about 5 liters/minute. This mode is useful, for example, for performing functional testing to verify that the heart 102 is defect free, both prior and subsequent to transportation to a donor location.

In another embodiment of a flow mode, the system 100 circulates the perfusion fluid 108 to the heart 102 via the pulmonary artery. In this embodiment, the heart 102 is cannulated at the aorta and pulmonary artery, but not at the pulmonary vein. In this embodiment, pump 106 pumps the perfusion fluid 108 into pulmonary artery interface 166 and into the pulmonary artery 164. The perfusion fluid 108 enters the right ventricle 154 and right atrium 157 of the heart 102 via the pulmonary artery 164. The perfusion fluid 108 is then flowed away from the aorta 158 through interface 165. Then, from the aorta 158, the perfusion fluid 108 is directed to the reservoir 160. In this embodiment, the system 100 pumps the perfusion fluid 108 to the heart 102 at a near physiological rate of between about 1 liter/min and about 5 liters/minute. This mode is useful, for example, for performing functional testing to verify that the heart 102 is defect free, both prior and subsequent to transportation to a donor location.

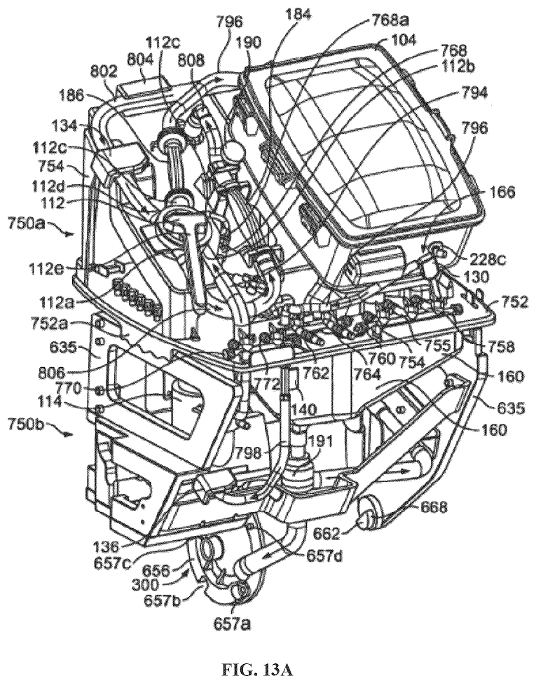

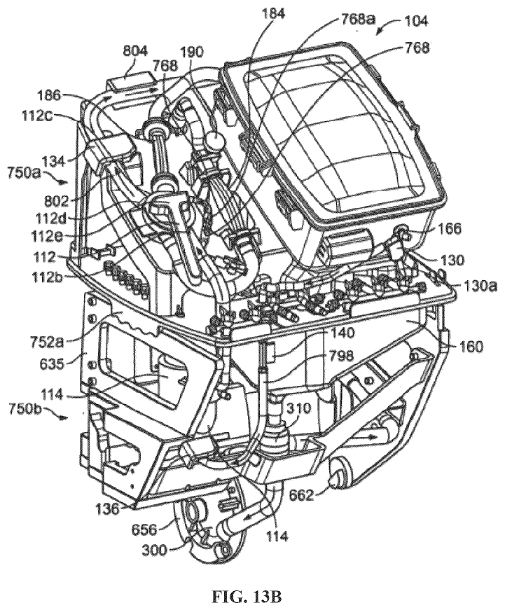

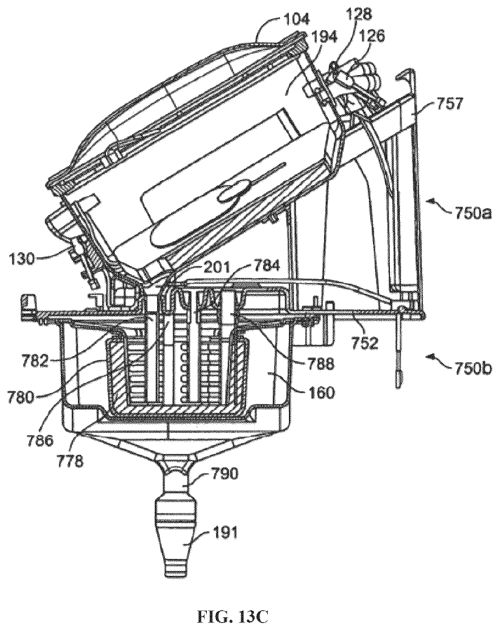

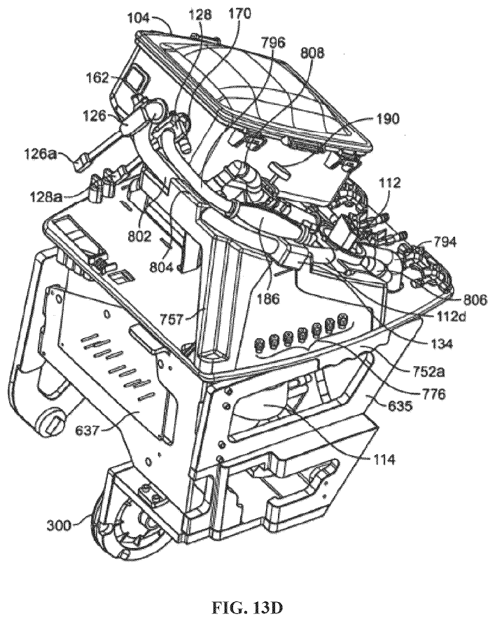

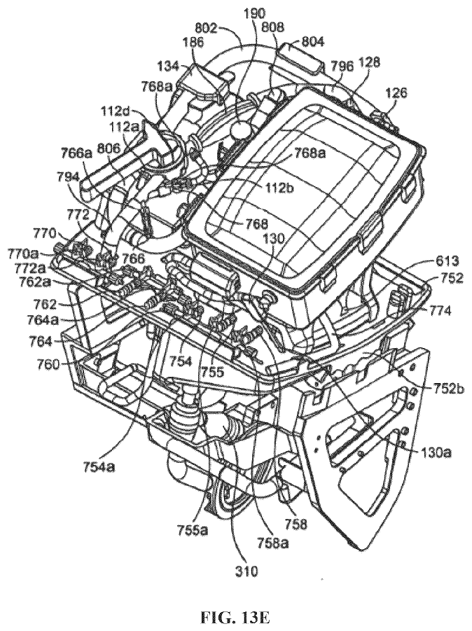

Alternatively, in retrograde flow mode, shown in FIG. 4, the system 100 flows the perfusion fluid 108 into the heart 102 via the aorta 158, through the coronary sinus 155 and other coronary vasculature of the heart, and out of the right ventricle 154 of the heart 102 via the pulmonary artery 164. As discussed in further detail below with regard to FIGS. 13A and 13B, the system 100 also provides a trickle flow 769 to the left atrium 152 through trickle valve 768. The trickle flow is provided in an amount sufficient to moisten the left atrium 152 and left ventricle 156. In certain applications the trickle flow is less than about 5 ml/min, less than about 1 ml/min, or less than about 0.1 ml/min. In this mode of operation, the system 100 reduces the flow rate of the perfusion fluid 108 to between about 300 milliliters/minute and about 1 liter/minute. The inventors have found that the retrograde flow path of FIG. 4, along with the reduced flow rate, reduces damage to the heart 102 during extended periods of ex-vivo maintenance. Thus, according to one feature of the invention, the heart 102 is transported to a donor site in retrograde flow mode.

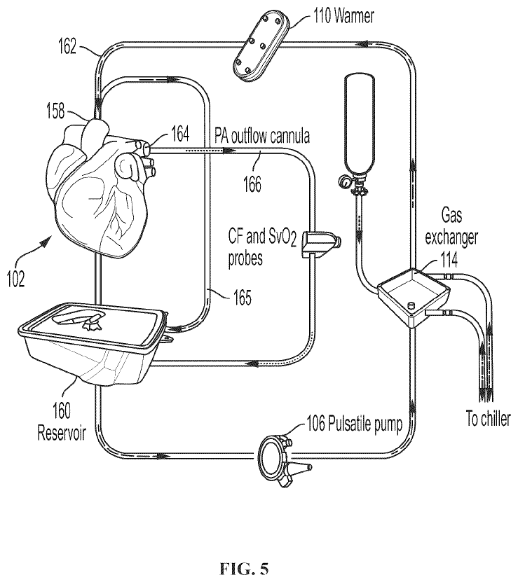

Another embodiment of retrograde flow mode is shown in FIG. 5. The pump 106 extracts perfusion fluid 108 from reservoir 160 and pumps the perfusion fluid 108 to the oxygenator/gas exchanger 114, and then through the heater/warmer 110. From there, the perfusion fluid 108 flows into the aorta 158 via aorta interface 162. This allows the perfusion fluid 108 to perfuse the coronaries. Deoxygenated blood from the coronary arteries then enters the right atrium 157 and passes through the tricuspid valve to the right ventricle 154. Then, the perfusion fluid 108 exists through pulmonary artery 164 and flows through pulmonary artery interface 166, through a coronary flow (CF) and SvO₂ probe and into reservoir 160. From reservoir 160, the perfusion fluid 108 flows back into the pump to repeat the process.

Having briefly described the normal and retrograde flow modes, the system 100 will next be described in further detail operationally. Referring once again to FIGS. 1-4, in one practice, the heart 102 is harvested from a donor and cannulated into the organ chamber assembly 104. The perfusion fluid 108 is prepared for use within system 100 by being loaded into the reservoir 160 via portal 774 and, optionally, being treated with therapeutics via portal 762. The pump 106 pumps the loaded perfusion fluid 108 from a reservoir 160 to the heater assembly 110. The heater assembly 110 heats the perfusion fluid 108 to or near a normal physiological temperature. According to one embodiment, the heater assembly 110 heats the perfusion fluid to between about 32 degrees C. and about 37 degrees C. The heater assembly 110 has an internal flow channel with a cross-sectional flow area that is approximately equal to the inside cross-sectional area of fluid conduits that carry the perfusion fluid 108 into and/or away from the heater assembly 110, so as to minimize disturbance of fluid flow. From the heater assembly 110, the perfusion fluid 108 flows to the flow mode selector valve 112.

Initially, the flow mode selector valve 112 is positioned in retrograde mode to direct the perfusion fluid 108 from the heater assembly 110 into the organ chamber assembly 104 via a first interface 162. Also referred to as an aorta interface or left ventricle interface, the interface 162 includes cannulation to vascular tissue of the left ventricle via an aperture 228b located on the organ chamber assembly 104. As the heart 102 warms, it begins to beat which causes the heart 102 to pump the perfusion fluid 108 through the coronary vasculature 155 and out of the heart 102 through the right ventricle 154 via a second interface 166. The second interface 166, also referred to as a pulmonary artery interface or a right ventricle interface, in some embodiments, includes cannulation to vascular tissue of the right ventricle via an aperture 228c located on the organ chamber assembly 104. As mentioned above, in retrograde flow mode, fluid is not actively pumped into or out of the left side of the heart, except for a relatively small trickle 769 of perfusion fluid, which is delivered to moisten the left atrium 152 and left ventricle 156, as described below in reference to FIGS. 13A-13E.

In response to the flow mode selector valve 112 being placed in the normal mode position, it directs the perfusion fluid 108 into the left atrium 152 of the heart 102 via a third interface 170. The third interface 170, also referred to as a pulmonary vein interface or left atrium interface, includes cannulation to vascular tissue of the left atrium 152 via an aperture 228a located on the organ chamber assembly 104. The heart 102 then expels the perfusion fluid 108 through the left ventricle 156 via the aorta interface 162 and through the right ventricle 154 via the pulmonary artery interface 166.

In an alternative embodiment, in response to the flow mode selector valve 112 being placed in the normal mode position, it directs the perfusion fluid 108 into the pulmonary artery interface 166. The heart 102 then expels the perfusion fluid 108 through the aorta interface 162. In some embodiments, this alternative flow mode is used when providing the heart with a PDE3 inhibitor. In some embodiments, this alternative normal flow mode is achieved by cannulating the aorta and pulmonary artery, without cannulating the pulmonary vein.

In embodiments described herein, a heart 102 could include one or more of interfaces 162, 166, and/or 170. In some embodiments, heart 102 has an aortic interface 162 and a pulmonary artery interface 166, but no pulmonary vein interface 170. Instead, the pulmonary vein is tied off. In some embodiments, the inferior vena cava and the superior vena cava are tied off and not cannulated. Each of the interfaces 162, 166 and 170 may be cannulated to the heart 102 by pulling vascular tissue (e.g., an aorta stub) over the end of the interface, then tying or otherwise securing the tissue to the interface. The vascular tissue is preferably a short segment of a blood vessel (e.g., an aorta stub 158) that remains connected to the heart 102 after the heart 102 is severed and explanted from the donor. For example, the aorta interface 162 is cannulated to a small segment of the severed aorta 158 which has been formed by severing the aorta 158 in a location down-stream from the coronary sinus 155. In certain applications, the short vessel segments may be about 5 to about 10 inches in length or longer. The segments may also be shorter than about 5 inches. The segments may be about 2 to about 4 inches in length, or about 1 to about 2 inches in length; in other applications the segments may be less than about ½ inch, or less than about ¼ inch.

Alternatively, the cannulation may occur by affixing the interface directly to the applicable atrium or ventricle, as may be preferred in applications where the heart 102 is prepared for explantation by severing an entire blood vessel without leaving any stub portion of the vessel connected to the heart 102. For example, a left atrium 152 cannulation can be formed by inserting the interface 170 directly into the left atrium 152 and clamping the interface 170 in place, without the need to tie to any pulmonary vein 168 tissue.

With continued reference to FIG. 1, in some embodiments, in both flow modes the perfusion fluid 108 flows from the pulmonary artery interface 166 into the oxygenator 114. In other embodiments, as shown in FIG. 5, the perfusion fluid flows from the pump to the oxygenator 114 before reaching the heart 102. The oxygenator 114 receives gas from an external or onboard source 172 through a gas regulator 174 and a gas flow chamber 176, which can be a pulse-width modulated solenoid valve that controls gas flow, or any other gas control device that allows for precise control of gas flow rate. A gas pressure gauge 178 provides a visual indication of how full the gas supply 172 is. The transducer 132 provides similar information to the controller 150. The controller 150 can regulate automatically the gas flow into the oxygenator 114 in dependence, for example, on the perfusion fluid oxygen content measured at the sensor 140. According to various illustrative embodiments, the oxygenator 114 is a standard membrane oxygenator, such as the Liliput 2 manufactured by Dideco, a division of Sorin Biomedical, or the MINIMAX PLUS.TM. manufactured by Medtronic, Inc. In the illustrative embodiment, the gas includes an oxygen and carbon dioxide mixture. In some embodiments, the gas mixture contains about 85% O₂, about 1% CO₂, with the balance being N₂. In some embodiments, the gas mixture contains about 80% O₂, about 1% CO₂, with the balance being N₂. In some embodiments, the gas mixture contains about 21% 02, 5.5% CO₂, with the balance being N₂. Subsequent to re-oxygenation, the oxygenator 114 returns the perfusion fluid 108 to the reservoir 160. According to the illustrative embodiment, the sensor 140 measures the amount of light absorbed or reflected by the perfusion fluid 108 when applied at a multi-wavelength to provide an optical-based measurement of oxygen saturation. Since the perfusion fluid 108 is blood product based in certain embodiments, it may contain red blood cells (e.g., oxygen carrying cells). Accordingly, the sensor 140 also provides a signal 145 indicative of a hematocrit measurement of the perfusion fluid 108. In alternative embodiments the solution 108 is formed of a synthetic blood substitute, while in other embodiments, the solution 108 may contain a blood product in combination with a blood substitute product.

Also, in both flow modes, the nutritional subsystem 115, including a supply of maintenance solutions 116/118 and an infusion pump 182, infuses the perfusion fluid 108 with nutrients 116, such as glucose and/or a ketone body, as the perfusion 108 solution flows through the system 100, and in some embodiments, while it is in the reservoir 160. The maintenance solutions 116/118 also include a supply of therapeutics and preservatives 118 for reducing ischemia and other re-perfusion related injuries to the heart 102.

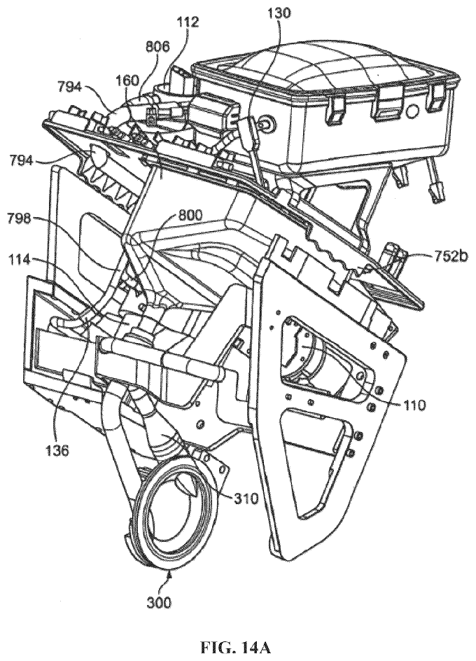

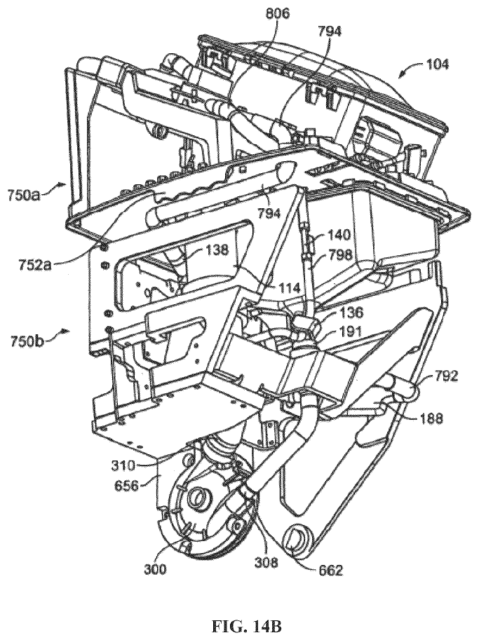

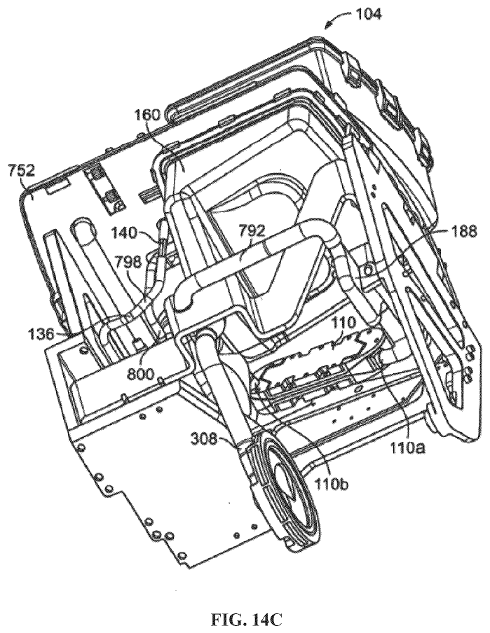

Both normal and retrograde flow modes are described in further detail below with reference to FIGS. 13A-14C.

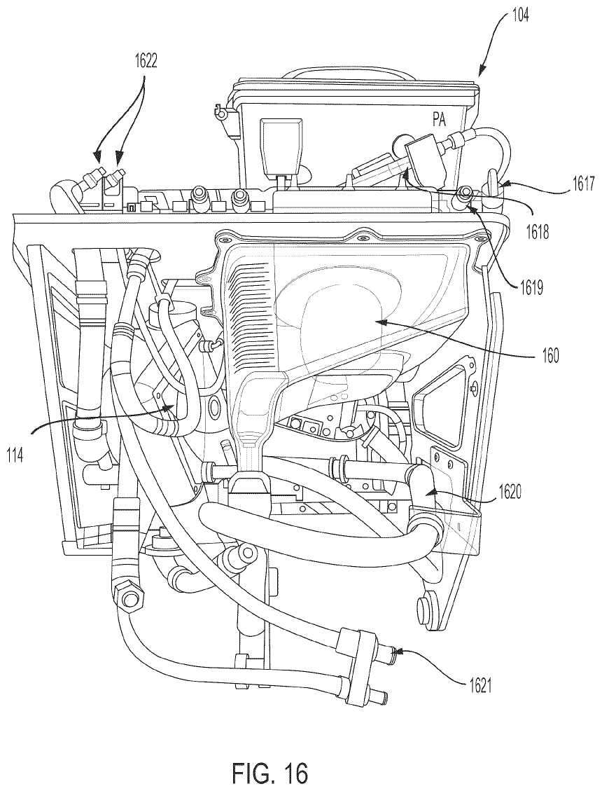

According to the illustrative embodiment, the system 100 is primed prior to introducing an organ into the organ chamber assembly 104. During priming, a priming solution (described below) is inserted into the organ chamber 160 and pumped through the system 100. In some embodiments, the priming solution contains a PDE3 inhibitor (e.g., milrinone). In some embodiments, the priming occurs for a period of between about 5 minutes and about 20 minutes. In some embodiments, the priming occurs for a period of between about 1 minute and about 5 minutes. In some embodiments, the priming occurs for less than 1 minute. In some embodiments, the priming solution containing the PDE3 inhibitor can be administered immediately before the organ is instrumented onto the organ care system or immediately after the organ is instrumented onto the organ care system. In some embodiments, the priming solution includes a PDE3 inhibitor. In some embodiments, the cannulation interfaces 162, 166 and 170 in the organ chamber assembly 104 are bypassed to enable normal mode flow of perfusion fluid 108 through the system 100, without the donor heart 102 being present. Blood (or a synthetic blood substitute) is then loaded into the reservoir 160. The blood may be the blood exsanguinated from the donor during harvesting of the heart 102 or obtained from typed and cross-matched banked blood. The system 100 then circulates the blood (or blood substitute) through the system 100 to heat, oxygenate, and filter it. Nutrients, preservatives and/or other therapeutics are provided via the infusion pump 182 of the nutritional subsystem 115. Various parameters may also be initialized and calibrated via the operator interface 146 during priming. Once the system 100 is running appropriately, the pump rate can be decreased or brought to zero, and the heart 102 can be cannulated into the organ chamber assembly 104. The pump rate can then be increased. Priming of the system 100 is described in further detail below with reference to the flow diagram of FIG. 16A.

As shown in FIG. 1, the system 100 may include a plurality of compliance chambers 184, 186 and 188. The compliance chambers 184, 186 and 188 are essentially small inline fluid accumulators with flexible, resilient walls designed to simulate the human body's vascular compliance by aiding the system in more accurately mimicking blood flow in the human body, for example, by providing flow back-pressure and/or by filtering/reducing fluid pressure spikes due, for example, to flow rate changes and/or the pumping of the pump 106. According to the illustrative embodiment, the compliance chamber 184 is located between an output 112a of the mode valve 112 and the reservoir 160 and operates in combination with an adjustable clamp 190 during normal flow mode to provide back pressure to the aorta 158 to cause perfusion fluid to flow into the coronary sinus 155 to feed the heart 102. In the illustrative embodiment, the fluid back-pressure provided to the aorta 158 is between about 55 mmHg and about 85 mmHg, which is within an acceptable near-physiologic range of mean aortic blood pressure (which is typically between about 80 mmHg and about 100 mmHg). The back pressure to the aorta 158 aids the system 100 in simulating normal physiologic conditions. The compliance chamber 186 is located between an output 112b of the mode valve 112 and the pulmonary vein cannulation interface 170 of the organ chamber assembly 104. The primary function of the compliance chamber 186 is to provide back-pressure to the left atrium 152 and to smooth pressure/flow spikes caused from the pumping action of the perfusion fluid pump 106, which delivers blood to the heart without causing substantial fluid pressure spikes. In the illustrative embodiment, the fluid back-pressure provided to the left atrium 152 is between about 0 mmHg to about 14 mmHg, which is approximately the same as the left atrial pressure under normal physiologic conditions. The compliance chamber 188 is located between an output of a one-way valve 310 and an inlet 110a of the heater 110. The primary function of the compliance chamber 188 is also to smooth pressure/flow spikes caused by the pumping action of the perfusion fluid pump 106 and to provide fluid back-pressure to the pulmonary artery 164. In the illustrative embodiment, the fluid back-pressure provided to the pulmonary artery 164 is between about 0 mmHg and about 25 mmHg, which is within an acceptable near-physiologic range of mean arterial blood pressure (between about 0 mmHg and about 12 mmHg).

The compliance chambers 184, 186 and 188 provide the benefits described above through their size and shape and the materials used in their design. The chambers 184, 186 and 188 are sized to contain about 20 ml to about 100 ml of fluid 108, and they are shaped in an oval configuration to allow them to receive fluid 108 and expand to dampen pressure spikes and to provide back-pressure to the heart 102. In certain applications, the material used for the chambers 184, 186 and 188 includes at least one flexible membrane, selected so that the chambers have a Shore A durametric hardness (ASTM D2240 00) of about 10 (more flexible) to about 60 (less flexible), with certain preferred embodiments having a hardness of between about 30 (±about 8) and about 50 (±about 8). In the illustrative embodiment, the compliance chamber 184 has a Shore A hardness of about 50 (±about 8) and the compliance chamber 186 has a Shore A hardness of about 30 (±about 8). In the illustrative embodiment, the compliance chamber 188 has a dual-layered configuration, with an inner chamber having a Shore A hardness of about 50 (±about 8) and an outer sleeve having a Shore A hardness of about 30 (±about 8). Alternatively, the inner chamber can have a lower hardness (e.g., about 30, ±about 8) and outer sleeve can have a higher hardness (e.g., about 50, ±about 8)).

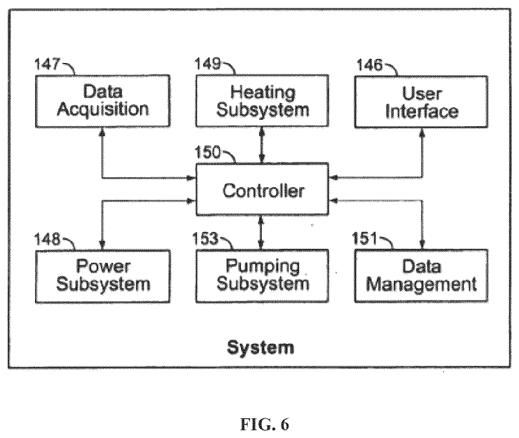

Having described the illustrative organ care system 100 from a system, operational and component point of view, illustrative control systems and methods for achieving operation of the system 100 are next discussed. In some embodiments, one or more components depicted and described with reference to FIG. 1 can be used in combination with the configuration of one or more components depicted and described with reference to FIG. 5. FIG. 6 depicts a block diagram of an illustrative control scheme for the system 100. As described above with reference to FIG. 1, the system 100 includes a controller 150 for controlling operation of the system 100. As shown, the controller 150 connects interoperationally with the following six subsystems: an operator interface 146 for assisting an operator in monitoring and controlling the system 100 and in monitoring the condition of the heart 102; a data acquisition subsystem 147 having various sensors for obtaining data relating to the heart 102 and to the system 100, and for conveying the data to the controller 150; a power management subsystem 148 for providing fault tolerant power to the system 100; a heating subsystem 149 for providing controlled energy to the heater 110 for warming the perfusion fluid 108; a data management subsystem 151 for storing and maintaining data relating to operation of the system 100 and with respect to the heart 102; and a pumping subsystem 153 for controlling the pumping of the perfusion fluid 108 through the system 100.

The term “processor” or “controller” as used herein refers to either a single processor/controller or a distributed network of two or more processors/controllers. Designs of systems using a single processor/controller or distributed processing are well-known in the art. It should be noted that although the system 100 is described conceptually with reference to a single controller 150, the control of the system 100 may be distributed in a plurality of controllers or processors. For example, any or all of the described subsystems may include a dedicated processor/controller. Optionally, the dedicated processors/controllers of the various subsystems may communicate with and via a central controller/processor.

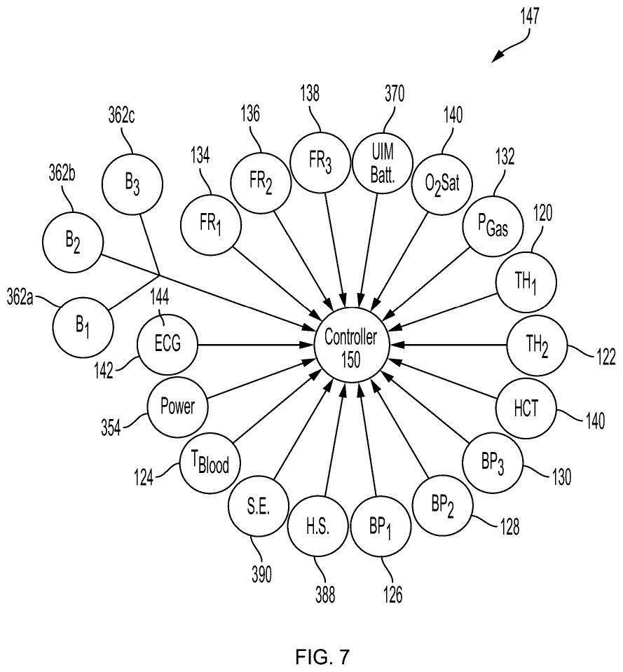

Referring first to the block diagram of FIG. 7, the data acquisition subsystem 147 includes sensors for obtaining information pertaining to how the system 100 and the heart 102 is functioning, and for communicating that information to the controller 150 for processing and use by the system 100. As described with respect to FIG. 1, the sensors of subsystem 147 include, without limitation: temperature sensors 120, 122 and 124; pressure sensors 126, 128, and 130; flow rate sensors 134, 136 and 138; the oxygenation/hematocrit sensor 140; and electrodes 142 and 144. The data acquisition subsystem 147 also includes: a set of Hall sensors 388 and a shaft encoder 390 from the perfusion pump assembly 106; battery sensors 362a-362c for sensing whether the batteries 352a-352c, respectively, are sufficiently charged; an external power available sensor 354 for sensing whether external AC power is available; an operator interface module battery sensor 370 for sensing a state of charge of the operator interface module battery; and a gas pressure sensor 132 for sensing gas flow from the gas flow chamber 176. How the system 100 uses the information from the data acquisition subsystem 147 will now be described with regard to the heating 149, power management 148, pumping 153, data management 151, and operator interface 146 subsystems.

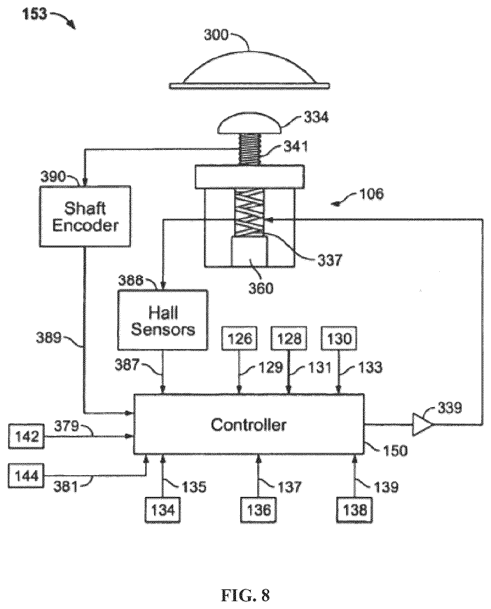

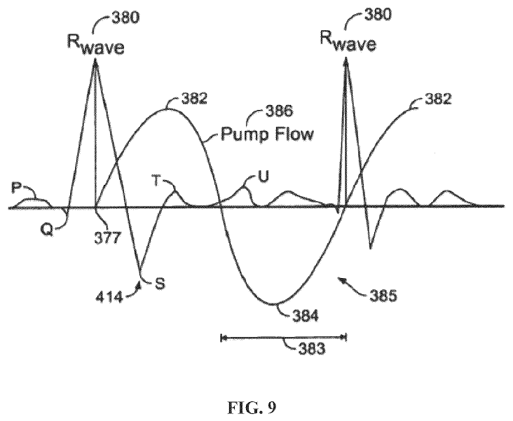

The pumping subsystem 153 of FIG. 6 will now be described in further detail with reference to FIGS. 8 and 9. More particularly, FIG. 8 is a conceptual block diagram depicting the illustrative pumping subsystem 153, and FIG. 9 shows an exemplary ECG 414 of a heart 102 synchronized with an exemplary wave 385 depicting pumping output by the subsystem 153. The ECG 414 shown in FIG. 9 has P, Q, R, S, T, and U peaks. The pumping subsystem 153 includes the perfusion fluid pump 106 interoperationally connected to the pump interface assembly 300. As shown in FIG. 8 the controller 150 operates the pumping subsystem 153 by sending a drive signal 339 to a brushless three-phase pump motor 360 using Hall Sensor feedback. The drive signal 339 causes the pump motor shaft 337 to rotate, thereby causing the pump screw 341 to move the pump driver 334 up and/or down. According to the illustrative embodiment, the drive signal 339 is controlled to change a rotational direction and rotational velocity of the motor shaft 337 to cause the pump driver 334 to move up and down cyclically. This cyclical motion pumps the perfusion fluid 108 through the system 100.

In operation, the controller 150 receives a first signal 387 from the Hall sensors 388 positioned integrally within the pump motor shaft 337 to indicate the position of the pump motor shaft 337 for purposes of commutating the motor winding currents. The controller 150 receives a second higher resolution signal 389 from a shaft encoder sensor 390 indicating a precise rotational position of the pump screw 341. From the current motor commutation phase position 387 and the current rotational position 389, the controller 150 calculates the appropriate drive signal 339 (both magnitude and polarity) to cause the necessary rotational change in the motor shaft 337 to cause the appropriate vertical position change in the pump screw 341 to achieve the desired pumping action. By varying the magnitude of the drive signal 339, the controller 150 can vary the pumping rate (e.g., how often the pumping cycle repeats) and by varying the rotational direction changes, the controller 150 can vary the pumping stroke volume (e.g., by varying how far the pump driver 334 moves during a cycle). Generally speaking, the cyclical pumping rate regulates the pulsatile rate at which the perfusion fluid 108 is provided to the heart 102, while (for a given rate) the pumping stroke regulates the volume of perfusion fluid 108 provided to the heart 102.

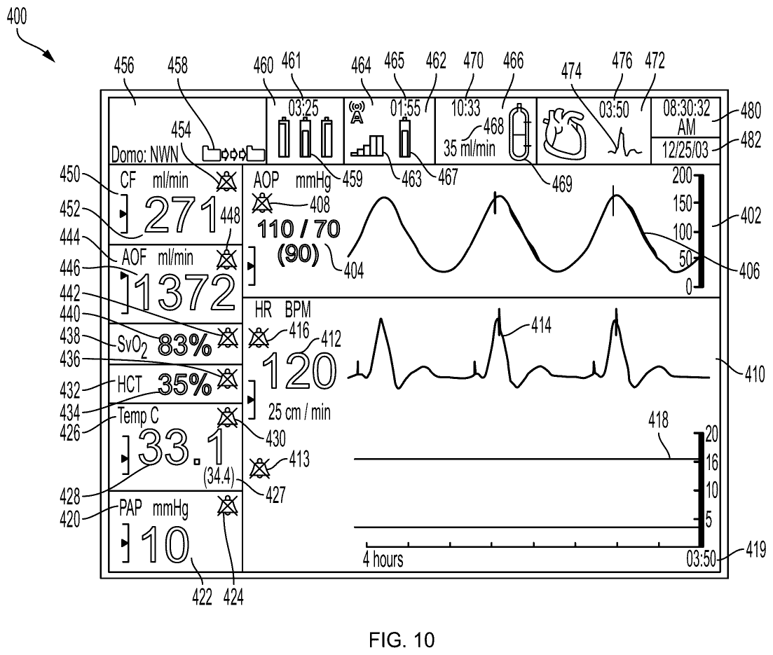

Both the rate and stroke volume affect the flow rate, and indirectly the pressure, of the perfusion fluid 108 to and from the heart 102. As mentioned with regard to FIG. 1, the system includes three flow rate sensors 134, 136 and 138, and three pressure sensors 126, 128 and 130. As shown in FIG. 8, the sensors 134, 136, and 138 provide corresponding flow rate signals 135, 137 and 139 to the controller 150. Similarly, the sensors 126, 128 and 130 provide corresponding pressure signals 129, 131 and 133 to the controller 150. The controller 150 employs all of these signals in feedback to ensure that the commands that it is providing to the perfusion pump 106 have the desired effect on the system 100. In some instances, and as discussed below in further detail with reference to FIG. 10, the controller 150 may generate various alarms in response to a signal indicating that a particular flow rate or fluid pressure is outside an acceptable range. Additionally, employing multiple sensors enables the controller 150 to distinguish between a mechanical issue (e.g., a conduit blockage) with the system 100 and a biological issue with the heart 102.

According to one feature of the invention, the pumping system 153 may be configured to control the position of the pump driver 334 during each moment of the pumping cycle to allow for finely tuned pumping rate and volumetric profiles. This in turn enables the pumping system 153 to supply perfusion fluid 108 to the heart with any desired pulsatile pattern. According to one illustrative embodiment, the rotational position of the shaft 337 is sensed by the shaft encoder 390 and adjusted by the controller 150 at least about 100 increments per revolution. In another illustrative embodiment, the rotational position of the shaft 337 is sensed by the shaft encoder 390 and adjusted by the controller 150 at least about 1000 increments per revolution. According to a further illustrative embodiment, the rotational position of the shaft 337 is sensed by the shaft encoder 390 and adjusted by the controller 150 at least about 2000 increments per revolution. The vertical position of the pump screw 341 and thus the pump driver 334 is calibrated initially to a zero or a ground position, corresponding to a reference position of the pump screw 341.

According to the illustrative embodiment, the positional precision of the pumping subsystem 153 enables the controller 150 to precisely regulate the pumping of the perfusion fluid 108 through the heart 102. This process of synchronizing the pulsatile flow of the perfusion fluid to the heart's natural rate is referred to herein as “r-wave synchronization,” which is described with continued reference to FIGS. 2, 8, and 9. A normally functioning heart has a two-phase pumping cycle-diastole and systole. During the diastolic phase, also known as the “resting phase,” the heart's atria 157 and 152 contract, causing valves to open between the atria 157 and 152 and the ventricles 154 and 156 to allow blood to flow into and load the ventricles 154 and 156. During the systolic phase, the loaded ventricles eject the blood, and the atria 157 and 152 are opened and fill with blood. The cyclical expansion and contraction of the heart 102 during this process can be represented by graphing the heart's ventricular ECG wave form, shown at 414 in FIG. 9. FIG. 9 depicts the ECG waveform 414 synchronized with an exemplary wave 385 representative of a pumping output by the subsystem 153.

The pumping subsystem 153 is configured to provide the maximum output at a time that will result in delivery of fluid 108 to the heart 102 at the most beneficial time. In the illustrated embodiment, in retrograde mode, the pumping subsystem 153 is configured to pump fluid 108 toward the heart 102 so that the maximum pump output 382 occurs during the diastolic phase of the heart, which begins after the S peak shown in FIG. 9 and is when the left ventricle 156 has finished ejecting perfusion fluid 108 through the aorta 158. Timing the pump output in this manner allows the user to maximize the injection of perfusion fluid 108 through the aorta 158 and into the coronary sinus 155. The timed pumping is accomplished by starting the pumping at point 377 on wave 385, which is a point prior to point 382 and corresponds to the peak of the heart's r-wave pulse 380 and the middle of ventricular systole. The point 377 is selected to account for time-delay between the time a signal is provided from the controller 150 to start pumping the fluid and the time of actual delivery of the pumped fluid 108 to the heart 102. In another example, during normal flow mode where the left side of-the heart fills and ejects perfusion fluid (as described in more detail with reference to FIG. 13A), the controller 150 synchronizes the pumping subsystem 153 to start pumping at a fixed period of time after the r-wave 380, so as to match the natural filling cycle of the left atrium 152. The synchronization may be adjusted and fine-tuned by the operator through a pre-programmed routine in the operating software on the system 100 and/or by manually operating the controls of the user interface display area 410, as described in more detail below in reference to FIG. 10.

To achieve the synchronized pump output, the controller 150 predicts when the heart's r-wave pulses 380 will occur and causes the pump to pump at the appropriate time during the ECG 414. To make this prediction, the controller 150 measures the length various r-wave pulses 380 from the electrical signals 379 and 381 provided from the electrodes 142 and 144, respectively. From these pulses, the controller 150 tracks the time that elapses from one pulse 380 to the next, and uses this information to calculate a running average of the length of time separating two sequential r-wave pulses. From this information, the controller 150 projects the time of the next r-wave (and from the projection determines the time prior to or after that projected r-wave when the pumping should start to achieve optimal output delivery) by adding the average time separating two sequential r-wave pulses to the time of the previous r-wave 380. Based on this running average of separation time between r-waves, the controller 150 has the option to adjust the time of pump output in relation to subsequent r-waves, as reflected in the movement of wave 385 to the left or the right along the ECG 414 as signified by the arrow 383 in FIG. 9. Adjusting the wave 385 thus allows the user to adjust and customize the timing of output by the pump 106 so as to optimize the filling of the heart. In addition, the pump 106 may also be adjusted to increase or decrease the pump stroke volume to customize the volume of fluid 108 provided by the pump 106, and this may be done either in concert with or independent of the r-wave synchronization.

It should be noted that although the subsystem 153 particularly synchronizes with the r-wave cycle 385, this need not be the case. In alternative illustrative embodiments, the subsystem 153 may pump in synchronicity with any available characteristic of the heart, including fluid pressures into or out of a particular chamber or vessel. Also, the subsystem 153 may be programmed to pump in any arbitrary pattern, whether periodic or not.

Referring back to FIG. 6, the data management subsystem 151 receives and stores data and system information from the various other subsystems. The data and other information may be downloaded to a portable memory device and organized within a database, as desired by an operator. The stored data and information can be accessed by an operator and displayed through the operator interface subsystem 146.

Turning now to the operator interface subsystem 146, FIG. 10 shows an illustrative display screen of the operator interface subsystem 146. The display screen enables the operator to receive information from and provide commands to the system 100. FIG. 10 depicts a top level “home page” display screen 400 according to an illustrative embodiment of the invention. From the display screen 400 an operator can access all of the data available from the data acquisition subsystem 147 and can provide any desired commands to the controller 150. The display screen 400 of FIG. 10 also allows the operator to access more detailed display screens for obtaining information, providing commands and setting operator selectable parameters.

With continued reference to FIG. 1, the display screen 400 includes a display area 402, which shows a number of numerical and graphical indications pertaining to the operation of the system 100. In particular, the display area 402 includes a numerical reading of the aorta output pressure (AOP) 404 of the perfusion fluid 108 exiting the aorta interface 162 on the organ chamber assembly 104, a wave form depiction 406 of the aortic fluid pressure (AOP) 404, and an AOP alarm image 408 indicating whether the fluid pressure 404 is too high or too low (the alarm 408 is shown as “off” in FIG. 10). The display screen 400 also includes a display area 410 having a numerical indication 412 of the rate at which the heart 102 is beating, an ECG 414 of the heart 102, a heart rate (HR) alarm image 416 indicating whether the HR 412 exceeds or falls below operator set thresholds, and a time log 418 indicating how long the system 100 has been running, including priming time (discussed in further detail below with reference to FIG. 16A). A numerical display 419 shows the amount of time for which the system 100 has been supporting the heart 102. The indicator alarm 413 indicates when an operator preset time limit is exceeded.

The display screen 400 includes a number of additional display areas 420, 424, 432, 438, 444,450,456,460, 462, 466,472,480, and 482. The display area 420 shows a numerical reading of the pulmonary artery pressure (PAP) 422. The PAP 422 is an indication of the pressure of the perfusion fluid 108 flowing from the heart's pulmonary artery 164, as measured by the pressure sensor 130. The display area 420 also provides a PAP alarm indicator 424, which signals when the PAP 422 is outside an operator preset range. The display area 426 indicates the temperature (Temp) 428 of the perfusion fluid 108 as it exits the heater 110. The display area 426 also includes a Temp alarm indicator 430, which signals in response to the Temp 428 being outside of an operator preset range. The upper limit of the operator preset range is shown at 427. The display area 432 shows a numerical reading of the hematocrit (HCT) 434 of the perfusion fluid 108, and an HCT alarm indicator 436 for signaling the operator if the HCT 434 falls below an operator preset threshold. The display area 438 shows the oxygen saturation (SvO₂) 440 of the perfusion fluid 108. The display area 438 also includes a SvO₂ alarm 442 for indicating if the SvO₂ 440 of the perfusion fluid 108 falls below an operator preset threshold. The display area 444 indicates the aorta output flow rate (AOF) 446 of the perfusion fluid 108 as it flows out of the aorta 158. The AOF 446 is measured by the flow rate sensor 134. The AOF alarm 448 indicates whether the flow rate 446 falls outside of an operator preset range. The display area 450 shows the coronary flow rate (CF) 452. The CF 452 is an indication of the flow rate of the perfusion fluid 108 as it exits the organ chamber 104, as measured by the flow rate sensor 136. In some embodiments, flow rate sensor 136 is referred to as a coronary flow rate sensor. In some embodiments, the display area 450 also includes a CF alarm 454, which signals in response to the CF 454 falling outside of an operator preset range. The display area 456 includes a graphic 458 for indicating when a file transfer to the memory card is occurring.

The display area 460 shows a graphical representation 459 of the degree to which each of the batteries 352a-352c is charged. The display area 460 also provides a numerical indication 461 of the amount of time remaining for which the batteries 352a-352c can continue to run the system 100 in a current mode of operation. The display area 462 identifies whether the operator interface module 146 is operating in a wireless 464 fashion, along with a graphical representation 463 of the strength of the wireless connection between the operator interface module 146 and the remainder of the system 100. The display area 462 also provides graphical indication 467 of the charge remaining in the operator interface module battery 368 and a numerical indication 465 of the amount of time remaining for which the operator interface module battery 368 can support it in a wireless mode of operation. The display area 466 indicates the flow rate 468 of oxygen from the gas flow chamber 176. It also provides a graphical indication 469 of how full an onboard oxygen tank is, and a numerical indication 470 of the amount of time remaining before the onboard oxygen tank runs out. The display area 472 shows the heart rate of the heart 102, and the amount of time 476 for which the heart 102 has been cannulated onto the system 100. This field is duplicative of the field 419 mentioned above. The display areas 480 and 482 show the current time and date, respectively, of operation of the system 100.

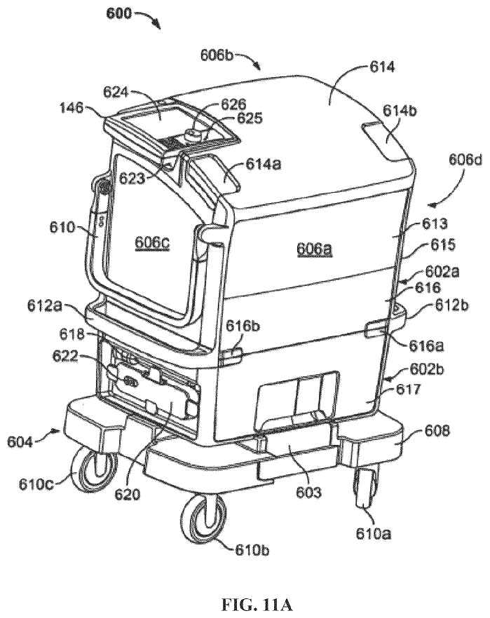

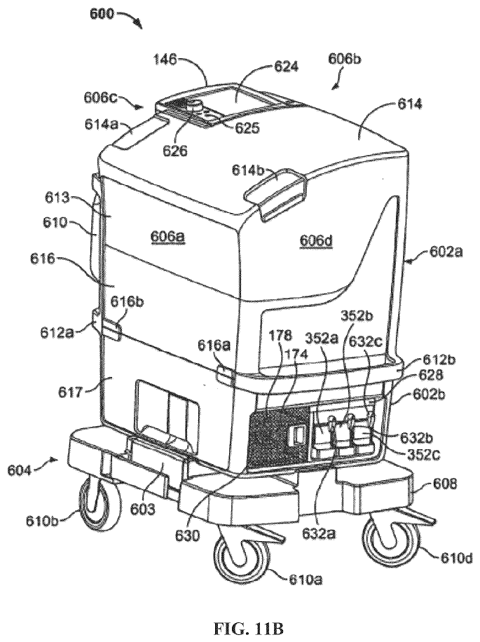

Referring to FIGS. 10, the operator interface 146 also provides graphical mechanisms for adjusting various parameters. For example, as noted above in reference to FIG. 9, one advantage of the user display area 402 is that it allows the operator to monitor (and adjust) the pumping of the subsystem 153. Display area 410 identifies the ECG waveform 414 of the heart 102 and display 402 shows in wave form 406 the pressure of fluid flowing through the aorta. In these two displays the operator can monitor the effect of the pumping profile on the heart's ECG 414, which allows the user to adjust the stroke volume of the pumping subsystem 153, to adjust the rate of the pumping subsystem 153 (and thus the flow-rate of the fluid 108 being pumped through the system 100), to manually impose, or adjust a time of, firing of the subsystem (e.g., by imposing a fixed delay between the r-wave 380 and the beginning of the pumping cycle), or to automatically program the pumping subsystem 153 to pump at a pre-determined time along the heart's ECG waveform 414, as needed to properly fill the heart according to whether the heart is being perfused in retrograde or normal mode. These pumping adjustments may be made by use of the various graphical frames of the operator interface 146. By way of example, in response to a operator selecting the ECG graphic frame option 492 located in the display field 484 of the display screen 401, the operator interface 146 displays the dialog 568. The dialog 568 shows a graphical representation 572 of the ECG 414 along with a cursor 570. The position of the cursor 570 indicates the point at which the pumping subsystem 153 will initiate an output pumping stroke (e.g., the portion of the pumping cycle at which the pump motor 106 will push perfusion fluid 108 to the heart 102) relative to the ECG 414 of the heart 102. By rotating a mechanical knob 626 (shown in FIGS. 11A and 11B) on the operator interface 146, the operator moves the position of the cursor 570 to adjust when the pumping subsystem 153 will initiate the output pumping stroke relative to the r-wave pulse 380. As described above with regard to FIGS. 8 and 9, the pumping subsystem 153 receives an r-wave signal 380 from the ECG sensors 142 and 144. The pumping subsystem 153 uses the r-wave signal 380 along with the pumping adjustment information from the cursor 570 to synchronize perfusion fluid pumping with the beating of the heart 102. In another example, in response to the operator pressing the pump adjust button 625, the operator interface 146 displays the dialog 574. From the dialog 574, the operator can select the pointer 576 and rotate the knob 626 to turn the pump motor 106 on and off. Additionally, the operator can select the bar graphic 578 and rotate the knob 626 to adjust the volume of fluid being pumped, which is displayed in liters/minute.

Having described an illustrative control systems and methods for achieving operation of the system 100, illustrative mechanical features of the system 100 will now be discussed, along with an illustrative division of components between the single use disposable module 634 and multiple use module 650 units. More particularly, FIGS. 11A-11B show a mechanical implementation 600 of the system of FIG. 1, according to an illustrative embodiment of the invention. As shown, the illustrative implementation 600 includes a housing 602 and a cart 604. The housing 602 conceptually divides into upper 602a and lower 602b housing sections, and includes front 606a, rear 606b, left 606c, and right 606d sides. The cart 604 includes a platform 608 and wheels 610a-610d for transporting the system 600 from place to place. A latch 603 secures the housing 602 to the cart 604. To further aid in portability, the system 600 also includes a handle 610 hinge mounted to the upper section 602a of the left side 606c of the housing 602, along with two rigidly mounted handles 612a and 612b mounted on the lower section 602b of the left 606c and right 606d sides of the housing 602.

The housing 602 further includes a removable top 614, and a front panel 615 having an upper panel 613, and a mid-panel 616 hinged to a lower panel 617 by hinges 616a and 616b. The top 614 includes handles 614a and 614b for aiding with removal. In the illustrated embodiment, the upper panel 613 is screwed, bolted or otherwise adjoined to the top 614, such that removal of the top 614 also removes panel 613.

As shown in FIG. 11A, the system 600 includes an AC power cable 618, along with a frame 620 for securing the power cable 618, both located on the lower section 602b of the left side 606c of the housing 602. A software reset switch 622, also located on the lower section 602b of the left side 602c, enables an operator to restart the system software and electronics.

As shown in FIGS. 11A and 11B, the implementation 600 also includes the operator interface module 146, along with a cradle 623 for holding the operator interface module 146. The operator interface module 146 includes a display 624 for displaying information to an operator, for example, by way of the display screen of FIG. 10. As mentioned above, the operator interface module 146 also includes a rotatable and depressible knob 626 for selecting between the various parameters and display screens (one example is shown in FIG. 10). The knob 626 may also be used to set parameters for automatic control of the system 100, as well as to provide manual control over the operation of the system 100. For example, the knob 626 may be used to provide instructions to the controller 150 to increase perfusion fluid flow rates, gas flow rates, etc. The operator interface module 146 includes its own battery 368 and may be removed from the cradle 623 and used in a wireless mode. While in the cradle 623, power connections enable the operator interface module 146 to be charged. As shown, the operator interface module also includes control buttons 625 for controlling the pump, silencing or disabling alarms, entering or exiting standby mode, entering or adjusting ECG synchronization mode, and starting the perfusion clock, which initiates the display of data obtained during organ care.

As shown in FIG. 11B, the illustrative implementation 600 also includes a battery compartment 628 and an oxygen tank bay 630, both located on the lower section 602b of the right side 606d of the housing 602.

The disposable module 634 and the multiple use unit 650 are constructed of material that is durable yet light-weight. In some illustrative embodiments, polycarbonate plastic is used to form one or more of the components of the units 634 and 650. To further reduce the weight, the chassis 635 and the multiple use module chassis 602 are formed from low weight materials such as, for example, carbon fiber epoxy composites, polycarbonate ABS-plastic blend, glass reinforced nylon, acetal, straight ABS, aluminum or magnesium. According to one illustrative embodiment, the weight of the entire system 600 is less than about 85 pounds, including the multiple use module, heart, batteries, gas tank, and priming, nutritional, preservative and perfusion fluids, and less than about 50 pounds, excluding such items. According to another illustrative embodiment, the weight of the disposable module 634 is less than about 12 pounds, excluding any solutions. According to a further illustrative embodiment, the multiple use module 650, excluding all fluids, batteries 352a-352c and oxygen supply 172, weighs less than about 50 pounds.

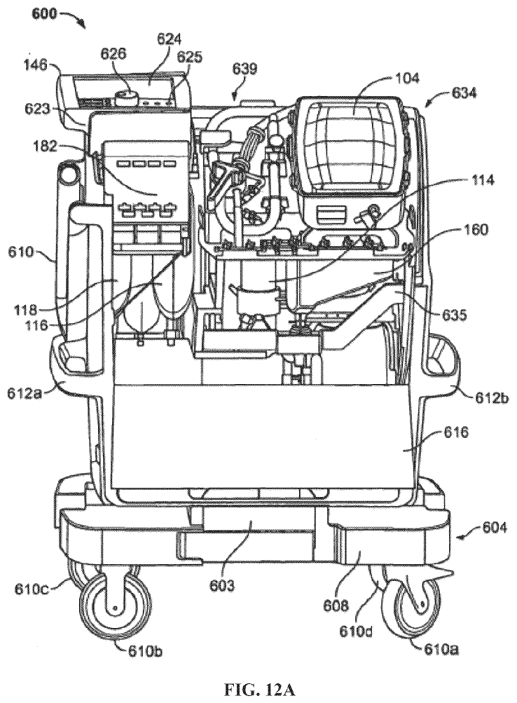

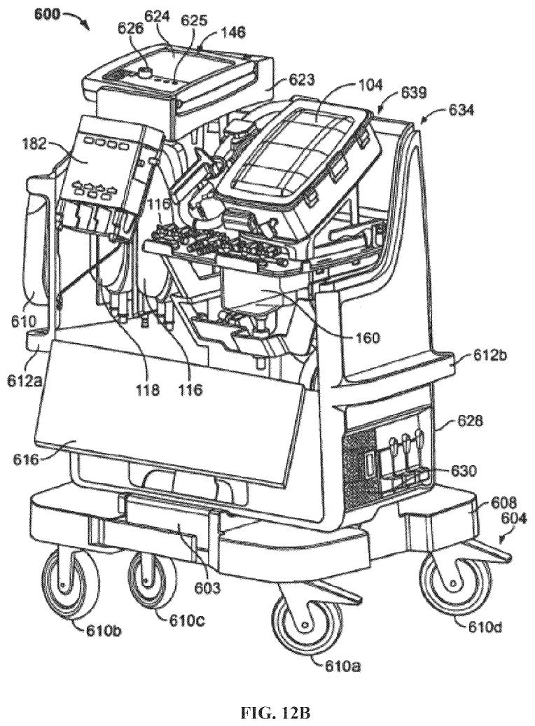

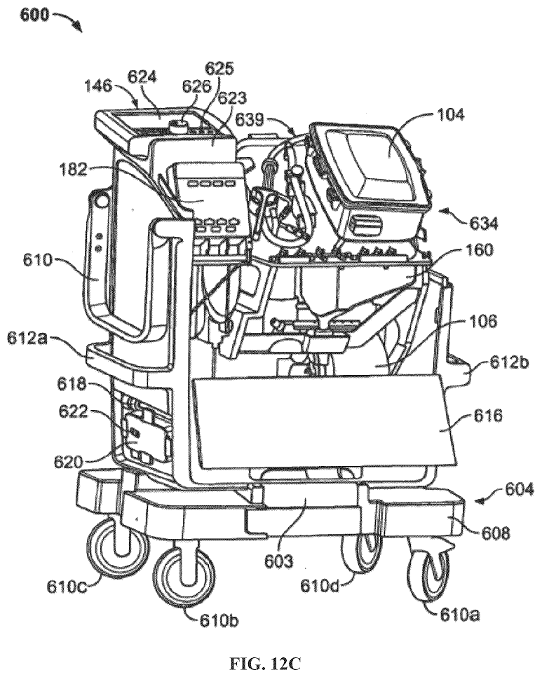

With continued reference to FIGS. 12A-12C, various views are shown of the implementation 600 of FIGS. 11A and 11B with the top 614 and upper front panel 613 removed and the front mid panel 616 open, according to an illustrative embodiment of the invention. With reference to FIGS. 12A-12C, the system 100 is structured as a single use disposable module 634 (shown and described in detail below with reference to FIGS. 13A-14C) and a multiple use module 650. As discussed in further detail below, according to one feature of the illustrative embodiment, all of the blood contacting components of the system 100 are included in the single use disposable module 634 so that after a use, the entire single use module 634 may be discarded, a new module 634 installed, and the system 100 available for use again within a very brief amount of time.

According to the illustrative embodiment, the single use module 634 includes a chassis 635 for supporting all of the components of the single use module 634. As described in more detail with regard to FIGS. 13A-14C, the components of the single use module 634 include the organ chamber assembly 104, the perfusion fluid reservoir 160, the oxygenator 114, the perfusion fluid pump interface 300, and all of the various fluid flow conduits and peripheral monitoring components 633.

As shown in FIG. 12A-12C, with the top 614 removed and the front panel 616 open, an operator has easy access to many of the components of the disposable 634 and multiple use 650 modules. For example, the operator may install, remove and view the levels of the nutrient 116 and preservative 118 supplies of the nutritional subsystem 115. The operator may also control operation of the nutrient 116 and preservative 118 infusion pump 182. The operator may also cannulate an organ, such as the heart 102, into the organ chamber assembly 104. This configuration also provides the operator with sufficient access to install and/or remove the single use module 634 to/from the multiple use module 650.

Referring to FIGS. 13A-14C, the single use module 634 will next be described in terms of the components included therein. After that, exemplary forward and retrograde flow modes are traced through the described components.

Referring first to FIG. 13A, the disposable module 634 includes a chassis 635 having upper 750a and lower 750b sections. The upper section 750a includes a platform 752 for supporting various components. The lower section 750b supports the platform 752 and includes structures for pivotably connecting with the multiple use module 650. More particularly, the lower chassis section 750b includes the C-shaped mount 656 for rigidly mounting the perfusion fluid pump interface assembly 300, and the projection 662 for sliding into and snap fitting with the slot 660. The lower chassis section 750b also provides structures for mounting the oxygenator 114. As shown in FIGS. 14A and 14C, the lower section 750b further includes structures for mounting the heater assembly 110. Additionally, the reservoir 160 mounts to the underside of the platform 725 and extends into the lower chassis section 750b. Various sensors, such as the O₂ saturation and hematocrit sensor 140 (shown in FIG. 13A), the flow rate sensor 136 (shown in FIG. 13A), the flow rate sensor 138 (shown in FIG. 14B), are located within and/or mount to the lower chassis section 750b. The flow pressure compliance chamber 188 (shown in FIG. 14B) is also located in the lower chassis section 750b. As shown in FIG. 13D, the lower chassis section 750b also mounts the front-end circuit board 637. Conduits located in the lower chassis section 750b are described in further detail below with reference to the normal and retrograde flow paths through the single use module 634.

Referring to FIGS. 13A-14C, and as mentioned above, the upper chassis section 750a includes the platform 752. The platform 752 includes handles 752a and 752b formed therein to assist in installing and removing the single use module 634 from the multiple use module 650. Alternatively, such handles can be located on the platform 757 to allow for easier accessibility during installation of the single use module into the multiple use module. As shown most clearly in FIG. 13C, an angled platform 757 mounts onto the platform 752. The organ chamber assembly 104 mounts to the angled platform 757. According to the illustrative embodiment, with the single use module 634 installed within the multiple use module 650, the platform 757 is angled at about 10° to about 80° relative to horizontal, to provide an optimal angle of operation for the heart 102 when placed within the organ chamber assembly 104. In some illustrative embodiments, the platform 757 is angled at about 20° to about 60°, or about 30° to about 50° relative to horizontal. The flow mode selector valve 112, the flow rate sensor 134, and the perfusion fluid flow pressure compliance chambers 184 and 186 also mount onto the angled platform 757.

Referring to FIG. 13E, several fluid ports mount to the platform 752. For example, a fluid sampling port 754 enables an operator to sample the flow into and/or out of the aorta 158 via the cannulation interface 162 on the organ chamber assembly 104. A fluid sampling port 755 enables the operator to sample the flow into the left atrium 152 via the interface 170 on the organ chamber assembly 104. Additionally, a fluid port 758 enables the operator to sample the coronary flow out of the pulmonary artery 164 via the pulmonary artery interface 166 on the organ chamber 104. According to the illustrative embodiment, the operator turns a respective valve 754a, 755a or 758a to obtain flow from the sampling ports 754, 755 and 758. Flow from the particular port selected is provided at a single common outlet 764. According to one feature, only flow from the left most port selected is provided at the outlet 764. By way of example, if the operator opens both ports 755 and 758, only flow from port 755 is provided at the outlet 764. In this way, system 100 reduces the likelihood of an operator mixing samples from multiple ports.

The single use module 634 also includes a general injection port 762, operable with the valve 762a, for enabling the operator to inject medication into the perfusion fluid 108, for example, via the reservoir 160. Both the sampling 764 and injection 762 ports mount to the platform 752. Also located on the upper chassis section 750a is an infusion port 766, operable with the valve 766a, for flowing the nutritional 116 and preservative 118 fluids into the perfusion fluid 108. The upper chassis section 750a also includes a tube 774 for loading the exsanguinated blood from the donor into the reservoir 160. As shown in FIG. 13D, the single use module 634 also includes non-vented caps 776 for replacing vented caps on selected fluid ports that are used while running a sterilization gas through the single use module 634 during sterilization. Preferably, such sterilization takes place prior to packaging the single use module 634 for sale.

The upper chassis section 750a also includes the flow clamp 190 for regulating back pressure applied to the left atrium 152 when the heart 102 is cannulated and operating in normal flow mode in the organ chamber assembly 104. The upper chassis section 750a further includes a trickle valve 768. The trickle valve 768 may be opened and closed with the handle 768a to regulate a small fluid flow to the left atrium 152 to moisten the left atrium 152 during retrograde flow mode. The upper chassis section 750a also includes ports 770 for infusion of additional solutions and 772 for purging the oxygenator 114, operable with respective valves 770a and 772a.

As shown most clearly in FIGS. 13A and 13D, the upper chassis section 750 further includes the flow pressure probes 126, 128 and 130. As described above with reference to FIG. 1, the probe 126 measures the pressure of the perfusion fluid 108 flowing into/out of the aorta 158, (pressure sensor/probe 126 is also referred to as an aortic pressure sensor herein). The probe 128 measures the pressure of the perfusion fluid 108 flowing into the left atrium 152 through the pulmonary vein 168. The probe 130 measures the pressure of the perfusion fluid 108 flowing out of the pulmonary artery 164. Each probe includes a respective connector 126a, 128a and 130a (shown shortened for clarity) for coupling a respective signal 129, 131, and 133 to the front-end circuit board 637.

Referring particularly to the single use module 654 cross-sectional side view of FIG. 13C, the reservoir 160 includes several components. More specifically, the reservoir 160 includes four inlets: 782, 784, 786 and 788. The inlet 782 transfers perfusion fluid 108 from the drain 201 of the organ chamber 194 into the reservoir 160. The inlet 784 receives exsanguinated blood from the tube 774. The inlet 786 receives oxygenated perfusion fluid 108 from the oxygenator 114, and the inlet 788 receives perfusion fluid 108 out of the aorta 158 via the back pressure clamp 190. The reservoir 160 also has an outlet 790, which provides the perfusion fluid to the one way inlet valve 191. The reservoir 160 further includes a defoamer 778 and a filter 780. The defoamer 778 removes bubbles out of the perfusion fluid 108 as it enters the reservoir 160. According to the illustrative embodiment, the defoamer is made of porous polyurethane foam with an antifoam coating. The filter 780 is a polyester felt, which filters debris, blood particles, emboli, and air bubbles out of the perfusion fluid as it enters the reservoir 160.

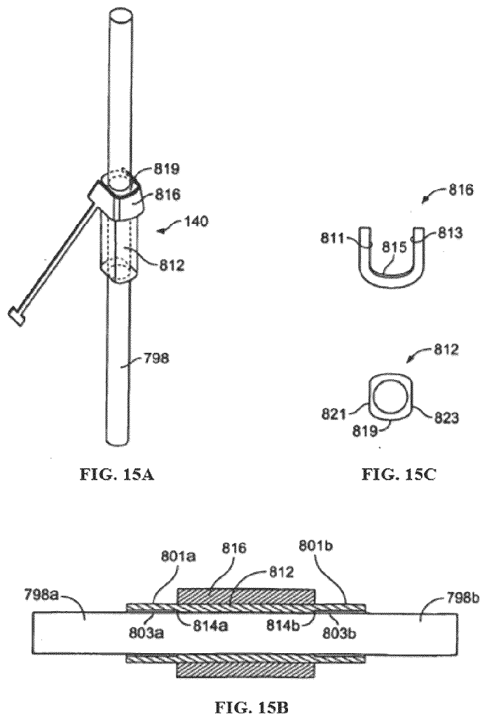

As mentioned above in the summary, the O₂ saturation and hematocrit sensor 140 employed in the single use module 634 includes important advantages over prior art approaches. FIGS. 15A-15C depict an illustrative embodiment of the O₂ saturation and hematocrit sensor 140 of the invention. As shown in FIG. 15A, the sensor 140 includes an in-line cuvette shaped section of tube 812 connected to the conduit 798, which has at least one optically clear window through which an infrared sensor can provide infrared light. Exemplary sensors used in the in-line cuvette-shaped tube 812 are those made by Datamed, BL0P4. As shown in the cross-sectional view of FIG. 15B, the cuvette 812 is a one-piece molded part having connectors 801a and 801b. The connectors 801a and 801b are configured to adjoin to connecting receptacles 803a and 803b, respectively, of conduit ends 798a and 798b. This interconnection between cuvette 812 and conduit ends 798a and 798b is configured so as to provide a substantially constant cross-sectional flow area inside conduit 798 and cuvette 812. The configuration thereby reduces, and in some embodiments substantially removes, discontinuities at the interfaces 814a and 814b between the cuvette 812 and the conduit 798. Reduction/removal of the discontinuities enables the blood based perfusion fluid 108 to flow through the cuvette with reduced lysing of red blood cells and reduced turbulence, which enables a more accurate reading of perfusion fluid oxygen levels. This also reduces damage to the perfusion fluid 108 by the system 100, which ultimately reduces damage done to the heart 102 while being perfused by the system 100.

According to the illustrative embodiment, the cuvette 812 is formed from a light transmissive material, such as any suitable light transmissive glass or polymer. As shown in FIG. 15A, the sensor 140 also includes an optical transceiver 816 for directing light waves at perfusion fluid 108 passing through the cuvette 812 and for measuring light transmission and/or light reflectance to determine the amount of oxygen in the perfusion fluid 108. As illustrated in FIG. 15C, in some embodiments a light transmitter is located on one side of the cuvette 812 and a detector for measuring light transmission through the perfusion fluid 108 is located on an opposite side of the cuvette 812. FIG. 15C depicts a top cross-sectional view of the cuvette 812 and the transceiver 816. The transceiver 816 fits around cuvette 812 such that transceiver interior flat surfaces 811 and 813 mate against cuvette flat surfaces 821 and 823, respectively, while the interior convex surface 815 of transceiver 816 mates with the cuvette 812 convex surface 819. In operation, when UV light is transmitted from the transceiver 816, it travels from flat surface 811 through the fluid 108 inside cuvette 812, and is received by flat surface 813. The flat surface 813 may be configured with a detector for measuring the light transmission through the fluid 108.

The fluid flow path through the single use module 634 in both normal and retrograde flow modes will now be described with reference to FIGS. 13A-13D and FIG. 14A. As described above with reference to FIGS. 1-4, the system 100 can maintain the heart 102 in two modes of operation; a normal flow mode, shown in FIG. 3, and a retrograde flow mode shown in FIG. 4. As mentioned above with regard to FIG. 1, to change between normal and retrograde flow modes, the system 100 provides the flow mode selector valve 112. To operate in normal flow mode, the operator sets the flow mode selector valve handle 112e to the position indicated in FIG. 13A. This has the effect of aligning the flow paths through the selector valve 112. Specifically, in normal flow mode, fluid can flow into port 112b, through the flow channel 112f and out the port 112c. Additionally, fluid can flow into port 112d, through the flow channel 112g and out the port 112a. To operate in retrograde flow mode, the operator sets the flow mode selector valve handle 112e to the position indicated in FIG. 13B. This has the effect of aligning the flow paths through the selector valve 112. Specifically, in retrograde flow mode, fluid can flow into port 112b, through the flow channel 112 h and out the port 112d.

Referring to FIG. 13A, in normal flow mode, the reservoir 160 provides the perfusion fluid 108 to the one way inlet valve 191 of the perfusion pump interface assembly 300. Referring to FIG. 14A, the perfusion pump 106 pumps the perfusion fluid 108 out the outlet valve 310. Referring to FIG. 14C, the perfusion fluid 108 then flows through the conduit 792 and the compliance chamber 188 and into the inlet 110a of the heater assembly 110. The heater assembly 110 heats the perfusion fluid 108 and then flows it out the heater outlet 110b. Referring to FIG. 13A, the heated perfusion fluid 108 flows from the heater outlet 110b in the lower chassis section 750b through the chassis plate 752 and into the port 112b of the mode select valve 112 via the conduit 794. Referring also to FIG. 13D, the perfusion fluid 108 flows out the mode valve port 112c, through the compliance chamber 186, the conduit 796, and the pressure sensor 128 into the pulmonary vein cannulation interface 170 on the organ chamber assembly 104.

Referring to FIG. 13A, in normal flow mode, the heart 102 pumps the perfusion fluid 108 out the pulmonary artery 164 through the pulmonary artery interface 166 and the pressure sensor 130. The conduit 796 then flows the perfusion fluid 108 from the pulmonary artery interface 166 through the plate 752 and through the O₂ saturation and hematocrit sensor 140. Referring also to FIGS. 14A and 14C, the conduit 798 then flows the perfusion fluid 108 from the sensor 140 through the flow-rate sensor 136 into the oxygenator 114. The conduit 800 flows the perfusion fluid 108 from the oxygenator 114 back into the reservoir 160 by way of the reservoir inlet 786.

Referring to FIGS. 13A, 13D and 13E, in normal flow mode, the heart 102 also pumps the perfusion fluid 108 out of the aorta 158 through the aorta interface 162 and the pressure sensor 126. The conduit 802 flows the perfusion fluid 108 from the pressure sensor 126 through the flow rate sensor 134 and back into the port 112d on the flow mode selector valve 112. A clamp 804 holds the conduit 802 in place. A conduit 806 flows the perfusion fluid 108 out the port 112a from the flow mode selector valve 112 through the compliance chamber 184 and the back pressure adjustment clamp 190. As mentioned above, the clamp 190 may be adjusted to restrict flow through the conduit 806 to adjust the back pressure seen by the aorta 158 during normal flow mode to more realistically simulate normal physiologic conditions. The compliance chamber 184, which can expand and contract as perfusion fluid 108 is pumped into and out of it, interoperates with the clamp 190 to dampen flow pressure spikes to further improve simulation of near-normal physiologic conditions. The after-load clamp 190 is configured to closely emulate systemic vascular resistance of the human body which affects aortic pressure, left atrial pressure, and coronary flow. A conduit 808 returns the perfusion fluid 108 into the reservoir 160 by way of the reservoir inlet 788.

In retrograde flow mode, the flow mode selector valve 112 is positioned as shown in FIG. 13B. Referring to FIG. 13B, the reservoir 160 provides the perfusion fluid 108 to the inlet valve 191. As shown in FIG. 14A, the perfusion pump 106 pumps the perfusion fluid 108 out the outlet valve 310. As shown in FIG. 14C, the perfusion fluid 108 then flows through the conduit 792 and the compliance chamber 188 and into the inlet 110a of the heater assembly 110. The heater assembly 110 heats the perfusion fluid 108 and then flows it out the heater outlet 110b. Referring to FIG. 13B, the heated perfusion fluid 108 flows from the heater outlet 110b in the lower chassis section 750b through the chassis plate 752 and into the input 112b of the mode select valve 112 via the conduit 794. Referring also to FIG. 13D, the perfusion fluid 108 flows out the mode valve outlet 112d, into the conduit 802, through the flow rate sensor 134, the pressure sensor 126 and into the aorta 158 via the aorta interface 162. The perfusion fluid 108 then flows through the coronary sinus 155 and the rest of the coronary vasculature.

Referring to FIG. 13B, in retrograde flow mode, the heart 102 pumps the perfusion fluid 108 out of the pulmonary artery 164 and through the pulmonary artery interface 166 and the pressure sensor 130. The conduit 796 then flows the perfusion fluid from the pulmonary artery interface 166 through the plate 752 and into the O₂ saturation and hematocrit sensor 140. Referring also to FIGS. 14A and 14C, the conduit 798 then flows the perfusion fluid 108 from the sensor 140 through the flow rate sensor 136 into the oxygenator 114. The conduit 800 flows the perfusion fluid 108 from the oxygenator 114 back into the reservoir 160 by way of the reservoir inlet 786. In retrograde flow mode, substantially no perfusion fluid is pumped into or out of the left atrium 152 via the pulmonary vein 168 and the pulmonary vein interface 170, with the exception of a small amount of perfusion fluid diverted by the trickle valve 768 from the conduit 794 around the flow mode selector valve 112 into the compliance chamber 186. As mentioned above, the trickle flow provides sufficient perfusion fluid 108 to keep the left atrium 152 moistened during retrograde flow.

As described above, the illustrative embodiment of the system 100 has one or more sensors or probes for measuring fluid flow and pressure. The probes and/or sensors may be obtained from standard commercial sources. The flow rate sensors 134, 136 and 138 are conventional, ultrasonic flow sensors, such as those available from Transonic Systems Inc., Ithaca, N.Y. The fluid pressure probes 126, 128 and 130 may be conventional, strain gauge pressure sensors available from MSI or G.E. Thermometrics. Alternatively, a pre-calibrated pressure transducer chip can be embedded into organ chamber connectors and wired to a data collection site such as the front-end board 637.

FIGS. 16-21 show various views of a single use disposable module according to another illustrative embodiment of the invention. FIG. 16 illustrates a front view of an exemplary single use disposable module. The module provides the sterile blood circuit and protective environment for a heart within the organ care system. As described above, the module can include a heart chamber 104; a pulmonary artery (PA) line 1618; a prime and blood inlet port 1617; a sample, vent, and infusion port 1619; a reservoir 160; a pump compliance chamber 1620; a gas line connector 1621; a gas oxygenator 114; and infusion ports 1622.

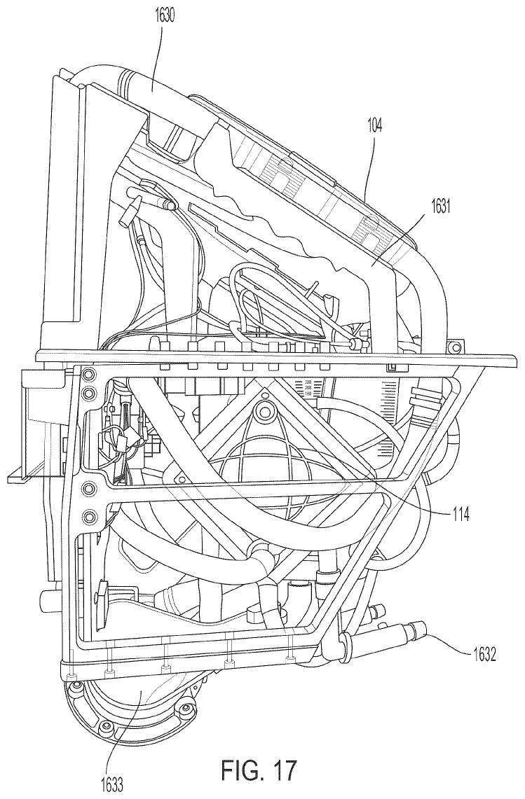

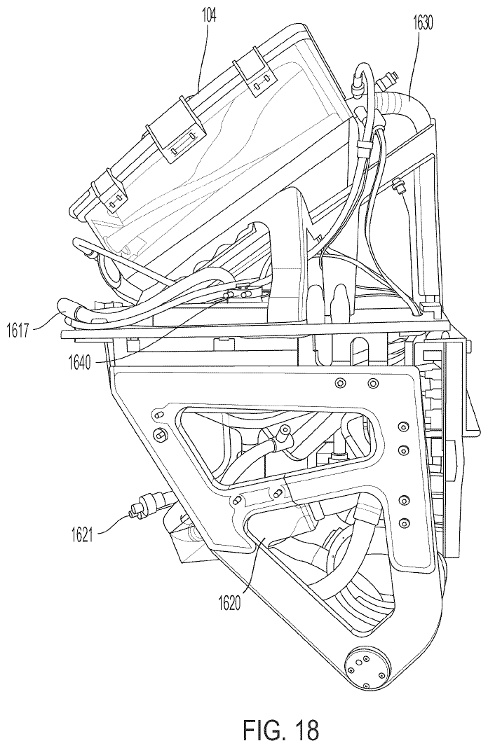

FIGS. 17-18 are side views of an exemplary single use disposable module. As shown in these views, the module can include an aorta (AO) line 1630; a heart chamber 104; a hand grip 1631; a gas oxygenator 114; a chiller connection 1632; a pump interface 1633; a prime and blood inlet port 1617; a defibrillator connection 1640; and a pump compliance chamber 1620; a gas line connector.

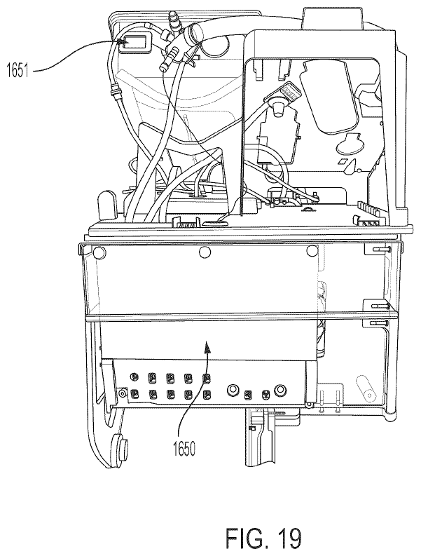

FIG. 19 illustrates a rear view of an exemplary single use disposable module. As shown in this view, the module can include a circuitry board 1650 and a pacing lead window 1651.

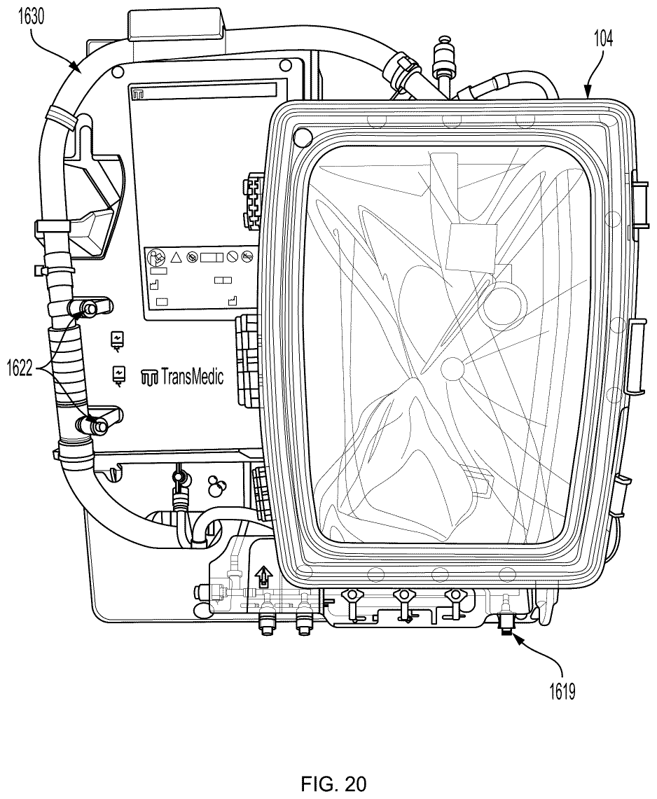

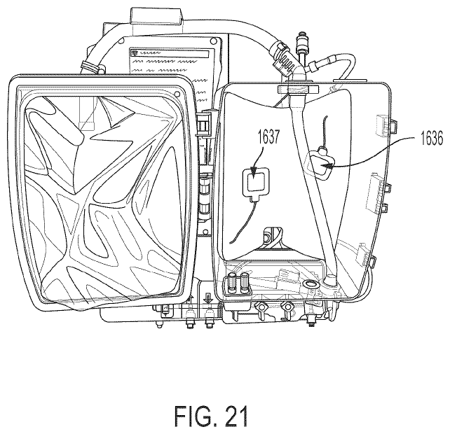

FIGS. 20-21 show top views of an exemplary single use disposable module with FIG. 20 showing the cover of the heart chamber 104 closed and FIG. 21 showing the cover of the heart chamber 104 opened. As shown in these views, the module can include an aorta (AO) line 1630; a heart chamber 104; a sample, vent, and infusion port 1619; infusion ports 1622; defibrillator connection 1640; and defibrillator pads 1636, 1637.

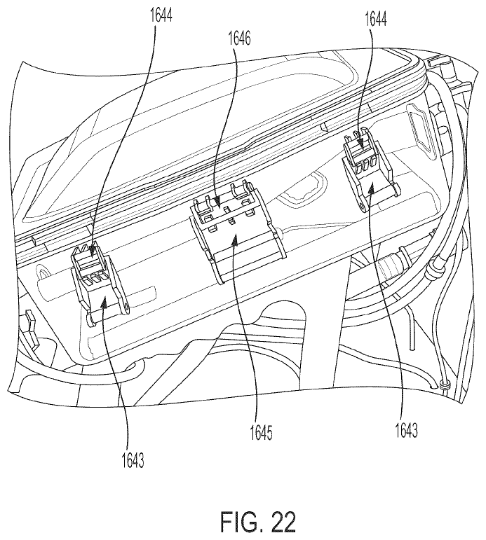

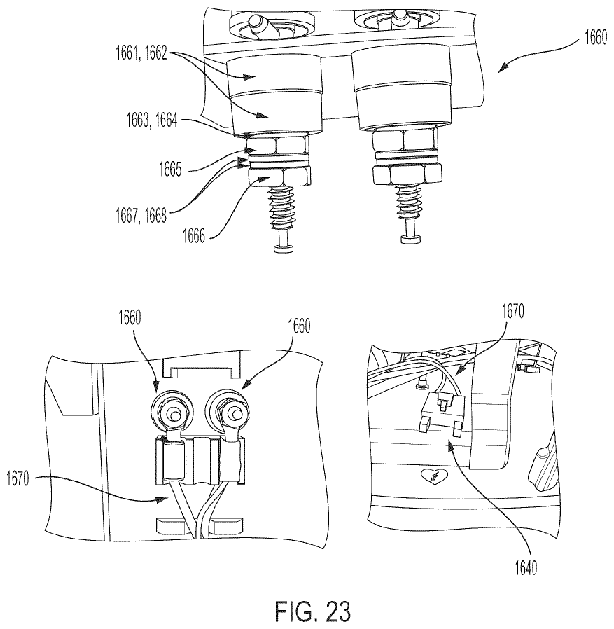

FIG. 22 shows a side view of a heart chamber 104 of an exemplary single use disposable module. As shown in this view, the heart chamber 104 contains latches 1643, 1644, 1645, 1646. FIG. 23 shows exemplary heart chamber ECG/defibrillator binding posts 1660 and wiring 1670 of a single use disposable module according to an illustrative embodiment of the invention. The binding posts include plastic rings 1661, 1662; washers 1663, 1664; nuts 1665, 1666; stars 1667, 1668. The wiring 1670 connections to a defibrillator connection 1640.

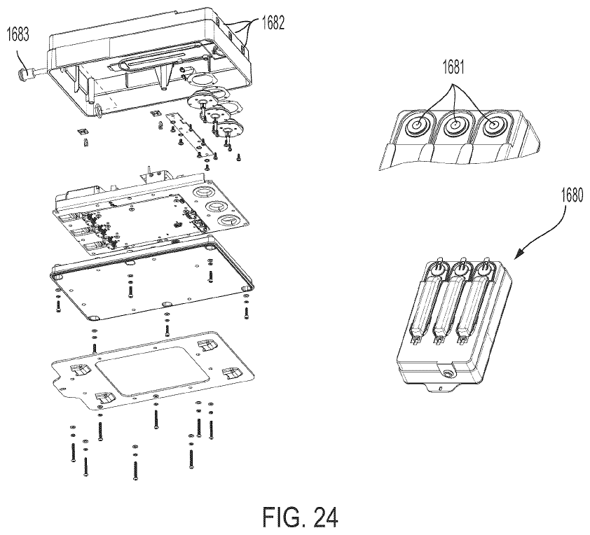

FIG. 24 shows an exploded view of an exemplary solution delivery system (SDS). As described previously, the SDS can be used to administer solutions to the single use disposable module throughout organ preservation. This subsystem can be comprised of a non-disposable SDS Console 1680 and disposable line sets (not shown in FIG. 24). The SDS Console includes pressure sensors 1681, solution delivery channels 1682, and a cable 1683.

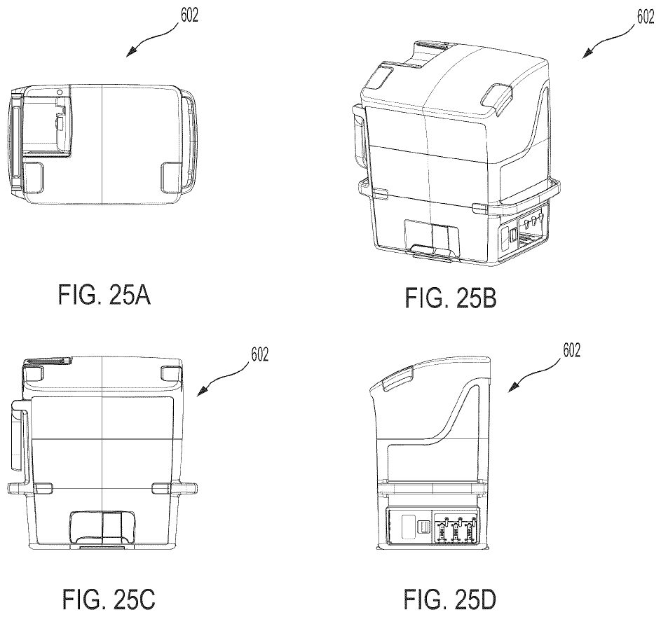

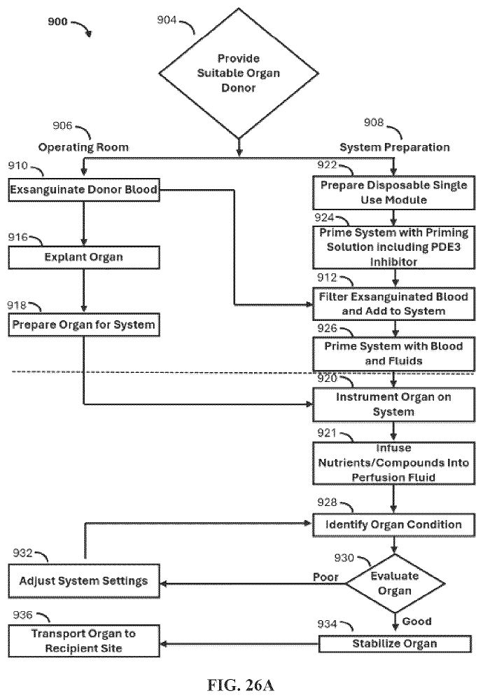

FIGS. 25A-D show different views of a housing 602 of a mechanical implementation 600 of the system of FIG. 1, according to illustrative embodiments of the invention. FIG. 25A is the top view, FIG. 25B is a perspective view, FIG. 25C is a front view, and FIG. 25D is a side view.

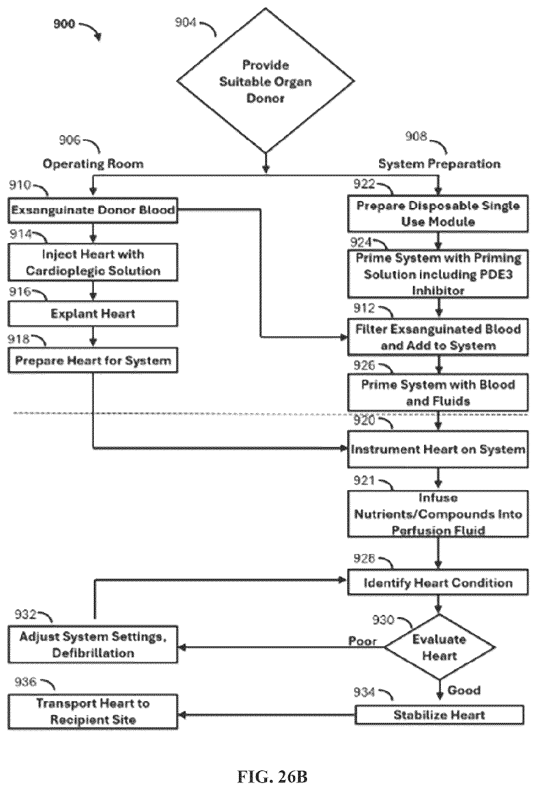

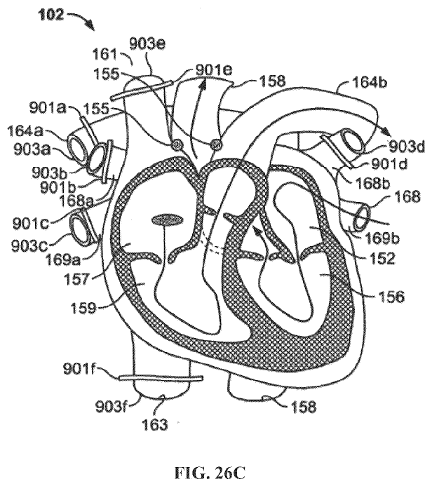

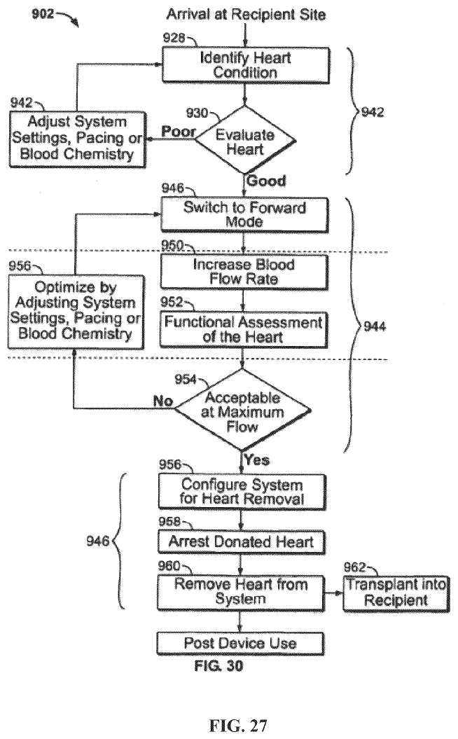

Having described the electrical and mechanical components and functionality of illustrative embodiments of the system 100 and certain modes of operation thereof, the system 100 will next be described with reference to the illustrative organ harvest and transplant procedures of FIGS. 26A-C. More particularly, FIG. 26A is a flow diagram 900 depicting exemplary methodologies for harvesting a donor organ and cannulating it into the system 100 at a donor location. FIG. 26B is a flow diagram 900 depicting exemplary methodologies for harvesting an organ, using the donor heart 102 as an example, and cannulating it into the system 100 at a donor location. FIG. 26C depicts particular points of care for handling the heart 102 in preparation for cannulation, and FIG. 27 is a flow diagram 902 of exemplary methodologies for removing the donor organ 102 from the system 100 and transplanting it into a patient at a recipient site.

As shown in FIG. 26A, the process of obtaining and preparing the donor organ for cannulation and transport begins by providing a suitable organ donor 904. The organ donor is brought to a donor location, whereupon the process of receiving and preparing the donor organ for cannulation and transport proceeds down two intersecting pathways 906 and 908. The pathway 906 principally involves preparing the donor organ for transplant, while the pathway 908 principally involves preparing the system 100 to receive the donor organ and then transporting the organ via system 100 to the recipient site.

With particular reference to FIG. 26A, the first pathway 906 includes exsanguinating the donor 910, arresting the donor organ 914, explanting the organ 916, and preparing the organ 102 for cannulation 918 into the system 100. In particular, in the exsanguination step 910, the donor's blood is removed and set aside so it can be used to perfuse the organ 102 during preservation on the system 100. This step is performed by inserting a catheter into either the arterial or venous vasculature of the donor to allow the donor's blood to flow out of the donor and be collected into a blood collection bag. The donor's blood is allowed to flow out until the necessary amount of blood is collected, typically 1.0-2.5 liters, whereupon the catheter is removed. The blood extracted through exsanguination is then filtered and added to a fluid reservoir 160 of the system 100 in preparation for use with the system 100. Alternatively, the blood can be exsanguinated from the donor and filtered for leukocytes and platelets in a single step that uses an apparatus having a filter integrated with the cannula and blood collection bag. An example of such a filter is a Pall BC2B filter. After the organ is arrested, the organ is explanted 916 from the donor and prepared 918 for loading onto the system 100.

As shown in FIG. 26A, the system 100 is prepared in pathway 908 through a series of steps, which include preparing the single use module 634 (step 922), priming the system 100 with priming solution (step 924), filtering the blood from the donor and adding it to the system 100 reservoir 160 (step 912), and connecting the organ into the system 100 (step 904). In particular, the step 922 of preparing the single use module 634 includes assembling the disposable single use module 634. Suitable assemblies are shown, for example, in FIGS. 13A-13E, FIGS. 14A-14C, FIGS. 16-21, FIGS. 35-37, FIGS. 42A-42F, FIGS. 45A-45D. After the module 634 is assembled, or provided in the appropriate assembly, it is then inserted into multiple use module 650.

In step 924, the loaded system 100 is primed with priming solution, as described in more particular detail below with reference to Table 1. In the next step 912, blood from the donor is filtered and added to the reservoir 160. The filtering process helps reduce the inflammatory process through the complete or partial removal of leukocytes and platelets. Additionally, the donor blood is mixed with one or more nutritional 116 and/or preservative 118 solutions to form the perfusion fluid 108. In step 926, the system 100 is primed with the perfusion fluid 108 by pumping it through the system 100 in the retrograde flow mode, and with the bypass conduit 810 in place. As the perfusion fluid 108 circulates through the system 100 in priming step 926, it is warmed to the desired temperature. In step 920, after the system 100 is primed with the perfusion fluid 108, the bypass conduit 810 is removed, and the organ (e.g., heart, lung, liver, kidney) is instrumented onto the system 100.

In step 921, nutrients and compounds are infused into the perfusion fluid. This step may occur simultaneously with the initiation of perfusion following step 920 or after a delay.

After the organ (e.g., heart, lung, liver, kidney) is instrumented onto the system 100 at step 920 and nutrient and compound infusion is delivered at step 921, subsequent steps 928 and 930 allow the operator to test the organ and the system 100, and to evaluate their respective conditions. Step 928 and 930 can include measuring and evaluating a lactate level, edema formation, mean aortic pressure, coronary flow rate, contraction band injury, pulmonary artery pressure, oncotic pressure, hepatic artery pressure, portal vein pressure, and/or renal artery pressure to determine whether the organ is in suitable condition for transplantation.

During the evaluation step 930, based on the data and other information obtained during testing 928, the operator determines whether and how to adjust the system 100 properties (e.g., fluid flows, pressures, and temperatures), and whether to provide additional treatment to the organ. The operator makes any such adjustments in step 932, then repeats steps 928 and 930 to re-test and re-evaluate the organ and the system 100. In certain embodiments, the operator may also opt to perform surgical, therapeutic or other procedures on the organ during the adjustment step 932.

In another application, during or after step 932, the system 100 allows a medical operator to evaluate the organ for compatibility with an intended recipient after explantation but prior to implantation into the donor. For example, the operator can perform a Human Leukocyte Antigen (HLA) matching test on the organ while the organ is cannulated to the system 100. Such tests may require 12 hours or longer and are performed to ensure compatibility of the organ with the intended recipient. The preservation of an organ using the system 100 described above may allow for preservation times in excess of the time needed to complete an HLA match, potentially resulting in improved post-transplant outcomes. In the HLA matching test example, the HLA test can be performed on the heart while a preservation solution is pumping into the heart.

According to a further illustrative embodiment, after the organ (e.g., heart, lung, liver, kidney) is functioning as determined by the step 932, the operator can perform surgery on the organ or provide therapeutic or other treatment, such as immunosuppressive treatments, chemotherapy, genetic testing and therapies, or irradiation therapy. Because the system 100 allows the organ to be perfused under near physiological temperature, fluid flow rate, and oxygen saturation levels, the organ can be maintained after the adjustment step 932 for a long period of time (e.g., for a period of at least 3 days or more, greater than at least 1 week, at least 3 weeks, or a month or more) to allow for repeated evaluation and treatment.

According to the illustrative embodiment, the testing 928, evaluation 930 and adjustment 932 steps may be conducted with the system 100 operating in retrograde flow mode, or may be conducted with the system 100 operating in normal flow mode. In normal flow mode, the operator can test the function of the organ under normal or near normal physiologic blood flow conditions. Based on the evaluation 930, the settings of the system 100 may be adjusted in step 932, if necessary, to modify the flow, heating and/or other characteristics to stabilize the organ in step 934 in preparation for transport to the recipient site in step 936. After the organ and the system 100 is tested and evaluated to ensure appropriate performance, the system 100 with the loaded organ is transported to the recipient site at step 936.

Turning to FIG. 26B, the process of obtaining and preparing the heart 102 for cannulation and transport begins by providing a suitable organ donor 904. The organ donor is brought to a donor location, whereupon the process of receiving and preparing the donor heart 102 for cannulation and transport proceeds down two intersecting pathways 906 and 908. The pathway 906 principally involves preparing the donor heart 102 for transplant, while the pathway 908 principally involves preparing the system 100 to receive the donor heart 102 and then transporting the heart 102 via system 100 to the recipient site.

With particular reference to FIG. 26B, the first pathway 906 includes exsanguinating the donor 910, arresting the donor heart 914, explanting the heart 916, and preparing the heart 102 for cannulation 918 into the system 100. In particular, in the exsanguination step 910, the donor's blood is removed and set aside so it can be used to perfuse the heart 102 during preservation on the system 100. This step is performed by inserting a catheter into either the arterial or venous vasculature of the donor to allow the donor's blood to flow out of the donor and be collected into a blood collection bag. The donor's blood is allowed to flow out until the necessary amount of blood is collected, typically 1.0-2.5 liters, whereupon the catheter is removed. The blood extracted through exsanguination is then filtered and added to a fluid reservoir 160 of the system 100 in preparation for use with the system 100. Alternatively, the blood can be exsanguinated from the donor and filtered for leukocytes and platelets in a single step that uses an apparatus having a filter integrated with the cannula and blood collection bag. An example of such a filter is a Pall BC2B filter. After the donor's blood is exsanguinated, the donor heart 102 is injected in step 914 with a cardioplegic solution to temporarily halt beating in preparation for harvesting the heart 102.

After the heart 102 is arrested, the heart 102 is explanted 916 from the donor and prepared 918 for loading onto the system 100. In general, the steps of explanting the heart 916 and preparing for loading 918 involve severing the connections between the vasculature of the heart 102 and the interior chest cavity of the donor, suturing various of the severed connections, then lifting the heart 102 from the chest cavity.

More particularly, as shown in FIG. 26C, the right and left pulmonary arteries 164a and 164b are severed, and the right pulmonary artery 164a is tied-off by a surgical thread 901a or other suitable mechanism. The tying prevents fluid from flowing through the severed end 903a of the left pulmonary artery 164a. As described above with reference to FIGS. 13A-13B, the left pulmonary artery 164b remains unsutured to allow it to be cannulated to the organ chamber assembly 104, thereby allowing perfusion fluid 108 to flow through the left pulmonary artery 164b, through the pulmonary artery cannulation interface 170, and back to the reservoir 160. The left pulmonary veins 168b and 169b and the right pulmonary veins 168a and 169a are also severed, and all except a single pulmonary vein 169b are tied off with surgical thread 901b, 901c, and 901d, respectively. This prevents fluid from flowing through the severed ends 903b and 903c of the right pulmonary veins 168a and 169a, or through the severed end 903d of the left pulmonary vein 168b, but allows the untied pulmonary vein to be cannulated to the organ chamber assembly 104 through the pulmonary vein interface 170. As described above with reference to FIGS. 13A-13B, this arrangement allows the perfusion fluid 108 to flow through the right pulmonary artery 164b, through the pulmonary artery interface 166, and back to the oxygenator 114. Alternatively, blood can be expelled from the right ventricle via cannulating the pulmonary arterial trunk. The pulmonary arterial trunk is not shown but includes the segment of pulmonary artery 164 between the branches 164a and 164b of the pulmonary artery 164 and the right ventricle 159. The superior vena cava 161 is also severed and, once the heart is connected to the system 100 and begins beating, is tied with thread 90le to prevent fluid from flowing through its end 903e. The inferior vena cava 163 is similarly severed and tied with thread 901f or oversewn to prevent fluid from flowing through its end 903f. The aorta 158 is also severed (in the illustrated embodiment at a point downstream from the coronary sinus 155) but is not tied off, allowing it to be cannulated to the organ chamber assembly 104. In one embodiment, the aorta 158 is cannulated to an aortic connector, which can be easily attached to the aorta interface 170.

With continued reference to the flow chart of FIG. 26B, after the heart vasculature is severed and appropriately tied, the heart 102 is then loaded onto the system 100 by inserting it into the organ chamber assembly 104 and cannulating the aorta 158, left pulmonary artery 164b, and a pulmonary vein 169b to the appropriate points in the organ chamber assembly 104.

Often, hearts obtained from donors who have also donated their lungs are missing part or all of the left atrium 152. In this situation, the heart 102 can still be instrumented and perfused in the retrograde mode by cannulating the aorta 158 and either the right pulmonary artery 164a or pulmonary artery trunk (not shown, but described above), and allowing any remaining left atrium 152 portion to remain open during the preservation period.

With continued reference to FIG. 26B, during the preparation of the heart via path 906, the system 100 is prepared through the steps of path 908 so it is primed and waiting to receive the heart 102 for cannulation and transport as soon as the heart 102 is prepared. By quickly transferring the heart 102 from the donor to the system 100, and subsequently perfusing the heart 102 with the perfusion fluid 108, a medical operator can minimize the amount of time the heart 102 is deprived of oxygen and other nutrients, and thus reduce ischemia and other ill effects that arise during current organ care techniques. In certain embodiments, the amount of time between infusing the heart 102 with cardioplegic solution and beginning flow of the perfusion fluid 108 through the heart 102 via the system 100 is less than about 15 minutes. In other illustrative embodiments, the between-time is less than about ½ hour, less than about 1 hour, less than about 2 hours, or even less than about 3 hours. Similarly, the time between transplanting the heart into an organ care system 100 and bringing the heart 102 to a near physiological temperature (e.g., between about 34 degrees C. and about 37 degrees C.) occurs within a brief period of time so as to reduce ischemia within the heart tissues. In some illustrative embodiments, the period of time is less than about 5 minutes, while in other applications it may be less than about ½ hour, less than about 1 hour, less than about 2 hours, or even less than about 3 hours. According to some illustrative embodiments, the heart can be transferred directly from the donor to the system 100, without the use of cardioplegia, and in such applications the time to beginning the flow of warm perfusion fluid 108 and/or time to the heart reaching near physiologic temperature is similarly less than about 5 minutes, less than about ½ hour, less than about 1 hour, less than about 2 hours, or even less than about 3 hours. In one implementation, the donor heart is not arrested prior to removal from the donor, and is instrumented onto the system 100 while the heart 102 is still beating.

As shown in FIG. 26B, the system 100 is prepared in pathway 908 through a series of steps, which include preparing the single use module 634 (step 922), priming the system 100 with priming solution which can contain a PDE3 inhibitor (step 924), filtering the blood from the donor and adding it to the system 100 reservoir 160 (step 912), and connecting the heart 102 into the system 100 (step 904). In particular, the step 922 of preparing the single use module 634 includes assembling the disposable single use module 634. Suitable assemblies are shown, for example, in FIGS. 13A-13E, FIGS. 14A-14C, FIGS. 16-21, FIGS. 35-37, FIGS. 42A-42F, FIGS. 45A-45D. After the module 634 is assembled, or provided in the appropriate assembly, it is then inserted into multiple use module 650.

In step 924, the loaded system 100 is primed with priming solution, as described in more particular detail below with reference to Table 1. In some embodiments, the priming solution contains a PDE3 inhibitor. According to one feature, to aid in priming, the system 100 provides an organ bypass conduit 810 shown installed into the organ chamber assembly 104. The bypass conduit includes three segments 810a-810c. Segment 810a attaches to the pulmonary artery cannulation interface 166. The segment 810b attaches to the aorta cannulation interface 162, and the segment 810c attaches to the pulmonary vein cannulation interface 170. Using the bypass conduit 810 so attached/cannulated into the organ chamber assembly 104, an operator can cause the system 100 to circulate the perfusion fluid 108 through all of the paths used during actual operation. This enables the system 100 to be thoroughly tested and primed prior to cannulating the heart 102 into place.

In the next step 912, blood from the donor is filtered and added to the reservoir 160. The filtering process helps reduce the inflammatory process through the complete or partial removal of leukocytes and platelets. Additionally, the donor blood is mixed with one or more nutritional 116 and/or preservative 118 solutions to form the perfusion fluid 108. In some embodiments, the perfusion fluid contains a PDE3 inhibitor. In step 926, the system 100 is primed with the perfusion fluid 108 (which may contain a PDE3 inhibitor) by pumping it through the system 100 in the retrograde flow mode, as described above in reference to FIGS. 4, 5 and 13B, and with the bypass conduit 810 in place. As the perfusion fluid 108 circulates through the system 100 in priming step 926, it is warmed to the desired temperature as it passes through heater assembly 110. In step 920, after the system 100 is primed with the perfusion fluid 108, the bypass conduit 810 is removed, and the heart 102 is instrumented onto the system 100.

After the heart 102 is instrumented onto the system 100, the pump 104 is activated and the flow mode valve 112 is positioned in retrograde flow mode (described above with reference to FIGS. 1, 4, and 5) to pump the perfusion fluid 108 in retrograde flow mode through the aorta into the vasculature of the heart 102. The pumping of the warm, oxygen and nutrient enriched perfusion fluid 108 through the heart 102 allows the heart 102 to function ex-vivo in a near normal physiologic state. In particular, the warm perfusion fluid 108 warms the heart 102 as it perfuses through it, which may cause the heart 102 to resume beating in its natural fashion. In some instances, it is desirable to assist the heart 102 in resuming its beating, which may be done by providing hand massage or a defibrillation signal 143 to the heart 102. In step 921, a nutrient, e.g., glucose, is infused into the perfusion fluid. In some embodiments, a compound such as a PDE3 inhibitor is infused into the perfusion fluid at step 921. Step 921 may occur simultaneously with the initiation of perfusion following step 920 or after a delay.

After the heart is instrumented onto the system 100 at step 920 and nutrient/compound infusion is delivered at step 921, subsequent steps 928 and 930 allow the operator to test the heart 102 and the system 100, and to evaluate their respective conditions. The PDE3 inhibitor may be included in step 924, 926, and/or 921. Illustratively, step 928 involves evaluating ECG signals 379 and 381 from the sensors 142 and 144, respectively, as well as hematocrit 145 and oxygen saturation 141 levels of the perfusion fluid 108 from the sensor 140. Step 928 and 930 can include measuring and evaluating a lactate level, edema formation, mean aortic pressure, coronary flow rate, and/or contraction band injury to determine whether the heart is in suitable condition for transplantation. As further described in reference to FIG. 7 and FIGS. 10, the operator can also monitor the fluid flows, pressures, and temperatures of the system 100 while the heart 102 is cannulated. The testing step 928 may also include having the operator touch/examine the heart 102 by lifting an outer lid 196 of the organ chamber 104 and touching/examining the heart 102 indirectly through the flexible membrane 198b. During the evaluation step 930, based on the data and other information obtained during testing 928, the operator determines whether and how to adjust the system 100 properties (e.g., fluid flows, pressures, and temperatures), and whether to provide additional defibrillation, or other needed modes of treatment to the heart 102. The operator makes any such adjustments in step 932, then repeats steps 928 and 930 to re-test and re-evaluate the heart 102 and the system 100. In certain embodiments, the operator may also opt to perform surgical, therapeutic or other procedures on the heart 102 during the adjustment step 932. For example, the operator can conduct an evaluation of the physiological fitness of the heart, such as for example, performing an ultrasound or other imaging test, performing an echocardiogram or diagnostic test on the heart, measuring arterial blood gas levels and other evaluative tests.

In another application, during or after step 932, the system 100 allows a medical operator to evaluate the organ for compatibility with an intended recipient after explantation but prior to implantation into the donor. For example, the operator can perform a Human Leukocyte Antigen (HLA) matching test on the organ while the organ is cannulated to the system 100. Such tests may require 12 hours or longer and are performed to ensure compatibility of the organ with the intended recipient. The preservation of an organ using the system 100 described above may allow for preservation times in excess of the time needed to complete an HLA match, potentially resulting in improved post-transplant outcomes. In the HLA matching test example, the HLA test can be performed on the heart while a preservation solution is pumping into the heart.

According to a further illustrative embodiment, after the heart is functioning as determined by the step 932, the operator can perform surgery on the heart or provide therapeutic or other treatment, such as immunosuppressive treatments, chemotherapy, genetic testing and therapies, or irradiation therapy. Because the system 100 allows the heart 102 to be perfused under near physiological temperature, fluid flow rate, and oxygen saturation levels, the heart 102 can be maintained after the adjustment step 932 for a long period of time (e.g., for a period of at least 3 days or more, greater than at least 1 week, at least 3 weeks, or a month or more) to allow for repeated evaluation and treatment.

According to the illustrative embodiment, the testing 928, evaluation 930 and adjustment 932 steps may be conducted with the system 100 operating in retrograde flow mode, or may be conducted with the system 100 operating in normal flow mode. In normal flow mode, the operator can test the function of the heart 102 under normal or near normal physiologic blood flow conditions. Based on the evaluation 930, the settings of the system 100 may be adjusted in step 932, if necessary, to modify the flow, heating and/or other characteristics to stabilize the heart 102 in step 934 in preparation for transport to the recipient site in step 936. After the heart 102 and the system 100 is tested and evaluated to ensure appropriate performance, the system 100 with the loaded heart 102 is transported to the recipient site at step 936.

Referring now to FIG. 27, the first phase 942 of the transplant process involves repeating the testing 928 and evaluation 930 steps undertaken just prior to leaving the donor site 936. If the function and characteristics of the heart 102 are not acceptable, the system 100 can be adjusted 942 as appropriate, for example, to provide appropriate fluid oxygenation or nutritional levels, or to increase or decrease the appropriate fluid temperature. As noted above, surgical and/or other therapeutic/remedial procedures may be performed on the heart 102, along with the testing 928 and evaluation 930. According to the illustrative embodiment, testing at the recipient site may be performed in retrograde flow mode, normal flow mode, or a combination of both.

At step 946, after testing is complete, the system 100 may be placed in normal/forward flow mode or maintained in retrograde flow mode. In certain embodiments, this step 946 is not initiated until the left atrium 152 and pulmonary vein 164 are cannulated, there is adequate operating volume in the system, the heart exhibits stable electrical activity, the ABG and electrolytes are within acceptable ranges, SvO₂ is >80%, and blood temperature is between about 34 degrees C. and about 36 degrees C. The step 946 may be accomplished by slowing and/or stopping the retrograde pumping of the system 100, then restarting the pumping in forward mode. In certain embodiments, prior to restarting in forward mode, the user opens the aortic sampling port 754a, releases the pressure control clamp 190 by turning it counterclockwise, then increases the flow rate of pump 106 to about 1.0 L/min, sets the flow control valve 112 to normal/forward flow, and increases the flow rate of pump 106 to about 2.0 L/min to allow the blood 102 to displace air in the perfusate lines (e.g., 802) of the system 100 and pass through the left side of the heart 102 and down the reservoir return line 808. The user then closes the aortic sampling port 754a.

The flow rate of the perfusion fluid 108 emitted from the pump 106 is then increased at step 950 to a level of the clinician's choosing (typically between about 1 L/min to about 5 L/min) to approximate the physiologic flow rate provided by the heart 102 while functioning in normal beating mode. The heart 102 and the system 100 are again tested at step 952 in a similar fashion to that described above with respect to steps 928 and 930. The clinician may also choose to perform any other tests or evaluations on the heart, for example echocardiogram, electrolyte measurements, cardiac enzyme measurements, metabolyte measurements, intravascular ultrasound evaluation, pressure-volume loop evaluation, and Millar pressure evaluation.

In the third phase 946 at the recipient site, the heart 102 is prepared for implantation into the recipient. This phase includes the step 956 of powering down the pump 106 to stop the flow of perfusion fluid 108. Next, in step 958, the heart 102 is arrested, for example by injecting it with cardioplegic solution in a similar fashion to what is done in step 914 at the donor site. In step 960, the heart 102 is de-cannulated and removed from the organ chamber assembly 106. In step 962, the heart 102 is transplanted into the recipient patient by first removing the sutures 901a-901f, then inserting the heart 102 into the recipient's chest cavity, and suturing the various heart vesicles (e.g., 158, 164a, 164b, 168a, 168b, 169a, 169b, and 903a-903f) to their appropriate mating vesicles within the recipient.

While external devices and methods have been described to defibrillate the heart, deliver pacing signals to the heart, and perform blood chemistry analyses from samples taken from the perfusion fluid, it may also be beneficial to integrate these features into the portable system. Such features include defibrillation, pacing, diagnostic ECG sensing, and blood chemistry analyses.

As described above, the system 100 employs a priming solution, and also employs a perfusion fluid 108 that combines a nutritional supplement 116 solution and a preservative solution 118 with a blood product or synthetic blood product to form the perfusion fluid 108. The priming, supplement 116, and preservative 118 solutions are described next. In some embodiments, the priming solution contains a PDE3 inhibitor. In some embodiments, the nutritional supplement 116 solution contains a PDE3 inhibitor. In some embodiments, the preservative solution 118 solution contains a PDE3 inhibitor. In some embodiments, the perfusion fluid 108 solution contains a PDE3 inhibitor. In some embodiments, the PDE3 inhibitor is added to one or more of the priming solution, solution 116, solution 118, and/or perfusion fluid 108.

According to certain embodiments, solutions with particular solutes and concentrations are selected and proportioned to enable the organ to function at physiologic or near physiologic conditions. For example, such conditions include maintaining organ function at or near a physiological temperature and/or preserving an organ in a state that permits normal cellular metabolism, such as protein synthesis.

In certain embodiments solutions are formed from compositions by combining components with a fluid, from more concentrated solutions by dilution, or from more dilute solutions by concentration. In exemplary embodiments, suitable solutions include an energy source (e.g., glucose), one or more stimulants to assist the organ in continuing its normal physiologic function prior to and during transplantation, and one or more amino acids selected and proportioned so that the organ continues its cellular metabolism during perfusion. Cellular metabolism includes, for example conducting protein synthesis while functioning during perfusion. Some illustrative solutions are aqueous based, while other illustrative solutions are non-aqueous, for example organic solvent-based, ionic-liquid-based, or fatty-acid-based.

The solutions may include one or more energy-rich components to assist the organ in conducting its normal physiologic function. These components may include energy rich materials that are metabolizable, and/or components of such materials that an organ can use to synthesize energy sources during perfusion. Exemplary sources of energy-rich molecules include, for example, one or more carbohydrates. Examples of carbohydrates include monosaccharides, disaccharides, oligosaccharides, polysaccharides, or combinations thereof, or precursors or metabolites thereof. While not meant to be limiting, examples of monosaccharides suitable for the solutions include octoses; heptoses; hexoses, such as fructose, allose, altrose, glucose, mannose, gulose, idose, galactose, and talose; pentoses such as ribose, arabinose, xylose, and lyxose; tetroses such as erythrose and threose; and trioses such as glyceraldehyde. While not meant to be limiting, examples of disaccharides suitable for the solutions include (+)-maltose (4-O-(.alpha.-D-glucopyranosyl)-. alpha.-D-glucopyranose), (+)-cellobiose (4-O-(.beta.-D-glucopyranosyl)-D-glucopyranose), (+)-lactose (4-O-(.beta.-D-galactopyranosyl)-. beta.-D-glucopyranose), sucrose (2-O-(.alpha.-D-glucopyranosyl)-. beta.-D-fructofuranoside). While not meant to be limiting, examples of polysaccharides suitable for the solutions include cellulose, starch, amylose, amylopectin, sulfomucopolysaccharides (such as dermatane sulfate, chondroitin sulfate, sulodexide, mesoglycans, heparan sulfates, idosanes, heparins and heparinoids), and glycogen. In some embodiments, monosaccharides, disaccharides, and polysaccharides of both aldoses, ketoses, or a combination thereof are used. One or more isomers, including enantiomers, diastereomers, and/or tautomers of monosaccharides, disaccharides, and/or polysaccharides, including those described and not described herein, may be employed in the solutions described herein. In some embodiments, one or more monosaccharides, disaccharides, and/or polysaccharides may have been chemically modified, for example, by derivatization and/or protection (with protecting groups) of one or more functional groups. In certain embodiments, carbohydrates, such as dextrose or other forms of glucose are preferred. In certain embodiments, a ketone body is preferred.

Other possible energy sources include adenosine triphosphate (ATP), co-enzyme A, pyruvate, flavin adenine dinucleotide (FAD), thiamine pyrophosphate chloride (co-carboxylase), .beta.-nicotinamide adenine dinucleotide (NAD),.beta.-nicotinamide adenine dinucleotide phosphate (NADPH), and phosphate derivatives of nucleosides, e.g., nucleotides, including mono-, di-, and tri-phosphates (e.g., UTP, GTP, GDP, and UDP), coenzymes, or other bio-molecules having similar cellular metabolic functions, and/or metabolites or precursors thereof. For example, phosphate derivatives of adenosine, guanosine, thymidine (5-Me-uridine), cytidine, and uridine, as well as other naturally and chemically modified nucleosides are contemplated.

In certain embodiments, one or more carbohydrates is provided along with a phosphate source, such as a nucleotide. The carbohydrate helps enable the organ to produce ATP or other energy sources during perfusion. The phosphate source may be provided directly through ATP, ADP, AMP or other sources. In other illustrative embodiments, a phosphate is provided through a phosphate salt, such as glycerophosphate, sodium phosphate or other phosphate ions. A phosphate may include any form thereof in any ionic state, including protonated forms and forms with one or more counter ions.

The solutions may include one or more organ stimulants for assisting the organ's normal physiologic function during perfusion. In some illustrative embodiments, where the transplanted organ is a heart, cardio stimulants are provided to enable the heart to continue functioning (e.g., continue beating) during perfusion and transplantation. Such stimulants may include, for example, catecholamines, such as epinephrine and/or norepinephrine, which facilitate beating of the heart. Other cardio stimulants may be used, such as certain forms of peptides and/or polypeptides (e.g., vasopressin, Anthropleurin-A and Anthropleurin-B), and/or. beta. 1/.beta.2-adrenoreceptor blocking agents (such as CGP 12177), bupranolol, pindolol, alprenolol, and cardiac glycosides. One or more natural products may also be used, such as digitalis (digoxin), palustrin, and/or ferulic acid. Stimulants such as those mentioned above can be included with the solutions or added at the point of use by the user.

In some instances, additional components are provided to assist the organ in conducting its metabolism during perfusion. These components include, for example, forms or derivatives of adenine and/or adenosine, which may be used for ATP synthesis, for maintaining endothelial function, and/or for attenuating ischemia and/or reperfusion injury. According to certain implementations, a magnesium ion source is provided with a phosphate, and in certain embodiments, with adenosine to further enhance ATP synthesis within the cells of the perfused organ.

Solutions described herein may include one or more amino acids, preferably a plurality of amino acids, to support protein synthesis by the organ's cells. Suitable amino acids include, for example, any of the naturally occurring amino acids. The amino acids may be, in various enantiomeric or diastereomeric forms. For example, solutions may employ either D-or L-amino acids, or a combination thereof, e.g., solutions enantioenriched in more of the D- or L-isomer or racemic solutions. Suitable amino acids may also be non-naturally occurring or modified amino acids, such as citrulline, ornithine, homocysteine, homoserine, .beta.-amino acids such as .beta.-alanine, amino-caproic acid, or combinations thereof.

Certain exemplary solutions include some but not all naturally occurring amino acids. In some embodiments, solutions include essential amino acids. For example, a solution may be prepared with one or more or all of the following amino-acids:
Glycine
Alanine
Arginine
Aspartic Acid
Glutamic Acid
Histidine
Isoleucine
Leucine
Methionine
Phenylalanine
Proline
Serine
Threonine
Tryptophan
Tyrosine
Valine
Lysine acetate

In certain embodiments, non-essential and/or semi-essential amino acids are not included in the solutions. For example, in some embodiments, asparagine, glutamine, and/or cysteine are not included. In other embodiments, the solution contains one or more non-essential and/or semi-essential amino acids. Accordingly, in other embodiments, asparagine, glutamine, and/or cysteine are included.

The solutions may also contain electrolytes, particularly calcium ions for facilitating enzymatic reactions, cardiac contractility, and/or coagulation within the organ. Other electrolytes may be used, such as sodium, potassium, chloride, sulfate, magnesium and other inorganic and organic charged species, or combinations thereof. It should be noted that any component provided hereunder may be provided, where valence and stability permit, in an ionic form, in a protonated or unprotonated form, in salt or free base form, or as ionic or covalent substituents in combination with other components that hydrolyze and make the component available in aqueous solutions, as suitable and appropriate.

In certain embodiments, the solutions contain buffering components. For example, suitable buffer systems include 2-morpholinoethanesulfonic acid monohydrate (MES), cacodylic acid, H₂CO₃/NaHCO₃(pKₐ₁), citric acid (pKₐ₃), bis(2-hydroxyethyl)-imino-tris-(hydroxymethyl)-methane (Bis-Tris), N-(carbamoylmethyl)iminodiacetic acid (ADA), 3-bis [tris(hydroxymethyl)methylamino]propane (Bis-Tris Propane) (pKₐ₁), piperazine-1,4-bis(2-ethanesulfonic acid) (PIPES), N-(2-Acetamido)-2-aminoethanesulfonic acid (ACES), imidazole, N,N-bis(2-hydroxyethyl)-2-aminoethanesulfonic acid (BES), 3-(N-morpholino) propanesulphonic acid (MOPS), NaH₂PO₄/Na₂HPO₄ (pKₐ₂), N-tris(hydroxymethyl)methyl-2-aminoethanesulfonic acid (TES), N-(2-hydroxyethyl)-piperazine-N′-2-ethanesulfonic acid (HEPES), N-(2-hydroxyethyl) piperazine-N′-(2-hydroxypropanesulfonic acid) (HEPPSO), triethanolamine, N-[tris(hydroxymethyl)methyl]glycine (Tricine), tris(hydroxymethyl)aminoethane (Tris), glycinamide, N,N-bis(2-hydroxyethyl)glycine (Bicine), glycylglycine (pKₐ₂), N-tris(hydroxymethyl)methyl-3-aminopropanesulfonic acid (TAPS), or a combination thereof. In some embodiments, the solutions contain sodium bicarbonate, potassium phosphate, or TRIS buffer.

The solutions may include other components to help maintain the organ and protect it against ischemia, reperfusion injury and other ill effects during perfusion. In certain exemplary embodiments, these components may include hormones (e.g., insulin), vitamins (e.g., an adult multi-vitamin, such as multi-vitamin MVI-Adult), and/or steroids (e.g., dexamethasone and SoluMedrol). In some embodiments, the solutions contain a PDE3 inhibitor. In some embodiments, the PDE3 inhibitor has a cardiac effect. In some embodiments, the PDE3 inhibitor is enoximone, milrinone (Primacor), amrinone/inamrinone, cilostamide, cilostazol (Pletal), anagrelide, trequinsin. In some embodiments, the PDE3 inhibitor is milrinone.

In another aspect, a blood product is provided with the solution to support the organ during metabolism. Exemplary suitable blood products may include whole blood and/or one or more components thereof such as blood serum, plasma, albumin, and red blood cells. In embodiments where whole blood is used, the blood may be passed through a leukocyte and platelet depleting filter to reduce pyrogens, antibodies and/or other items that may cause inflammation in the organ. Thus, in some embodiments, the solution employs whole blood that has been at least partially depleted of leukocytes and/or whole blood that has been at least partially depleted of platelets.

The solutions are preferably provided at a physiological temperature and maintained thereabout throughout perfusion and recirculation. As used herein, “physiological temperature” is referred to as temperatures between about 25 degrees C. and about 37 degrees C., for example, between about 30 degrees C. and about 37 degrees C., such as between about 34 degrees C. and about 37 degrees C.

Table 1 sets forth components that are used in an exemplary aqueous priming solution. The component amounts in Table 1 are relative to each other and to the amount of aqueous solvent employed in the solution (about 500 mL in the exemplary embodiment) and may be scaled as appropriate. In certain embodiments, the quantity of aqueous solvent varies±about 10%.

TABLE 1
Composition of Exemplary Priming and/or Perfusion
Solution (up to 1000 mL aqueous solution)

| Component | Amount | | Specification |
|---|---|---|---|
| Dextran 40 | 5 | g/L | ±about 10% |
| Glucose Anhydrous | 2 | g/L | ±about 10% |
| Sodium Chloride | 6.840 | g/L | ±about 10% |
| Potassium Chloride | 0.335 | g/L | ±about 10% |
| Magnesium Sulfate heptahydrate | 0.246 | g/L | ±about 10% |
| Sodium Dihydrogen Phosphate | 1.725 | g/L | ±about 10% |
| Monohydrate | | | |
| Ficoll 400 | 33.8 | g/L | ±about 10% |
| Ficoll 70 | 40.0 | g/L | ±about 10% |
| Milrinone | 1 | mg/L | ±about 10% |

| | | |
|---|---|---|
| Sterile Water for Injection | Up to 1000 mL | ±about 10% |
| Tris base | Adjust to pH 7.5 | ±about 10% |

The exemplary priming/perfusion solution is added to the system 100 through priming step 924, as more fully described with reference to FIG. 16A.

With regard to the nutritional supplement solution 116, in certain embodiments it includes one or more carbohydrates and may also include a phosphate source. In some embodiments, the nutritional supplement solution 116 is maintained at a pH of about 5.0 to about 6.5, about 5.5 to about 6.0, about 7.0 to about 8.0, or about 7.2 to about 7.5.

Table 2 sets forth components that are used in an exemplary nutritional/compound supplement solution 116. In some embodiments, nutritional/compound supplement solution 116 contains not only nutrients, but also a compound (e.g., a PDE3 inhibitor such as milrinone). Table 3 sets forth components that are used in another exemplary nutritional/compound supplement solution 116. In some embodiments, the nutritional/compound solution 116 further includes sodium glycerol phosphate. The amount of components in Table 2 is relative to the amount of aqueous solvent employed in the solution 116 (about 500 mL) and may be scaled as appropriate. In some embodiments, the quantity of aqueous solvent varies±about 10%. The amount of components in Table 3 is relative to the amount of aqueous solvent employed in the solution 116 (about 100 mL) and may be scaled as appropriate. In some embodiments, the quantity of aqueous solvent varies±about 10%.

TABLE 2
Components of Exemplary Supplement Solutions
Supplement Solution 1 (about 500 mL)

| Component | Amount | Specification |
|---|---|---|
| Glucose (anhydrous) | 1-2 g | ±about 10% |

TABLE 3
Supplement Solution 2 (about 100 mL)

| Component | Amount | Specification |
|---|---|---|
| Milrinone | 0.1 mg | ±about 10% |

In certain embodiments the nutritional/compound solution 116 includes one or more carbohydrates (Supplement Solution 1) and may also include a phosphate source. In some embodiments, the nutritional/compound solution 116 includes a ketone body (e.g., OHB; Supplement Solution 2). In some embodiments, the nutritional/compound solution 116 may include both dextrose and OHB (Supplement Solution 1 and Supplement Solution 2). The nutritional/compound solution 116 is typically maintained at a pH of about 5.0 to about 6.5, for example of about 5.5 to about 6.0.

The preservation solution 118 may include one or more preservatives. In an exemplary embodiment, one or more cardio stimulants are included for assisting normal physiologic function of the heart 102 during perfusion and transplantation. Such stimulants may include, for example, catecholamines, such as epinephrine and/or norepinephrine, which facilitate beating of the heart. In some embodiments, preservation solution 118 includes a PDE3 inhibitor (e.g., milrinone).

Other components may be added to the preservation solution 118, including, for example, adenosine, magnesium, phosphate, calcium, and/or sources thereof. In some instances, additional components are provided to assist the organ in conducting its metabolism during perfusion. These components include, for example, forms of adenosine, which may be used for ATP synthesis, for maintaining endothelial function, and/or for attenuating ischemia and/or reperfusion injury. Components may also include other nucleosides, such as guanosine, thymidine (5-Me-uridine), cytidine, and uridine, as well as other naturally and chemically modified nucleosides including nucleotides thereof. According to some implementations, a magnesium ion source is provided with a phosphate source, and in certain embodiments, with adenosine to further enhance ATP synthesis within the cells of the perfused organ. A plurality of amino acids may also be added to support protein synthesis by the heart's 102 cells. Applicable amino acids may include, for example, any of the naturally-occurring amino acids, as well as those mentioned above.

Table 4 sets forth components that may be used in a solution 118 for preserving an organ as described herein. The solution 118 may include one or more of the components described in Table 4.

TABLE 4
Component of Exemplary Composition for Preservative Solution

| | Exemplary Concentration Ranges in |
|---|---|
| Component | Preservative Solution |
| Alanine | about 1 mg/L-about 10 g/L, e.g., 350 mg/L |
| Arginine | about 1 mg/L-about 10 g/L, e.g., 1.4 g/L |
| Asparagine | about 1 mg/L-about 10 g/L |
| Aspartic Acid | about 1 mg/L-about 10 g/L, e.g., 490 mg/L |
| Cysteine | about 1 mg/L-about 10 g/L |
| Cystine | about 1 mg/L-about 10 g/L |
| Glutamic Acid | about 1 mg/L-about 10 g/L, e.g., 516 mg/L |
| Glutamine | about 1 mg/L-about 10 g/L |
| Glycine | about 1 mg/L-about 10 g/L, e.g., 700 mg/L |
| Histidine | about 1 mg/L-about 10 g/L, e.g., 450 mg/L |
| Hydroxyproline | about 1 mg/L-about 10 g/L |
| Isoleucine | about 1 mg/L-about 10 g/L, e.g., 231 mg/L |
| Leucine | about 1 mg/L-about 10 g/L, e.g., 686 mg/L |
| Lysine/Lysine acetate | about 1 mg/L-about 10 g/L, e.g., 450 mg/L |
| Methionine | about 1 mg/L-about 10 g/L, e.g., 118 mg/L |
| Phenylalanine | about 1 mg/L-about 10 g/L, e.g., 104 mg/L |
| Proline | about 1 mg/L-about 10 g/L, e.g., 353 mg/L |
| Serine | about 1 mg/L-about 10 g/L, e.g., 186 mg/L |
| Threonine | about 1 mg/L-about 10 g/L, e.g., 10 mg/L |
| Tryptophan | about 1 mg/L-about 10 g/L, e.g., 70 mg/L |
| Tyrosine | about 1 mg/L-about 10 g/L, e.g., 184 mg/L |
| Valine | about 1 mg/L-about 10 g/L, e.g., 343 mg/L |
| Adenine | about 1 mg/L-about 10 g/L |
| ATP | about 10 ug/L-about 100 g/L |
| Adenylic Acid | about 10 ug/L-about 100 g/L |
| ADP | about 10 ug/L-about 100 g/L |
| AMP | about 10 ug/L-about 100 g/L |
| Ascorbic Acid | about 1 ug/L-about 10 g/L |
| D-Biotin | about 1 ug/L-about 10 g/L |
| Vitamin D-12 | about 1 ug/L-about 10 g/L |
| Cholesterol | about 1 ug/L-about 10 g/L |
| Dextrose (Glucose)/ | about 1 g/L-about 150 g/L, e.g., 88 g/L |
| Glucose monohydrate | |
| Multi-vitamin Adult | about 1 mg/L-about 20 mg/L or 1 unit vial |
| Epinephrine | about 1 ug/L-about 1 g/L |
| Folic Acid | about 1 ug/L-about 10 g/L |
| Glutathione | about 1 ug/L-about 10 g/L |
| Guanine | about 1 ug/L-about 10 g/L |
| Inositol | about 1 g/L-about 100 g/L |
| Riboflavin | about 1 ug/L-about 10 g/L |
| Ribose | about 1 ug/L-about 10 g/L |
| Thiamine | about 1 mg/L-about 10 g/L |
| Uracil | about 1 mg/L-about 10 g/L |
| Calcium chloride/ | about 1 mg/L-about 100 g/L, e.g., 4.8 g/L |
| calcium chloride dehydrate | |
| NaHCO₃ | about 1 mg/L-about 100 g/L |
| Magnesium sulfate/ | about 1 mg/L-about 100 g/L, e.g., 800 mg/L |
| magnesium sulfate | |
| heptahydrate | |
| Potassium chloride | about 1 mg/L-about 100 g/L |
| Sodium glycerophosphate | about 1 mg/L-about 100 g/L |
| Sodium chloride/ | about 1 mg/L-about 100 g/L, e.g., 3.5 g/L |
| Sodium phosphate | about 1 mg/L-about 100 g/L |
| Insulin | about 1 IU-about 150 IU |
| Serum albumin | about 1 g/L-about 100 g/L |
| Pyruvate | about 1 mg/L-about 100 g/L |
| Coenzyme A | about 1 ug/L-about 10 g/L |
| Serum | about 1 ml/L-about 100 ml/L |
| Heparin | about 500 U/L-about 1500 U/L |
| Solumedrol | about 200 mg/L-about 500 mg/L |
| Dexamethasone | about 1 mg/L-about 1 g/L |
| FAD | about 1 ug/L-about 10 g/L |
| NADP | about 1 ug/L-about 10 g/L |
| adenosine | about 1 mg/L-about 10 g/L, e.g., 1.5 mg/L |
| guanosine | about 1 mg/L-about 10 g/L |
| GTP | about 10 ug/L-about 100 g/L |
| GDP | about 10 ug/L-about 100 g/L |
| GMP | about 10 ug/L-about 100 g/L |
| Milrinone | about 10 ug/L-about 100 g/L, e.g., about |
| | 0.5 mg/L-about 1.5 mg/L |

Table 5 sets forth components that are used in an exemplary preservative solution 118 per 500 mL. In some embodiments, the preservation solution contains all components shown in Table 5. In some embodiments, the preservation solution contains all components shown in

Table 5 except for milrinone which is instead only included in the priming and/or perfusion solutions. The amounts provided in Table 5 describe preferred amounts relative to other components in the table and may be scaled to provide compositions of sufficient quantity. In some embodiments, the amounts listed in Table 5 can vary by ±about 10% and still be used in the solutions described herein.

TABLE 5
Components of Exemplary Preservative Solution per 500 mL

| | |
|---|---|
| | Exemplary Concentrations |
| Component | in Preservative Solution |

| | | |
|---|---|---|
| L-Alanine | 174 | mg |
| L-Arginine | 700 | mg |
| L-Aspartic Acid | 245 | mg |
| L-Glutamic Acid | 258 | mg |
| Glycine | 350 | mg |
| L-Histidine | 225 | mg |
| L-Isoleucine | 115.5 | mg |
| L-Leucine | 343 | mg |
| Lysine acetate | 225 | mg |
| L-Methionine | 59 | mg |
| L-Phenylalanine | 52 | mg |
| L-Proline | 126 | mg |
| L-Serine | 93 | mg |
| L-Threonine | 70 | mg |
| L-Tryptophan | 35 | mg |
| L-Tyrosine | 92 | mg |
| L-Valine | 171.5 | mg |
| Magnesium sulfate heptahydrate | 400 | mg |
| Calcium chloride dehydrate | 2.4 | g |
| Sodium chloride | 1.75 | g |
| Potassium chloride | 20 | mg |
| Adenosine | 0.75 | mg |
| Milrinone | 0.5 | mg |

Table 6 sets forth components that are used in an exemplary preservative solution 118 per 500 mL to 1000 mL. In some embodiments, the preservation solution contains all components shown in Table 6. In some embodiments, the preservation solution contains all components shown in Table 6 except for milrinone which is instead only included in the priming and/or perfusion solutions. The amounts provided in Table 6 describe preferred amounts relative to other components in the table and may be scaled to provide compositions of sufficient quantity. In some embodiments, the amounts listed in Table 6 can vary by ±about 10% and still be used in the solutions described herein.

TABLE 6
Components of Exemplary Preservative Solution

| Component | Amount |
|---|---|
| Adenosine | About 675 mg-About 825 mg |
| Calcium Chloride dihydrate | About 2100 mg-About 2600 mg |
| Glycine | About 315 mg-About 385 mg |
| L-Alanine | About 150 mg-About 200 mg |
| L-Arginine | About 600 mg-About 800 mg |
| L-Aspartic Acid | About 220 mg-About 270 mg |
| L-Glutamic Acid | About 230 mg-About 290 mg |
| L-Histidine | About 200 mg-About 250 mg |
| L-Isoleucine | About 100 mg about 130 mg |
| L-Leucine | About 300 mg-About 380 mg |
| L-Methionine | About 50 mg-About 65 mg |
| L-Phenylalanine | About 45 mg-About 60 mg |
| L-Proline | About 110 mg-About 140 mg |
| L-Serine | About 80 mg-About 105 mg |
| L-Threonine | About 60 mg-About 80 mg |
| L-Tryptophan | About 30 mg-About 40 mg |
| L-Tyrosine | About 80 mg-About 110 mg |
| L-Valine | About 150 mg-About 190 mg |
| Lysine Acetate | About 200 mg-About 250 mg |
| Magnesium Sulfate Heptahydrate | About 350 mg-About 450 mg |
| Potassium Chloride | About 15 mg-About 25 mg |
| Sodium Chloride | About 1500 mg-About 2000 mg |
| Dextrose | About 25 gm-About 120 gm |
| Epinephrine | About 0.25 mg-About 1.0 mg |
| Insulin | About 75 Units-About 150 Units |
| MVI-Adult | 1 unit vial |
| SoluMedrol | About 200 mg-500 mg |
| Sodium Bicarbonate | About 10-25 mEq |
| Milrinone | About 0.25 mg-About 1.5 mg |

Table 7 sets forth components that are used in an exemplary preservative solution 118 per 500 mL to 1000 mL. In some embodiments, the preservation solution contains all components shown in Table 7. In some embodiments, the preservation solution contains all components shown in Table 7 except for milrinone which is instead only included in the priming and/or perfusion solutions. The amounts provided in Table 7 describe preferred amounts relative to other components in the table and may be scaled to provide compositions of sufficient quantity. In some embodiments, the amounts listed in Table 7 can vary by ±about 10% and still be used in the solutions described herein.

TABLE 7
Components of Exemplary Preservative Solution 2

| Component | Amount |
|---|---|
| Adenosine | About 675 mg-About 825 mg |
| Calcium Chloride dihydrate | About 2100 mg-About 2600 mg |
| Glycine | About 315 mg-About 385 mg |
| L-Alanine | About 150 mg-About 200 mg |
| L-Arginine | About 600 mg-About 800 mg |
| L-Aspartic Acid | About 220 mg-About 270 mg |
| L-Glutamic Acid | About 230 mg-About 290 mg |
| L-Histidine | About 200 mg-About 250 mg |
| L-Isoleucine | About 100 mg about 130 mg |
| L-Leucine | About 300 mg-About 380 mg |
| L-Methionine | About 50 mg-About 65 mg |
| L-Phenylalanine | About 45 mg-About 60 mg |
| L-Proline | About 110 mg-About 140 mg |
| L-Serine | About 80 mg-About 105 mg |
| L-Threonine | About 60 mg-About 80 mg |
| L-Tryptophan | About 30 mg-About 40 mg |
| L-Tyrosine | About 80 mg-About 110 mg |
| L-Valine | About 150 mg-About 190 mg |
| Lysine Acetate | About 200 mg-About 250 mg |
| Magnesium Sulfate Heptahydrate | About 350 mg-About 450 mg |
| Potassium Chloride | About 15 mg-About 25 mg |
| Sodium Chloride | About 1500 mg-About 2000 mg |
| Epinephrine | About 0.25 mg-About 1.0 mg |
| Insulin | About 75 Units-About 150 Units |
| MVI-Adult | 1 unit vial |
| SoluMedrol | About 200 mg-500 mg |
| Sodium Bicarbonate | About 10-25 mEq |
| Milrinone | About 0.25 mg-About 1.5 |

In the exemplary embodiment of a solution 118, the components in Tables 6 and 7 are combined in the relative amounts listed therein per about 1 L of aqueous fluid to form the solution 118. In some embodiments, the components in Tables 6 and 7 are combined in the relative amounts listed therein per about 500 mL of aqueous fluid and then combined with the solution 116, also about 500 mL, to provide a maintenance solution 116/118 of about 1 L of aqueous fluid. In some embodiments the quantity of aqueous fluid in solutions 116, 118, and/or 116/118 can vary±about 10%. The pH of the solution 118 may be adjusted to be between about 7.0 and about 8.0, for example about 7.3 and about 7.6. The solution 118 may be sterilized, for example by autoclaving, to provide for improved purity.

Table 8 sets forth another exemplary preservative solution 118, comprising a tissue culture media having the components identified in Table 8 and combined with an aqueous fluid, which may be used in the perfusion fluid 108 as described herein. In some embodiments, the preservation solution contains all components shown in Table 8. In some embodiments, the preservation solution contains all components shown in Table 8 except for milrinone which is instead only included in the priming and/or perfusion solutions. The amounts of components listed in Table 8 are relative to each other and to the quantity of aqueous solution used. In some embodiments, about 500 mL of aqueous fluid is used. In other embodiments about 1 L of aqueous fluid is used. For example, combination of about 500 mL of preservative solution 118 with 500 mL of nutritional/compound solution 116 affords a maintenance solution 116/118 of about 1 L. In some embodiments, the quantity of aqueous solution can vary±about 10%. The component amounts and the quantity of aqueous solution may be scaled as appropriate for use. The pH of the preservative solution 118, in this embodiment, may be adjusted to be about 7.0 to about 8.0, for example about 7.3 to about 7.6. In some embodiments, the pH of the preservative solution 118, in this embodiment, may be adjusted to be about 7.2 to about 7.5.

TABLE 8
Composition of Another Exemplary Preservative
Solution (about 500 mL aqueous solution)

| | | |
|---|---|---|
| Tissue Culture Component | Amount | Specification |

| | | | |
|---|---|---|---|
| Adenosine | 750 | mg | ±about 10% |
| Calcium chloride dihydrate | 2400 | mg | ±about 10% |
| Glycine | 350 | mg | ±about 10% |
| L-Alanine | 174 | mg | ±about 10% |
| L-Arginine | 700 | mg | ±about 10% |
| L-Aspartic Acid | 245 | mg | ±about 10% |
| L-Glutamic Acid | 258 | mg | ±about 10% |
| L-Histidine | 225 | mg | ±about 10% |
| L-Isoleucine | 115.5 | mg | ±about 10% |
| L-Leucine | 343 | mg | ±about 10% |
| L-Methionine | 59 | mg | ±about 10% |
| L-Phenylalanine | 52 | mg | ±about 10% |
| L-Proline | 126 | mg | ±about 10% |
| L-Serine | 93 | mg | ±about 10% |
| L-Threonine | 70 | mg | ±about 10% |
| L-Tryptophan | 35 | mg | ±about 10% |
| L-Tyrosine | 92 | mg | ±about 10% |
| L-Valine | 171.5 | mg | ±about 10% |
| Lysine Acetate | 225 | mg | ±about 10% |
| Magnesium Sulfate Heptahydrate | 400 | mg | ±about 10% |
| Potassium Chloride | 20 | mg | ±about 10% |
| Sodium Chloride | 1750 | mg | ±about 10% |
| Milrinone | 0.5 | mg | ±about 10% |

Since amino acids are the building blocks of proteins, the unique characteristics of each amino acid impart certain important properties on a protein such as the ability to provide structure and to catalyze biochemical reactions. The selection and concentrations of the amino acids provided in the preservative solutions provide support of normal physiologic functions such as metabolism of sugars to provide energy, regulation of protein metabolism, transport of minerals, synthesis of nucleic acids (DNA and RNA), regulation of blood sugar and support of electrical activity, in addition to providing protein structure. Additionally, the concentrations of specific amino acids found in the preservative solutions can be used to predictably stabilize the pH of the maintenance solution 116/118 and perfusion fluid 108.

Certain embodiments of the preservative solution 118 include epinephrine and a plurality of amino acids. In certain embodiments, the preservative solution 118 includes electrolytes, such as calcium and magnesium.

In one embodiment, a maintenance solution 116/118 is made from the combination of the preservative solution 118, including one or more amino acids, and the nutritional/compound solution 116, including one or more carbohydrates, such as glucose or dextrose. In some embodiments, the nutritional/compound solution 116 contains a ketone body instead of a carbohydrate. The maintenance solution 116/118 may also have additives, such as those described herein, administered at the point of use just prior to infusion into the organ perfusion system. For example, additional additives that can be included with the solution or added at the point of use by the user include hormones and steroids, such as dexamethasone and insulin, as well as vitamins, such as an adult multi-vitamin, for example adult multivitamins for infusion, such as MVI-Adult. Additional small molecules and large bio-molecules may also be included with the solution or added at the point of use by the user at port 762, for example, therapeutics and/or components typically associated with blood or blood plasma, such as albumin.

In some embodiments, therapeutics that may be included in the compositions, solutions, and systems described herein include hormones, such as thyroid hormones, for example T₃ and/or T₄ thyroid hormones. Further therapeutics that may be included include drugs such as anti-arrhythmic drugs, for example, for heart therapy, and beta blockers. For instance, in certain embodiments, one or more thyroid hormones, one or more anti-arrhythmic drugs, and one or more beta blockers are added to the nutritional/compound solution 116, the preservative solution 118, and/or the maintenance solutions 116/118 either before or during perfusion of the organ. The above therapeutics may also be added directly to the system, for example, to the perfusion fluid 108, before or during perfusion of the organ.

With further reference to Tables 3-8, certain components used in the exemplary preservation solution 118 are molecules, such as small organic molecules or large bio-molecules, that would be inactivated, for example through decomposition or denaturing, if passed through sterilization. According to the system 100, the inactivatable components of the solution 118 may be prepared separately from the remaining components of the solution 118. The separate preparation involves separately purifying each component through known techniques. The remaining components of the solution 118 are sterilized, for example through an autoclave, then combined with the biological components.

Table 9 lists certain biological components that may be separately purified and added to the solutions described herein after sterilization, according to this two-step process. These additional or supplemental components may be added to solutions 118, 116, 116/118, the priming solution or a combination thereof individually, in various combinations, all at once as a composition, or as a combined solution. For example, in certain embodiments, the epinephrine, insulin, and MVI-Adult, listed in Table 9, are added to the maintenance solution 116/118. In a preferred embodiment, milrinone is added to solutions 118, 116, the priming solution or a combination thereof. In another example, the SoluMedrol and the sodium bicarbonate, listed in Table 9, are added to the priming solution. The additional components may also be combined in one or more combinations or all together and placed in solution before being added to solutions 116, 118, 116/118, and/or the priming solution. In some embodiments, the additional components are added directly to the perfusion fluid 108 through port 762. The component amounts listed in Table 9 are relative to each other and/or to the amounts of components listed in one or more of Tables 1-8 as well as the amount of aqueous solution used in preparing solutions 116, 118, 116/118, and/or the priming solution and may be scaled as appropriate for the amount of solution required.

TABLE 9
Exemplary Biological Components Added Prior to Use

| Component | Amount | Type | Specification |
|---|---|---|---|
| Epinephrine | About 0.2-0.5 mg | Catecholamine | ±about 10% |
| | | Hormone | |
| Insulin | about 70-100 | Hormone | ±about 10% |
| | Units (IU) | | |
| MVI-Adult | 1 mL unit vial | Vitamin | ±about 10% |
| SoluMedrol | About 250 mg | Steroid | ±about 10% |
| Sodium | About 20 mEq | Buffer | ±about 10% |
| Bicarbonate | or 2 × 20 mEq | | |
| Milrinone | 0.25 mg to 1.5 | PDE3 Inhibitor | ±about 10% |
| | mg | | |

In one embodiment, a composition for use in a maintenance solution 116/118 is provided comprising one or more carbohydrates, one or more organ stimulants, and a plurality of amino acids that do not include asparagine, glutanine, or cysteine. The composition may also include other substances, such as those used in solutions described herein.

In another embodiment, a system for perfusing an organ, such as a heart, is provided comprising an organ and a substantially cell-free composition, comprising one or more carbohydrates, one or more organ stimulants, and a plurality of amino acids that do not include asparagine, glutamine, or cysteine. Substantially cell-free includes systems that are substantially free from cellular matter; in particular, systems that are not derived from cells. For example, substantially cell-free includes compositions and solutions prepared from non-cellular sources.

In another aspect, the solutions 116 and 118 may be provided in the form of a kit that includes one or more organ maintenance solutions. An exemplary maintenance solution may include components identified above in one or more fluid solutions for use in an organ perfusion fluid 108. In certain embodiments, the maintenance solution 116/118 may include multiple solutions, such as a preservation solution 118 and a nutritional/compound solution 116 and/or a supplemental composition or solution or may include dry components that may be regenerated in a fluid to form one or more solutions 116/118. The kit may also comprise components from the solutions 116 and/or 118 in one or more concentrated solutions which, on dilution, provide a preservation, nutritional, and/or supplemental solution as described herein. The kit may also include a priming solution. In an exemplary embodiment, the maintenance solution includes a preservation solution 118 and a nutritional/compound solution 116 such as those described above, and a priming solution such as that described above. In some embodiments the maintenance solution comprises a PDE3 inhibitor.

In certain embodiments, the kit is provided in a single package, wherein the kit includes one or more solutions (or components necessary to formulate the one or more solutions by mixing with an appropriate fluid), and instructions for sterilization, flow and temperature control during perfusion and use and other information necessary or appropriate to apply the kit to organ perfusion. In certain embodiments, a kit is provided with only a single solution 116, 118 and/or 116/118 (or set of dry components for use in a solution upon mixing with an appropriate fluid), and the single solution 116, 118 and/or 116/118 (or set of dry components) is provided along with a set of instructions and other information or materials necessary or useful to operate the solution 116, 118 and/or 116/118 in the system 100.

In another aspect, the systems, solutions and methods may be used to deliver therapeutics to an organ during perfusion. For example, one or more of the solutions and/or systems described above may include one or more drugs, biologics, gene therapy vectors, or other therapeutics which are delivered to the organ during perfusion. Suitable exemplary therapeutics may include drugs, biologics, or both. Suitable drugs may include, for example, antifungals, anti-microbials or anti-biotics, anti-inflammatoires, anti-proliferatives, anti-virals, steroids, retinoids, NSAIDs, vitamin D3 and vitamin D3 analogs, calcium channel blockers, complement neutralizers, ACE inhibitors, immunosuppressants, and other drugs. Suitable biologics may include proteins; suitable biologics may also include vectors loaded with one or more genes for gene therapy application. In one embodiment, the therapeutic is a PDE3 inhibitor.

For example, suitable steroids include but are not limited to androgenic and estrogenic steroid hormones, androgen receptor antagonists and 5-. alpha.-reductase inhibitors, and corticosteroids. Specific examples include but are not limited to alclometasone, clobetasol, fluocinolone, fluocortolone, diflucortolone, fluticasone, halcinonide, mometasone, prednisone, prednisolone, methylprednisolone, triamcinolone, betamethasone, and dexamethasone, and various esters and acetonides thereof.

Suitable retinoids include but are not limited to retinol, retinal, isotretinoin, acitretin, adapalene, tazarotene, and bexarotene.

Suitable NSAIDs include but are not limited to naproxen, suprofen, ketoprofen, ibuprofen, flurbiprofen, diclofenac, indomethacin, celecoxib, and rofecoxib.

Suitable vitamin D3 analogues include but are not limited to doxercalciferol, seocalcitol, calcipotriene, tacalcitol, calcitriol, ergocalciferol, and calcifediol.

Suitable anti-viral agents include but are not limited to trifluridine, cidofovir, acyclovir, penciclovir, famciclovir, valacyclovir, ganciclovir, and docosanol.

Suitable human carbonic anhydrase inhibitors include but are not limited to methazolamide, acetazolamide, and dorzolamide.

Suitable anti-proliferative agents include but are not limited to 5-FU, taxol, daunorubicin, and mitomycin.

Suitable antibiotic (antimicrobial) agents include but are not limited to bacitracin, chlorhexidine, chlorhexidine digluconate, ciprofloxacin, clindamycin, erythromycin,gentamicin, lomefloxacin, metronidazole, minocycline, moxifloxacin, mupirocin, neomycin, ofloxacin, polymyxin B, rifampicin, rufloxacin, tetracycline, tobramycin, triclosan, and vancomycin. The antiviral and antibacterial prodrugs described herein may be used to treat appropriately responsive systemic infections.

In certain embodiments, a solution system for use in a perfusion fluid 108, comprising a first chamber containing a first solution, such as a preservation solution 118, that includes one or more cardio stimulants and a plurality of amino acids that do not include asparagine, glutamine, or cysteine, and a second chamber, containing a second solution, such as a nutritional/compound solution 116, that includes one or more carbohydrates, such as dextrose. The system may also include a sterilization system for sterilizing the first solution and the second solution prior to using the solutions to perfuse a heart. In some embodiments, one or more of the solutions 118 and 116 include one or more therapeutics. In some embodiments, one or more of the solutions 118 and 116 include a PDE3 inhibitor. In some embodiments the solution system includes a third chamber comprising a priming solution, such as is described above, which may have one or more carbohydrates. In certain embodiments, the first solution 118 includes epinephrine, adenosine, insulin, one or more immuno-suppressants, a multi-vitamin, and/or one or more electrolytes. In certain embodiments, the first solution 118 includes a PDE3 inhibitor.

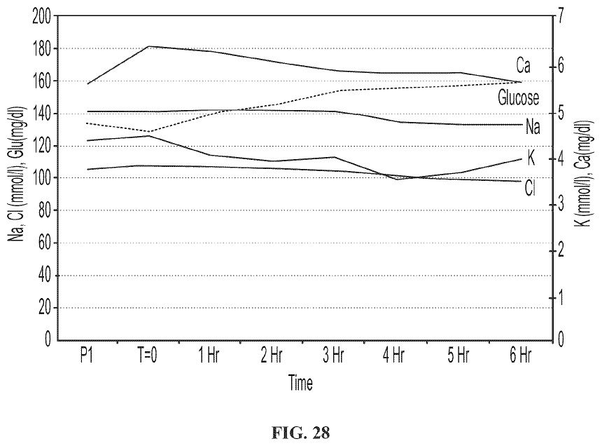

Certain experimental data are available to describe certain embodiments of the solutions described herein and their use in organ perfusion. Certain data are set for in FIGS. 28-30. FIG. 28 depicts a chart demonstrating electrolyte stability for an organ undergoing perfusion in forward mode according to an embodiment of the system 100. In the embodiment associated with FIG. 28, the organ is a heart 102 wherein perfusion is conducted in forward mode (as described above) by pumping perfusion fluid 108 containing solution 116/118 to the let atria 152 and out of the aorta 158. The rate of perfusion is approximately 30 mhr. As can be seen from FIG. 28, the levels of various electrolytes: sodium, potassium, calcium, and chloride ions, as well as dissolved glucose, remain at stable levels throughout the course of perfusion, from before the organ is cannulated to the perfusion system 100 to six hours after cannulation within the system 100.

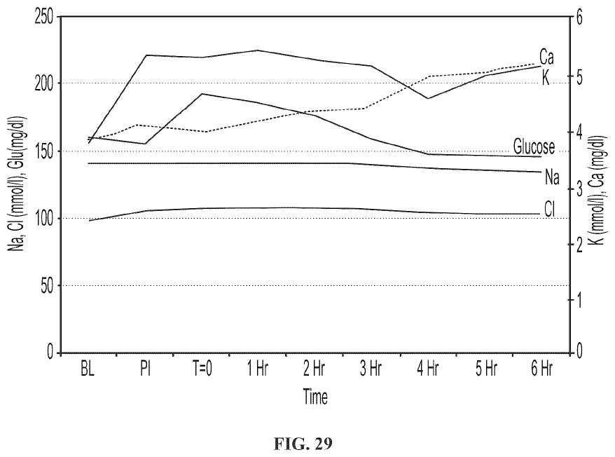

FIG. 29 depicts a chart demonstrating electrolyte stability for an organ undergoing retrograde perfusion according to another embodiment of the system 100. In the embodiment associated with FIG. 29, the organ is a heart wherein perfusion occurs by pumping the perfusion fluid 108 containing the solution 116/118 into the aorta 158 and through the coronary sinus 155. The rate of infusion is approximately 30 mL/hr. As can be seen from FIG. 29, the levels of various electrolytes: sodium, potassium, calcium, and chloride ions, as well as dissolved glucose, remain at stable levels throughout the course of perfusion, from before the organ is cannulated to the perfusion system 100 to six hours after cannulation. FIG. 29 also demonstrates that the levels of the electrolytes and glucose remain at levels similar to those for the base line (BL) normal physiological state for the organ.

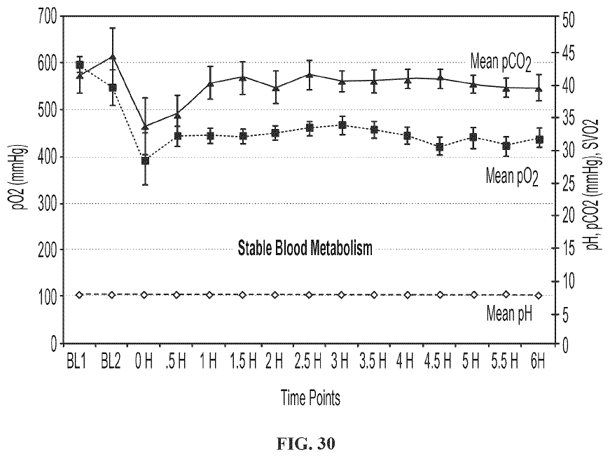

FIG. 30 depicts a chart demonstrating the arterial blood gas profile for an organ undergoing perfusion according to another embodiment of the invention. As can be seen from FIG. 30, the levels of various blood gasses: carbon dioxide and oxygen, and pH remain at stable levels throughout the six-hour course of perfusion. FIG. 30 also demonstrates that the levels of carbon dioxide, oxygen, and pH remain at levels similar to those for two base line (BL) measurements for the normal physiological state for the organ. FIGS. 28-30 demonstrate the ability of the present systems and methods to maintain an organ under stable physiological or near physiological conditions.

Lactate, also called lactic acid, is a byproduct/end product of anaerobic metabolism in living cells, tissues, and organs. Lactate is generated when there is no or low oxygen in the cell to metabolize glucose for basic energy production through the glycolysis pathway. Thus, lactate is used as a biomarker for healthy tissue in organ preservation. Lactate is metabolized in the organ leading to lower lactate levels which indicate organ preservation. In some embodiments, the measurement of total lactate can be used as an indication of body stress, trauma, injury or some form of hypo-perfusion state of an organ.

In some embodiments, lactate is used as an indicator of isolated donor heart perfusion status. In arterial blood, lactate is measured using a standard blood chemistry analyzer or as a built in organ care system 100 arterial on-line Lactate analyzer probe. In some embodiments, a lactate sensor is located at or near the aorta interface 162 and another lactate sensor is located at or near the pulmonary artery interface 166. The venous blood (which in some embodiments has been through the coronary sinus) lactate is measured using a similar technique as above. The V-A lactate differential is calculated using the following formula: Lactate V-A differential=

Venous blood lactate-Arterial blood lactate. In some embodiments, the venous lactate value is obtained at the pulmonary artery interface 166, and the arterial lactate value is obtained at the aorta interface 162.

The V-A differential indicates the perfusion status.

If the V-A Differential has a negative (−) value the venous blood (coronary sinus), has less lactate than the arterial blood. This indicates that the heart is actually metabolizing lactate which is a sign of adequate perfusion and oxygen delivery to the myocardial cells.

If the V-A Differential has a zero (0) value the lactate in the venous side is equal to the arterial blood. This indicates that the myocardial cells are not producing or metabolizing lactate. This state indicates adequate perfusion for the myocardial cell, however, serial measurements are needed to validate that this state of equilibrium is not shifting.

If the V-A Differential has a positive (+) value the myocardial cells are starved of oxygen and are starting to produce lactate as a byproduct of anaerobic metabolism. To address this issue, the operator would increase the coronary flow to ensure adequate perfusion and increase the rate of delivery of oxygen and substrate to the myocardial cells.

Serial (at least hourly) measurements of the lactate V-A differential are indicated for the entire maintenance period of an isolated heart on the organ care system 100 to give the operator a continuous assessment of the perfusion status of that heart. The serial measurements allow the operator to evaluate the trend data for the lactate V-A differential.

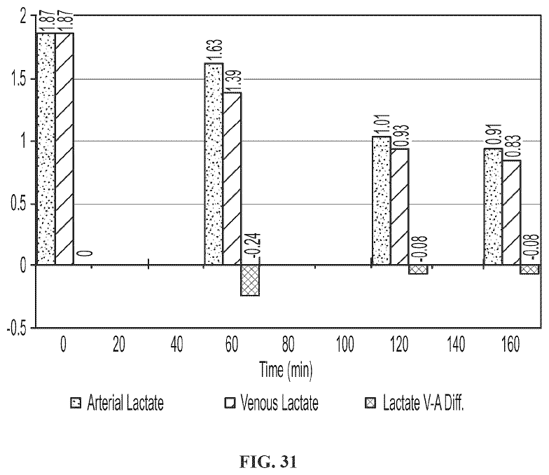

FIG. 31 depicts a serial lactate differential that indicates adequate perfusion. The vertical axis indicates the lactate value (mmol/L) and the horizontal axis is time (minutes). Table 10 below provides the values for arterial lactate (Lactate A), venous lactate (Lactate V) and Lactate V-A differential (Lactate VA dif) and the time, in minutes, on the perfusion clock.

TABLE 10

| Lactate | Lactate | Lactate | Perfusion |
|---|---|---|---|
| A | VA Dif | V | Time |
| 1.87 | 0 | 1.87 | 0 |
| | | | 20 |
| | | | 40 |
| 1.63 | −0.24 | 1.39 | 60 |
| | | | 80 |
| | | | 100 |
| 1.01 | −0.08 | 0.93 | 120 |
| | | | 140 |
| 0.91 | −0.08 | 0.83 | 160 |

Serial lactate table of information corresponding to FIG. 30.

Notable is that the V-A differential is zero or lower throughout the perfusion time. This indicates that there is adequate perfusion and that the myocardial cells are not producing lactate. In one embodiment, serial reading can provide the trend of the V-A differential. Further, the trend of decreasing lactate values indicates that the myocardial cells are metabolizing lactate. These indications are associated with positive post-transplant outcomes.

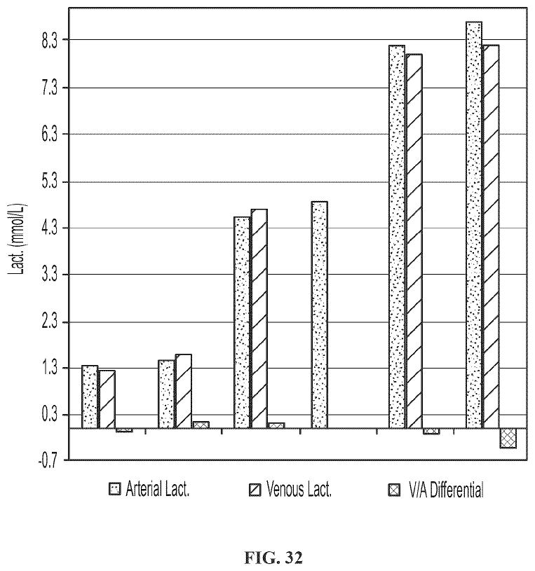

FIG. 32 is an example of serial lactate V-A differential assessment of a human heart on an organ care system 100. Notable is the increasing lactate values, indicating the myocardial cells are creating lactate and the positive values for the VA differential. This indicates an inadequate perfusion and was associated with ischemic injury to the donor heart resulting in a clinical decision of not being suitable for transplantation. Further, the trend of increasing lactate values indicates the production of lactate and indicates that the myocardial cells lack sufficient oxygen.

TABLE 11

| Lactate | Lactate | Lactate | Perfusion |
|---|---|---|---|
| A | VA Dif | V | Time |
| 1.32 | −0.06 | 1.26 | 10 |
| 1.45 | 0.11 | 1.56 | 30 |
| 4.54 | 0.11 | 4.65 | 150 |
| 4.81 | | | 180 |
| 8.1 | −0.1 | 8 | 250 |
| 8.7 | −0.5 | 8.2 | 280 |

Serial lactate table of information corresponding to FIG. 22.

The serial lactate differential can be used in combination with other physiologic parameters to assess the myocardial tissue suitability for a transplant. For example, Coronary Vascular Patency of an isolated heart on the Organ Care System 100 can be assessed using the combination of high aortic pressure (perfusion pressure) and serial lactate V-A Differential.

Particularly, the presence of elevated aortic pressure observed in a heart on the organ care system 100, combined with elevated, rising or neutral lactate V-A differential may indicate coronary vascular narrowing of the perfused heart. This can be explained by the elevated pressures as a sign of high resistance to blood flow and in turn low or inadequate oxygen delivery to the myocardial cells resulting in lactate production and the abnormal V-A differential.

### Exemplary Lung Organ Care System (OCS)

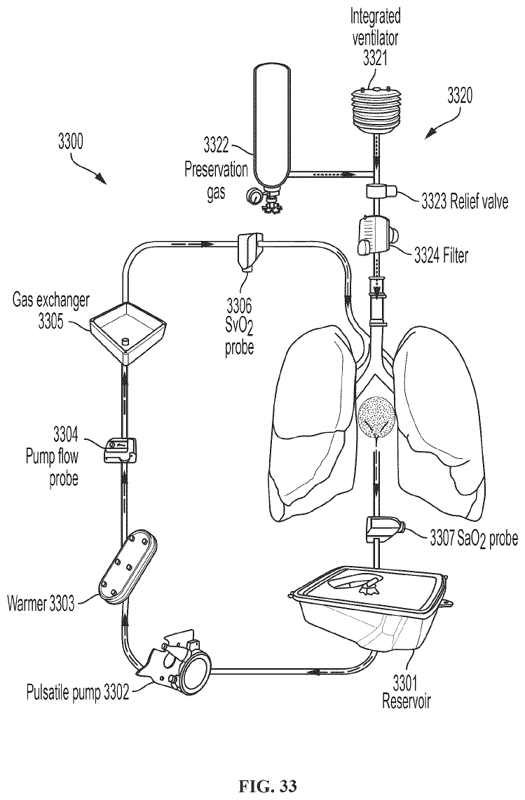

FIG. 33 depicts an illustrative diagram of an ex-vivo lung connected to exemplary components of an organ care system, which comprises a perfusion circuit 3300 and a ventilation circuit 3320. The perfusion fluid leaves the reservoir 3301 and is driven forward by a pump (e.g., a pulsatile pump 3302), then passes through a warmer 3303 to bring the perfusion fluid to at or near physiologic temperatures, e.g., between about 30 °C to about 37 °C. The perfusion fluid then enters a pump flow probe 3304 before entering a gas exchanger 3305, allowing gases to be exchanged between gas and perfusion solution via a gas-permeable, hollow fiber membrane. The perfusion fluid then passes a SvO₂ probe 3306, which measures the oxygen saturation of venous (deoxygenated) perfusion fluid before entering the pulmonary artery of the ex-vivo lung. The perfusion fluid exits via the pulmonary veins of the ex-vivo lung and is monitored by the SaO₂ probe 3307, which measures the oxygen saturation of arterial (oxygenated) perfusion fluid, before returning to the reservoir 3301 to complete the perfusion circuit 3300.

In an exemplary ventilation circuit 3320, the integrated ventilator 3321 delivers controlled airflow to the airways of the ex-vivo lung, while a preservation gas source 3322 supplies tailored gas mixtures to support metabolic needs. The preservation gas 3322 can be composed of 21% oxygen, 5.5% CO₂, and 73.5% nitrogen. A relief valve 3323 protects the system from excessive airway or circuit pressure, and an inline filter 3324 removes particulates or microemboli to protect delicate pulmonary microvasculature, together enabling continuous monitoring, protection, and functional assessment of the lungs throughout ex vivo preservation and evaluation.

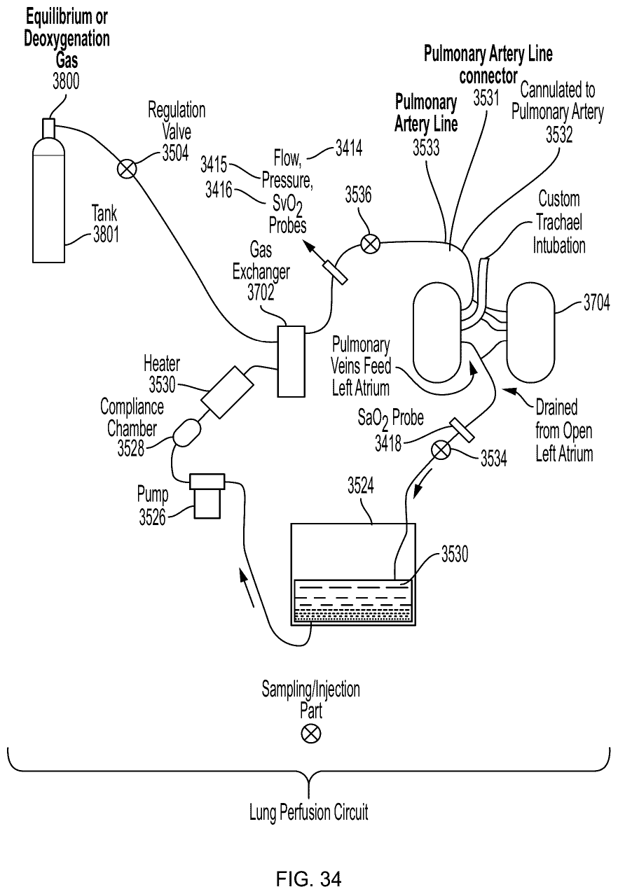

FIG. 34 illustrates an exemplary lung perfusion circuit which can be used to circulate the perfusion fluid containing a PDE3 inhibitor. The circuit is housed entirely within a lung perfusion module, and all its components may be disposable. U.S. application Ser. No. 12/099,715 (U.S. Pat. No. 9,247,728) and U.S. application Ser. No. 18/512,184 (U.S. Patent Pub. No. 2024/0081323) include exemplary embodiments of lung perfusion circuits, each of which is incorporated in its entirety by reference herein. Lung OCS perfusion solution 3550 is placed in a reservoir and then circulates within the perfusion circuit, passing through various components of lung perfusion module before passing through the vascular system of lungs 3704. In some embodiments, the perfusion solution 3550 contains a PDE3 inhibitor. Pump 3526 causes perfusion solution 3550 to flow around the lung perfusion circuit. It receives perfusion solution 3550 from reservoir 3524, and pumps the solution through compliance chamber 3528 to heater 3530. Compliance chamber 3528 is a flexible portion of tubing that serves to refine the flow characteristics nature of pump 3526. Heater 3530 replaces heat lost by perfusion solution 3550 to the environment during circulation of the fluid. In the described embodiment, the heater maintains perfusion solution 3550 at or near the physiologic temperature of 30-37 degrees C., and preferably at about 34 degrees C. After passing through heater 3530, perfusion solution 3550 flows into gas exchanger 3702. Gas exchanger 3702 allows gases to be exchanged between gas and perfusion solution 3550 via a gas-permeable, hollow fiber membrane. However, the gas exchanger has an effective gas exchange surface area of about 1 square meter, which is only a fraction of the 50-100 square meter effective exchange area of the lungs. Thus gas exchanger 3702 has only a limited gas exchange capability compared to the lungs. Blood gas solenoid valve 3504 regulates the supply of gas into gas exchanger 3702. The composition of gas supplied to gas exchanger is determined by which mode the OCS is in. For example, when OCS 3400 is in a sequential assessment mode, deoxygenation gas 3800 from deoxygenation gas tank 3801 is supplied to the gas exchanger. Sampling/injection port 3536 facilitates the removal of a sample or the injection of a chemical just before perfusion solution 3550 reaches the lungs. Perfusion solution then enters lungs 3704 through cannulated pulmonary artery 3532 via pulmonary artery line 3533 and pulmonary artery line 3531. Flow probe 3414 measures the rate of flow of perfusion fluid 3550 through the system. In the described embodiment, flow probe 3414 is placed on the perfusate line as it leads towards the pulmonary artery. Pressure sensor 3415 measures pulmonary arterial pressure at the point of entry of perfusion fluid 3550 into the lungs. Oxygen probe 3416 measures oxygen in perfusion fluid 3550 just before it enters the lungs. In some embodiments, the perfusion solution 3550 is the perfusion fluid disclosed in U.S. application Ser. No. 18/512,184 (U.S. Patent Pub. No. 2024/0081323 A1), which is incorporated in its entirety by reference. In some embodiments, the perfusion solution 250 is the perfusion fluid as disclosed in U.S. application Ser. No. 18/512,184 (U.S. Patent Pub. No. 2024/0081323 A1).

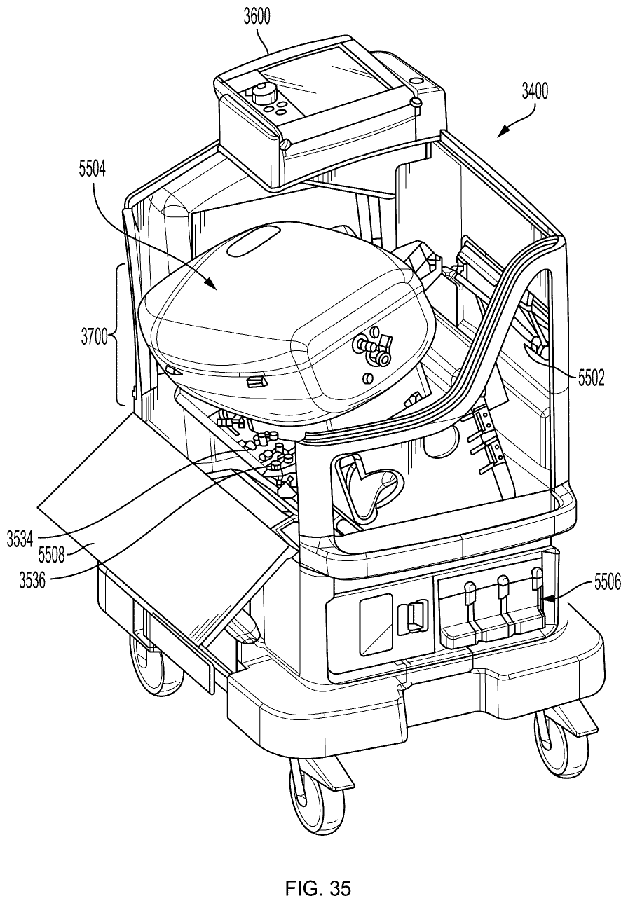

FIG. 35 is an overall view of an exemplary OCS console 3400 showing the single use, disposable lung perfusion module in a semi-installed position. As broadly indicated in FIG. 35, single use disposable lung perfusion module is sized and shaped to fit into OCS console 3400, and to couple with it. Overall, the unit has a similar form to the organ care system described in U.S. patent application Ser. No. 11/788,865. Removable lung perfusion module 3700, is insertable into OCS console 3400 by means of a pivoting mechanism that allows module 3700 to slide into the organ console module from the front, as shown in FIG. 35, and then pivot towards the rear of the unit. Clasp mechanism 5502 secures lung perfusion module 3700 in place. In alternative embodiments, other structures and interfaces of lung perfusion module 3700 are used to couple the module with OCS 3400. When secured in place, electrical and optical connections (not shown) provide power and communication between OCS console 3400 and lung perfusion module 3700. Details of the electrical and optical connections are described in U.S. patent application Ser. No. 11/246,013, filed on Oct. 7, 2005, the specification of which is incorporated by reference herein in its entirety. A key component of lung perfusion module 3700 is organ chamber 5504, which is described in detail below. Battery compartments 5506 and maintenance gas cylinder (not shown) are located in the base of the OCS console 3400. OCS console 3400 is protected by removable panels, such as front panels 5508. Just below lung perfusion module are perfusion solution sampling ports 3534 and 3536. Mounted on top of OCS console 3400 is OCS monitor 3600.

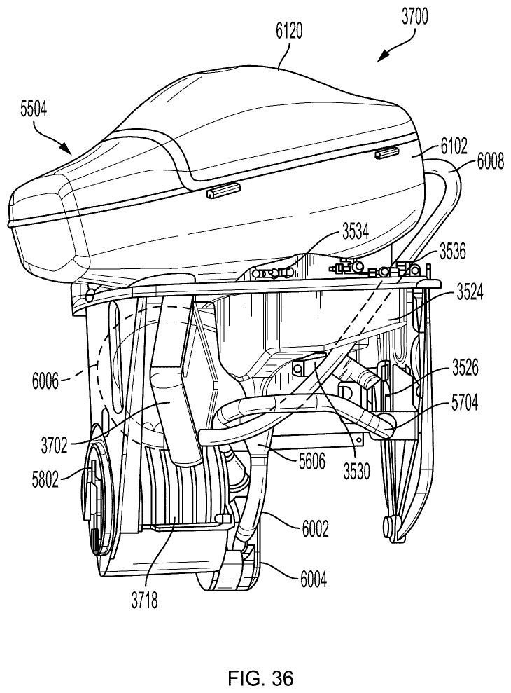

FIG. 36 is a front view of lung perfusion module 3700. Organ chamber 5504 includes a removable lid 6120 and housing 6102. Sampling ports, including LA sampling port 3534 and PA sampling port 3536 are visible below organ chamber 6102. Gas exchanger 3702, bellows 3718, bellows plate 5802 are also visible in the figure.

The circulation path of the perfusion solution in terms of the components of lung perfusion module 3700 is now addressed. Mounted below organ chamber 5504 are perfusion solution reservoir 3524, which stores perfusion solution 3550. The perfusion solution exits through one-way inflow valve 5606, line 6002, and pump dome 6004 to pump 3526 (not shown). The perfusion solution is pumped through perfusion solution line 5704 through compliance chamber 3528, and then to perfusion solution heater 3530. After passing through heater 3530, the perfusion solution passes through connecting line 6006 to gas exchanger 3702.

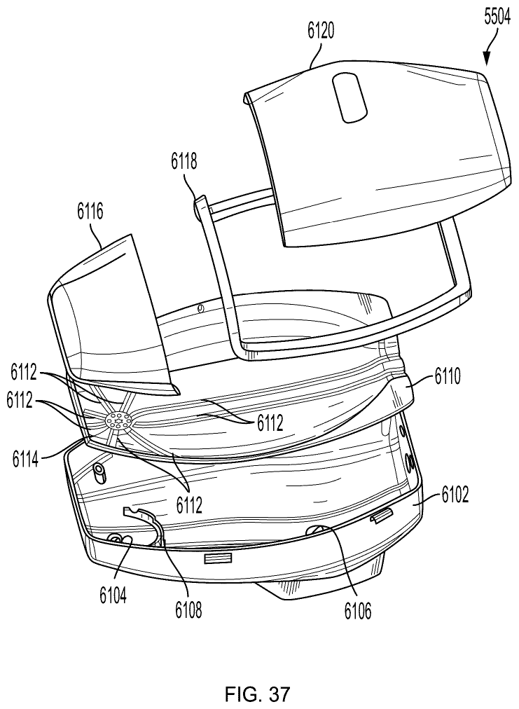

Having described OCS console 3400 and lung perfusion module 3700, we now describe organ chamber 5504. FIG. 37 shows an exploded view of the components of organ chamber 5504. The top of organ chamber 5504 is covered with a sealable lid that includes front piece 6116, top piece 6120, inner lid with sterile drape (not shown), and sealing piece 6118 that seals front piece 6116 to top piece 6120. Base 6102 of chamber 5504 is shaped and positioned within lung perfusion module 3700 to facilitate the drainage of the perfusion solution. Organ chamber 5504 has two drains, measurement drain 6104, and main drain 6106, which receives overflow from the measurement drain. Measurement drain 6104 drains perfusion solution at a rate of about 0.5 l/min, considerably less than perfusion solution 3550 flow rate through lungs 404 of between 1.5 l/min and 4 l/min. Measurement drain leads to oxygen probe 3418, which measures SaO₂ values, and then leads on to reservoir 3524. Main drain 6106 leads directly to reservoir 3524 without oxygen measurement. Oxygen probe 3418, which is a pulse oxymeter in the described embodiment, cannot obtain an accurate measurement of perfusion solution oxygen levels unless perfusion solution 3550 is substantially free of air bubbles. In order to achieve a bubble-free column of perfusion solution, base 6102 is shaped to collect perfusion solution 3550 draining from lungs 3704 into a pool that collects above drain 6104. The perfusion solution pool allows air bubbles to dissipate before the perfusion solution enters drain 6104. The formation of a pool above drain 6104 is promoted by wall 6108, which partially blocks the flow of perfusion solution from measurement drain 6104 to main drain 6106 until the perfusion solution pool is large enough to ensure the dissipation of bubbles from the flow. Main drain 6106 is lower than measurement drain 6104, so once perfusion solution overflows the depression surrounding drain 6104, it flows around wall 6108, to drain from main drain 6106. In an alternate embodiment of the dual drain system, other systems are used to collect perfusion solution into a pool that feeds the measurement drain. In some embodiments, the flow from the lungs is directed to a vessel, such as a small cup, which feeds the measurement drain. The cup fills with perfusion solution, and excess blood overflows the cup and is directed to the main drain and thus to the reservoir pool. In this embodiment, the cup performs a function similar to that of wall 6108 in the embodiment described above by forming a small pool of perfusion solution from which bubbles can dissipate before the perfusion solution flows into the measurement drain on its way to the oxygen sensor.

Lungs 3704 are supported by support surface 6110. The surface is designed to support lungs 3704 without applying undue pressure, while angling lungs 3704 slightly downwards towards the lower lobes to promote easy drainage of the perfusion solution. Support surface includes drainage channels 6112 to collect and channel perfusion solution issuing from lungs 3704, and to guide the perfusion solution towards drain 6114, which feeds perfusion solution directly to the blood pool for measurement drain 6104. To provide additional support for the lungs, lungs 3704 are wrapped with a polyurethane wrap (not shown) when placed on support surface 6110. The polyurethane wrap anchors lungs 3704, helps keep the lungs in a physiologic configuration, and prevents the bronchi from being kinked and limiting the total volume of inflation. The wrap provides a smooth surface for the exterior of the lung to interface with organ chamber 5504, reducing the risk of the chamber applying excessive pressure on any part of lungs 3704, which might cause undesirable hemorrhaging.

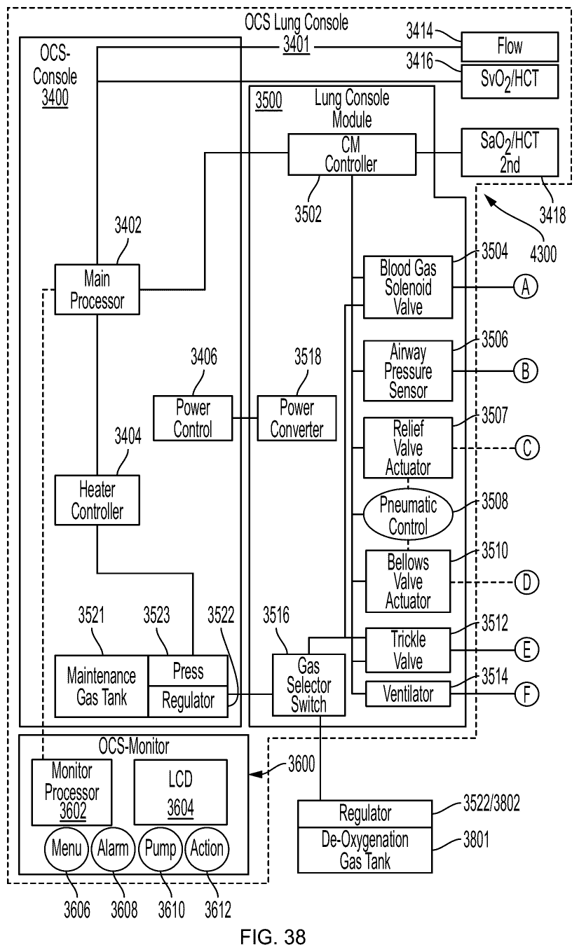

FIG. 38 is a schematic diagram of the described embodiment of a portable organ care system including the gas-related components of the lung perfusion module. The organ care system 3400 includes a permanent, multiple use, non-disposable section, OCS lung console 3401, and a single use disposable section, lung perfusion module 3700. The organ care system 3400 also includes a power control 3406, a power converter 3518, and a heat controller 3404. Regulator 3522/3802 converts the gas tank pressure to 25 mm Hg for use in the system. Internal maintenance gas tank 3521 contains a mixture that is designed to provide enough oxygen to maintain the lung tissue during maintenance mode. Pressure transducer 3523 measures the pressure of internal maintenance gas in tank 3521, so that the amount of gas remaining can be determined. Controller 3502 manages the release of maintenance and assessment gases by controlling the valves, gas selector switch 3516, and ventilator 3514, thus implementing the preservation of the lungs in maintenance mode, or the assessment of the lungs in one of the assessment modes. Blood gas solenoid valve 3504 controls the amount of gas flowing into blood gas exchanger 3702. Airway pressure sensor 3506 samples pressure in the airway of lungs 3704, as sensed through isolation membrane 3708. Relief valve actuator 3507 is pneumatically controlled, and controls relief valve 3712. The pneumatic control is carried out by inflating or deflating orifice restrictors that block or unblock the air pathway being controlled. This method of control allows complete isolation between the control systems in lung console module 3500 and the ventilation gas loop in lung perfusion module 3700. Pneumatic control 208 controls relief valve 3507 and bellows valve actuator 3510. Trickle valve 3512 controls delivery of gas to the airway of lungs 3704. Ventilator 3514 is a mechanical device with an actuator arm that causes bellows 3718 to contract and expand, which causes inhalation and exhalation of gas into and out of lungs 3704. OCS monitor 3600 provides user control of OCS 3400 via buttons, and displays data from the system's sensors that indicate the state of the lungs and of the various subsystems within OCS 3400. Monitor 3600 is universal, i.e., it can be used for any organ. It includes monitor processor 3602 that runs the software controlling monitor 3600 and displays data on LCD 3604. OCS monitor 3600 includes four control buttons for the user: menu button 3606 brings up the configuration menu; alarm button 3608 silences the speaker; pump button 3610 controls the circulatory pump; and action button 3612 provides access to certain organ-specific actions, such as ventilator control, or to system actions, such as saving a session file to an external memory card. Other controls can also be included, such as a knob for controlling a value or selecting an item.

Exemplary Lung Organ Care System without Gas Exchange Device

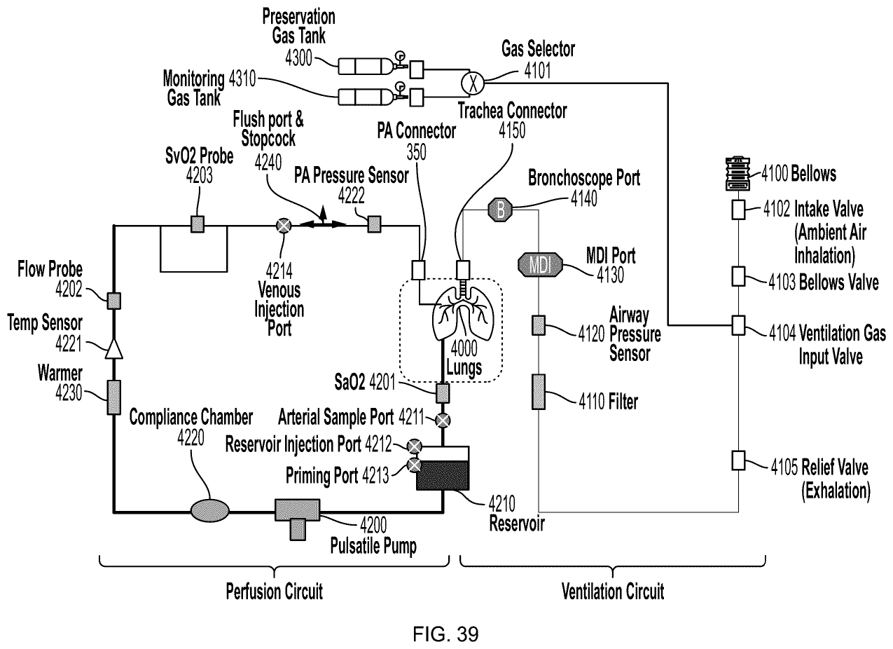

In some embodiments, a lung perfusion system without a gas exchange device is used to perfuse a lung. FIG. 39 provides a schematic diagram of the perfusion circuit and the ventilation circuit of an ex-vivo lung perfusion system. The perfusion and ventilation circuits described herein can be used with any suitable lung perfusion module that houses at least one ex-vivo lung and can be configured to connect with the rest of the system. Exemplary ex-vivo lung perfusion systems include those described in e.g., U.S. Patent Publication No. 2008/0017194, U.S. Patent Publication No. 2009/0197325, U.S. Application Ser. No. 63/795,157, the contents of which are hereby incorporated by reference in their entireties.

The ex-vivo lung perfusion systems disclosed herein can be used for maintaining an ex-vivo lung in a stable condition to allow the lung to be preserved for an extended period of time. In some embodiments, the lung can be maintained according to the maintenance mode described in U.S. Patent Publication No. 2009/0197325. For example, in the maintenance mode described in U.S. Patent Publication No. 2009/0197325, the lungs are ventilated with a gas (e.g., a preservation gas) containing oxygen to meet the lung's metabolic demands as well as carbon dioxide to control the pH of the perfusion fluid. The preservation gas used to ventilate the lungs in maintenance mode may comprise 21% oxygen, 5.5% CO₂, and 73.5% nitrogen. The lungs are ventilated by flowing a captive volume of gas back and forth between the lungs and a bellows, and excess gas is relieved from the circuit to maintain the desired gas pressure in the system. The ex-vivo lung perfusion systems can also be used to assess the health of a lung for transplantation using a functional monitoring mode, which is described in further detail below.

An advantage of the perfusion system disclosed herein is that it does not include a gas exchange device for altering the gas content of the perfusion fluid. Existing ex-vivo lung perfusion systems include a gas exchanger to supplement the function of the lungs and alter the perfusion fluid gas content, e.g., during assessment modes. However, gas exchange devices are expensive. Including a gas exchange device also increases manufacturing costs and complexity of the circuit. In the embodiments described herein, the system can alter the gas content of the perfusion fluid through the lungs and the ventilation circuit, which helps to reduce costs while maintaining the functionality of the perfusion system. Removing the gas exchange device also reduces the amount of foreign material in contact with the perfusion fluid, which may have a positive impact on the potential for hemolysis, especially for extended perfusion times.

### Perfusion Circuit

The perfusion circuit circulates perfusion fluid through the ex-vivo lung's vascular system. The perfusion circuit is not modified when switching between perfusion mode and assessment mode. In a preferred embodiment, the perfusion fluid enters the lung via a cannula inserted into the lung's pulmonary artery (“PA”) and exits the lung from the left atrial (“LA”) interface. A pump 4100, in some preferred embodiments a pulsatile pump, causes perfusion fluid to flow around the circuit. The pump 4100 receives perfusion fluid from a reservoir 4210 and pumps the perfusion fluid through the compliance chamber 4220 to the warmer 4230. In a preferred embodiment, the circuit includes a compliance chamber 4220, which is a flexible portion of tubing that serves to mitigate any pulsatile flow characteristics. The warmer 4230 replaces heat lost by the perfusion fluid to the environment during circulation of the fluid. The warmer can heat the perfusion fluid at or near physiologic temperatures, e.g., between about 30 °C to about 37 °C. Preferably, the warmer maintains the perfusion fluid at a temperature of about 30 °C.

After passing through the warmer 4230, the perfusion fluid flows directly through a temperature sensor 4221, a flow rate probe 4202, and a first perfusate oxygen probe 4203. The first perfusate oxygen probe 4203 measures the amount of oxygen in the perfusion fluid before it enters the lung. This oxygen amount is also referred to as SvO₂, since it is analogous to venous blood oxygen.

The perfusion circuit also includes a venous injection port 4214, which facilitates the removal of a perfusate sample or injection of a chemical before the perfusion fluid reaches the lungs. The perfusion fluid then flows through the flush port and stopcock 4240 and pulmonary artery (“PA”) pressure sensor 4222 before entering the lungs through a cannulated pulmonary artery.

After passing through the lungs, the perfusion fluid exits the lungs from the left atrial interface. The perfusion fluid then flows through a second perfusate oxygen probe 4201. The second perfusate oxygen probe 4201 measures the amount of oxygen in the perfusion fluid right after it drains from the lung. This amount is also referred to as SaO₂ and is analogous to arterial blood oxygen. Next, the perfusion fluid flows through an arterial sample port 4211, a reservoir injection port 4212, and a priming port 4213 before returning to the reservoir 4210.

### Ventilation Circuit

The ventilation circuit ventilates the lungs through the tracheal interface. In a preferred embodiment, the lung is ventilated by compressing a bellows 4100, which causes the flow of gas into the lung through a cannula inserted into the trachea. The bellows is regulated by the bellows valve 4103. The ventilation circuit also includes an intake valve 4102, which allows ambient air into the circuit when open, and a relief valve 4105, which allows excess gas to vent from the circuit to maintain a desired pressure level.

Furthermore, the ventilation circuit includes two gas sources, a preservation gas 4300 and a monitoring gas 4310, coupled with a gas selector 4101 to select the desired gas source. The preservation gas 4300 can be composed of 21% oxygen, 5.5% CO₂, and 73.5% nitrogen, while the monitoring gas 4310 can be composed of 6% CO₂ and 94% nitrogen. The circuit includes a ventilation gas input valve 4104 in fluid communication with the preservation gas 4300 and the monitoring gas 4310, which, when open, allows the gases to be injected into the remainder of the ventilation circuit.

The ventilation circuit also includes an airway pressure sensor 4120 for sampling the pressure in the airway of the lungs, a bronchoscope port 4140, and a metered dose inhaler (MDI) port 4130. The bronchoscope port 4140 allows endoscopic examination of the lung's airways, while the MDI port 4130 allows injection of drugs into the lungs. Lastly, the circuit includes a filter 4110 for filtering the gas before it reaches the lungs.

Optionally, in some embodiments, the lungs can be ventilated by applying a negative pressure to the exterior of the lungs while maintaining a positive pressure in the airway of the lung. This can be used in place of or in addition to using the bellows to ventilate the lung. For example, the lungs may be ventilated by applying a negative pressure according to the systems and methods described in U.S. Patent Publication No. 2020/0329699, the contents of which are hereby incorporated by reference in its entirety.

### Exemplary Liver Organ Care System (OCS)

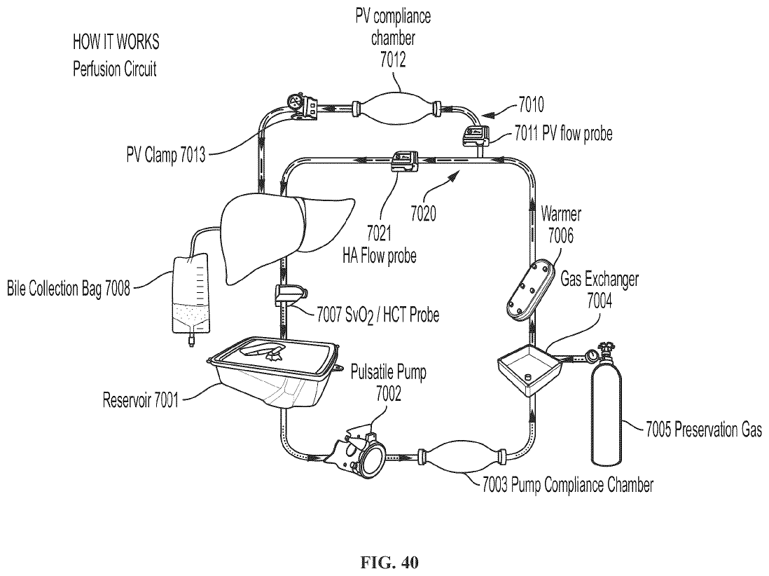

FIG. 40 depicts an illustrative diagram of an ex-vivo liver connected to exemplary components of an organ care system. In some embodiments, the perfusion fluid is driven from the reservoir 7001 by a pump (e.g., a pulsatile pump 7002) and then through a pump compliance chamber 7003 and a gas exchanger 7004. The gas exchanger 7004 can receive input gas from an external source (e.g., preservation gas 7005). In some embodiments, the gas exchanger 7004 is a standard membrane oxygenator, such as the interventional lung assist membrane ventilator from NOVALUNG or member of the Quadrox series from Maquet of Wayne, NJ. The perfusion fluid can then flow to the warmer 7006 to bring the perfusion fluid to at or near physiologic temperatures, e.g., between about 30 °C to about 37 °C. The perfusion fluid is then divided into branches 7010 and 7020. Branch 7010 is ultimately provided to the portal vein (PV) of the liver whereas branch 7020 is ultimately provided to the hepatic artery (HA) of the liver. The perfusion fluid is continuously monitored by the portal vein (PV) flow probe 7011 and hepatic artery (HA) flow probe 7021. In some embodiments, branch 7010 may also include a PV compliance chamber 7012 and/or a PV clamp 7013. The perfusion fluid exits the ex-vivo liver and returns to the reservoir 7001 to complete the circuit. After exiting the liver, the perfusion fluid may pass through a SvO₂/HCT probe 7007, which measures the venous oxygen saturation and hematocrit in the perfusion fluid leaving the liver. Bile produced by the liver may be collected in a bile collection bag 7008.

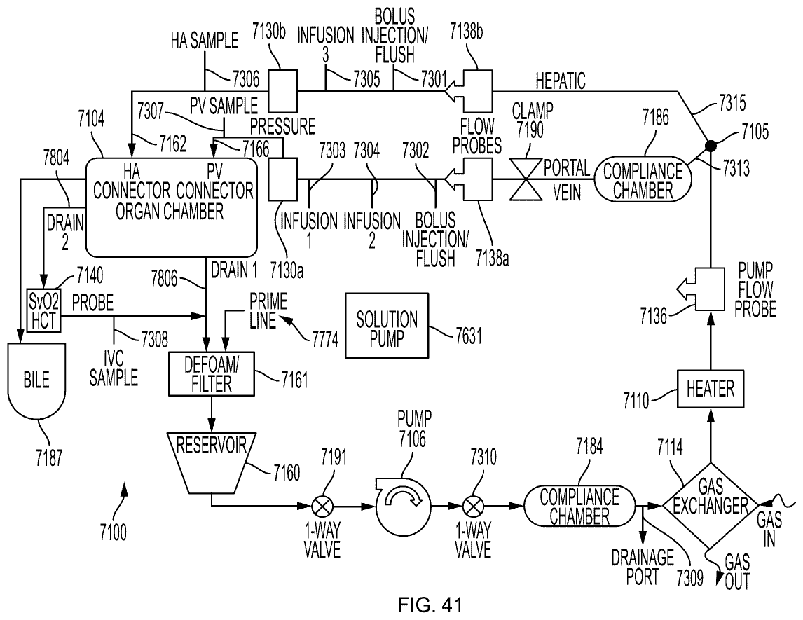

FIG. 41 illustrates an exemplary embodiment of a perfusion set 7100, which can be used to circulate the perfusion fluid containing a PDE3 inhibitor. U.S. application Ser. No. 18/402,476 (U.S. Patent Pub. No. 2024/0292831 A1) include exemplary embodiments of liver perfusion sets and is incorporated in its entirety by reference. The perfusion set 7100 can include a reservoir 7160, a one-way valve 7191, a pump 7106, a one-way valve 7310, compliance chambers 7184, 7186, a gas exchanger 7114, a heater 7110, flow meters 7136, 7138a, 7138b, a divider 7105, a flow clamp 7190, pressure sensors 7130a, 7130b, organ chamber 7104, a sensor 7140, defoamer/filter 7161, and tubing/interfaces to connect the same. In some embodiments, solution pump 7631 provides a maintenance solution to the perfusion fluid. The liver can also be connected to a bag 7187 the collects bile produced therefrom. In some embodiments, interface 7162 can be cannulated to vascular tissue of the hepatic artery via a conduit located within the organ chamber assembly. In some embodiments, interface 7166 can be cannulated to vascular tissue of the portal vein via a conduit located within the organ chamber assembly. In some embodiments, the perfusion set 7100 is contained entirely within the single-use module 7634, although this is not required. In some embodiments, the inferior vena cava (IVC) is cannulated so that flow from the IVC can be directed to a conduit in which the IVC pressure, flow, and oxygen saturation can be measured. In other embodiments, the IVC is not cannulated and perfusate flows freely from the IVC into the organ chamber 7104 (and ultimately into the drain(s) in the organ chamber 7104). In some embodiments, the perfusion set 7100 can include ports 7301, 7302, 7303, 7304, 7305, 7306, 7307, 7308, 7309. In some embodiments, the perfusion set 7100 can include a tube 7774 for loading priming solution and the exsanguinated blood from the donor or blood products from a blood bank into the reservoir 7160.

In one embodiment, perfusion fluid flows from the reservoir 7160 to valve 7191 and then to the pump 7106. After pump 7106, the perfusion can flow to one-way valve 7310 to compliance chamber 7184. After compliance chamber 7184, the perfusion fluid can flow to the gas exchanger 7114 and on to the heater 7110. After the heater 7110, the perfusion fluid can flow to the flow meter 7136, which is configured to measure the flow rate at that part of the perfusion circuit. After the flow meter 7136, the perfusion fluid flows to the divider 7105, which can divide the flow of the perfusion fluid into branches 7313 and 7315. In some embodiments, the divider 7105 can split the flow between the hepatic artery and the portal vein at a ratio of between 1:2 and 1:3. Branch 7313 is ultimately provided to the portal vein of the liver whereas branch 7315 is ultimately provided to the hepatic artery of the liver. The branch 7313 can include flow meter 7138a and the compliance chamber 7186 which provides perfusion fluid to the flow clamp 7190. From the flow clamp 7190, the perfusion fluid can flow to the pressure sensor 7130a before being provided to the portal vein of the liver. The branch 7315 can include a flow meter 7138b which provides perfusion fluid to the pressure meter 7130b before being provided to the hepatic artery of the liver. After perfusion fluid exits the liver, some of the perfusion fluid is collected by the measurement drain 7804 and the remainder is collected by the main drain 7806. The perfusion fluid collected by the measurement drain 7804 can be provided to the sensor 7140. Perfusion fluid exiting the sensor 7140 can be provided to the defoamer/filter 7161. The perfusion fluid collected by the drain 7806 can be provided directly to the defoamer/filter 7161. Perfusion fluid exiting the defoamer/filter 7161 can be provided to the reservoir 7160. Additionally, bile produced by the liver can be collected in a bag 7187.

In some embodiments, the system 7100 has at least 1.6 L of perfusion fluid (or other fluid) in it when operating. In some embodiments, the perfusion fluid contains a PDE3 inhibitor.

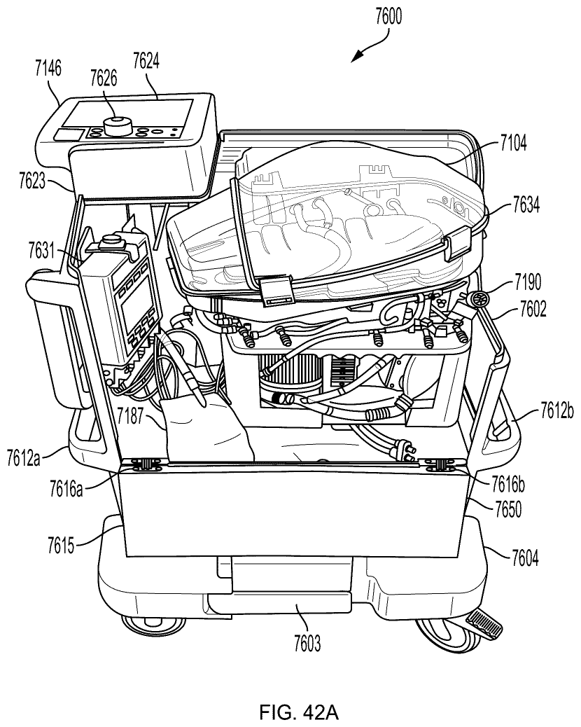

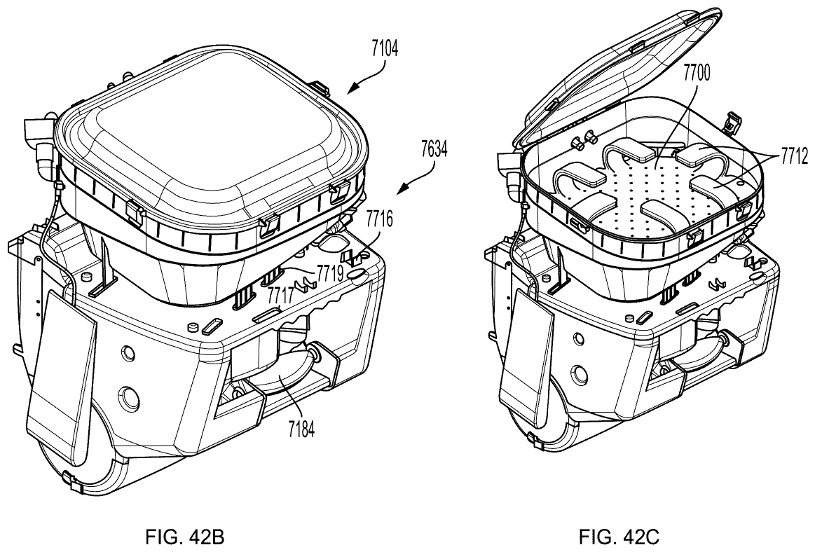

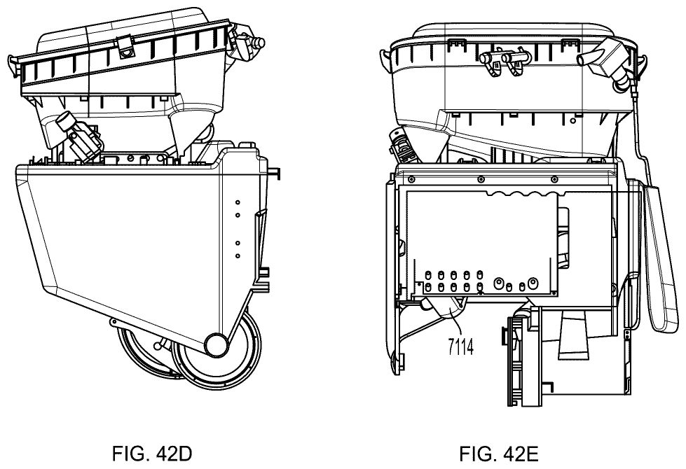

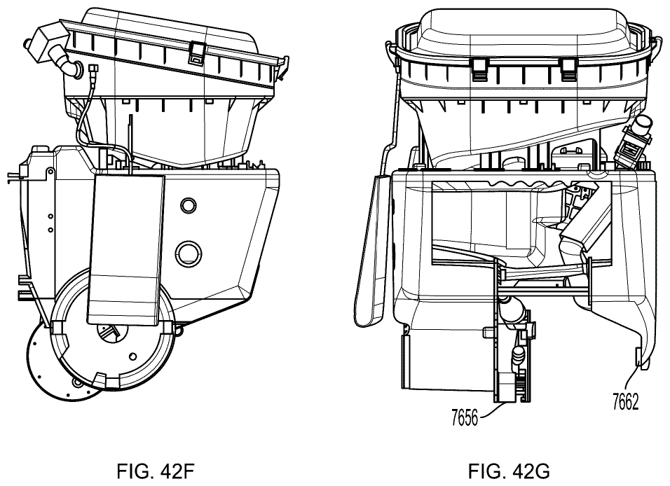

Referring to FIG. 42A, the Organ Care System 7600 can be configured to supply perfusion solution containing a PDE3 inhibitor to the liver in a manner that simulates the human body (e.g., the proper pressures, volumes, and pulsatile flows) using a single pump. For example, in a normal flow mode, the Organ Care System 7600 can circulate the perfusion fluid to the liver in the same manner as blood would circulate in the human body. More particularly, the perfusion fluid enters the liver through the hepatic artery and the portal vein and flows away from the liver via the IVC. In normal flow mode, the system 7100 pumps the perfusion fluid to the liver at a near physiological rate of between about 1-3 L/min, although in some embodiments the range can be 1.1-1.75 L/min (although the system can also be configured to provide flow rates outside of this range, e.g., 0-10 L/min). Each of the foregoing numbers is the total flow per minute provided to the hepatic artery and portal vein. U.S. application Ser. No. 18/402,476 (U.S. Patent Pub. No. 2024/0292831), incorporated by reference in its entirety, include exemplary embodiments of Organ Care Systems that can be configured to supply perfusion solution containing a PDE3 inhibitor to the liver.

FIG. 42A shows an exemplary organ care system 7600. In some embodiments, the organ care system 600 can be divided into two parts: a disposable single-use portion (e.g., 7634) and a non-disposable multiple-use portion (e.g., 7650) (also referred to herein as a single-use module and a multiple-use module). In some embodiments, the organ care system 7600 can include a housing 7602 and a cart 7604. A latch 7603 can secure the housing 7602 to the cart 7604. To further aid in portability, the system 7600 can also include a handle hinge mounted to the left side of the housing 7602, along with two rigidly mounted handles 7612a and 7612b mounted on the left and right sides of the housing 7602. The housing 7602 can further include a removable top lid (not shown) and a front panel 7615 hinged to a lower panel by hinges 7616a and 7616b. The cover can include handles for aiding with removal.

In some embodiments the system 7600 can include an operator interface module 7146, which can include a display 7624 for displaying information to an operator. In some embodiments, the operator interface module 7146 can include its own battery and may be removed from the cradle 7623 and used in a wireless mode. The operator interface module 7146 can also include a rotatable and depressible knob 7626 for selecting between multiple parameters and display screens.

FIGS. 42B-G show an exemplary single-use module 7634 with an alternatively shaped organ chamber 7104. Note, however, in some of the views certain components have been omitted to clarify the drawings (e.g., some of the tubing connectors, ports, and/or clamps have been omitted).

The single-use module 7634 can include a chassis having upper and lower sections. The upper section can include a platform for supporting various components. The lower section can support the platform and can include structures for pivotably connecting with the multiple-use module 7650.

The lower chassis section can include a C-shaped mount 7656 for rigidly mounting the perfusion fluid pump interface assembly, and the projection 7662 for sliding into and snap fitting with the slot. In some embodiments, the lower chassis section can also provide structures for mounting parts of the perfusion circuit including the following components: gas exchanger 7114, heater assembly 7110, reservoir 7160, perfusate flow compliance chambers 7184, 7186. In some embodiments, the lower chassis section can also contain, via appropriate mounting hardware, various sensors such as the sensor 7140, the flow rate sensors 7136, 7138a, 7138b, and the pressure sensors 7130a, 7130b. The lower chassis section can also mount the front-end circuit board. This embodiment is exemplary only, and components listed above as being part of the lower chassis section 7750b can be located elsewhere such as in the upper section (e.g., the pressure sensors 7130a, 7130b).

The upper chassis section can include the platform. The platform can include handles formed therein to assist in installing and removing the single-use module 7634 from the multiple-use module 7650, although the handles can be located elsewhere in the single-use module 7634. The platform can include one or more orifices (e.g., 7717) to allow tubing and/or other components to pass therethrough. The platform can also include one or more integrally formed brackets (e.g., 7716) to hold components in place atop the platform, such as the fluid injection and/or sampling ports described more fully below. The upper chassis section can also include a flow clamp 7190 for regulating the flow of perfusion fluid to the portal vein, as described more fully below. The organ chamber assembly 7104 can be configured to mount to the platform via one or more supports 7719.

In some embodiments, the organ chamber assembly 7104 includes a support surface 7700, which can be flexible material that supports and cushions the organ. In this or other embodiments, the support 7700 is a layer of materials, including a top layer and a bottom layer of a compliant material and an inner layer that is a frame of malleable metal substrate (e.g., aluminum). In some embodiments, the malleable metal frame extends into projections 7712.

### Exemplary Kidney Organ Care System (OCS)

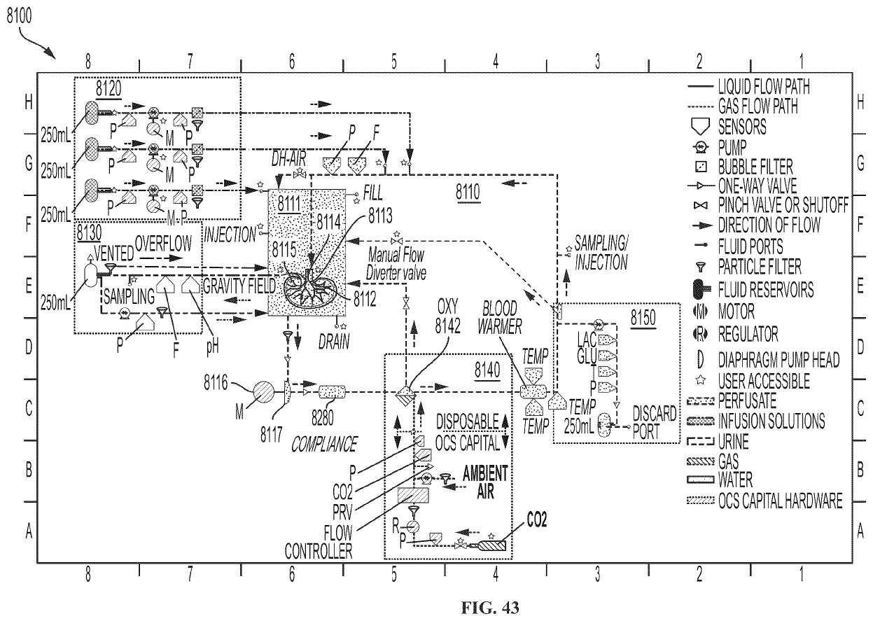

FIG. 43 depicts a schematic diagram of an organ care system OCS Kidney 8100. The OCS Kidney 8100 comprises a perfusion circuit 8110, an infusion subsystem 8120, a urine management system 8130, a gas management system 8140, and a biosensing subsystem 8150. U.S. Application Ser. No. 63/965,179 includes exemplary embodiments of kidney perfusion circuits and is incorporated in its entirety by reference.

The gas management system 8140 of the OCS Kidney mixes room air (or ambient air) with CO₂ from a gas cylinder. The infusion subsystem 120 contains multiple containers (e.g., three as shown in FIG. 43) to supply nutrients to the perfusion circuit, such as additional perfusion fluid, nutrient, and medicines. The urine management system 8130 collects urine from the ureter 8115 of the kidney 8112. The urine is tested, filtered, and recirculated back to the perfusion fluid in some embodiments.

The perfusion circuit 8110 of the OCS Kidney 8100 comprises an organ chamber 8111 for containing the harvested kidney. A pump circulates the perfusion fluid continuously through the perfusion circuit including the kidney contained in the organ chamber 8111. The pump comprises a motor 8116 and a pump head 8117 actuated by the motor 8116. The perfusion fluid exchanges gas (e.g., O₂ and/or CO₂) with the gas management system 8140 through an oxygenator 8142. The perfusion fluid then passes through a biosensing subsystem 8150 for monitoring the perfusion fluid properties. The infusion subsystem 8120 supplies nutrients, medicines, or additional perfusion fluid to the perfusion circuit before the perfusion fluid circulates back to the organ chamber 8111. The perfusion circuit is connected to the kidney 8112 by a cannulation device (not shown). In some embodiments, the perfusion fluid contains a PDE3 inhibitor.

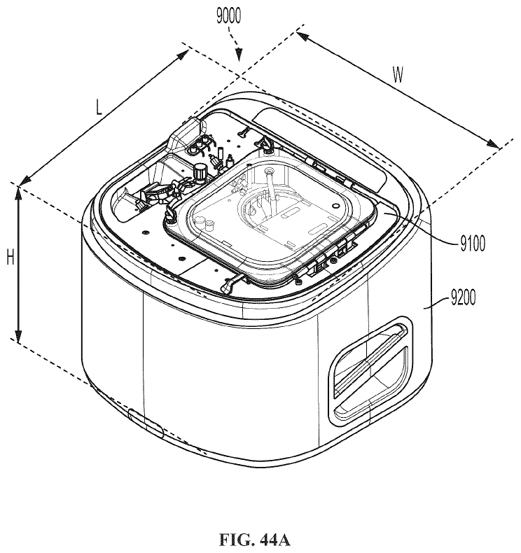

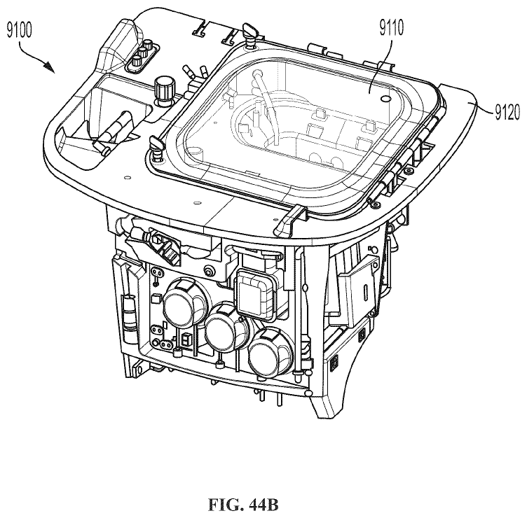

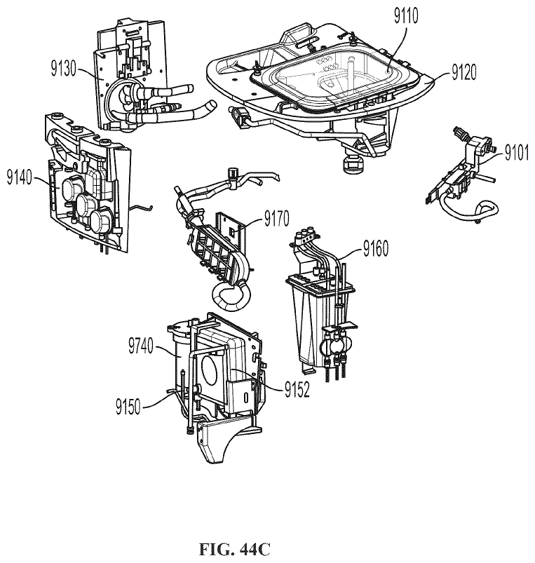

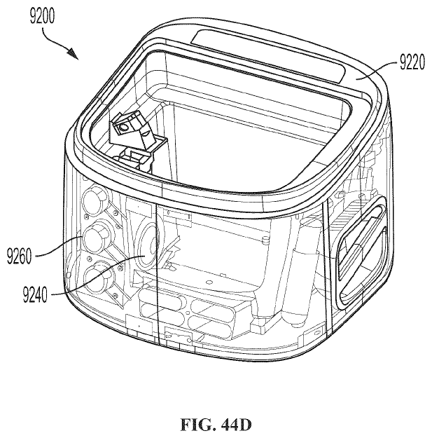

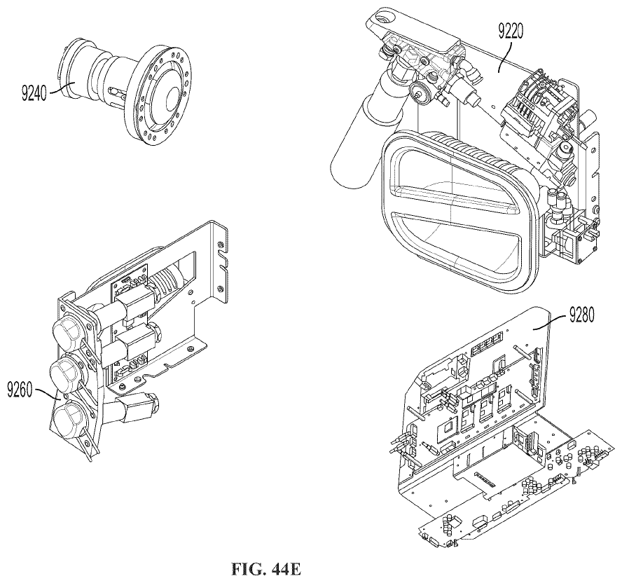

FIG. 44A shows an exterior appearance of an organ care system OCS Kidney 9000. The OCS Kidney comprises a console 9200 and a perfusion module 9100 mounted to console 9200. In some embodiments, a width W of the OCS Kidney 9000 is about 100 mm to about 800 mm, about 200 mm to about 600 mm, about 300 mm to about 500 mm, about 350 mm to about 450 mm, or any ranges therebetween. In one example, the width W of the OCS Kidney 9000 is about 395 mm. In some embodiments, a length L of the OCS Kidney 9000 is about 100 mm to about 800 mm, about 200 mm to about 600 mm, about 300 mm to about 500 mm, about 350 mm to about 400 mm, or any ranges therebetween. In one example, the length L of the OCS Kidney 9000 is about 365 mm. In some embodiments, a height H of the OCS Kidney 9000 is about 200 mm to about 600 mm, about 250 mm to about 500 mm, about 300 mm to about 400 mm, about 350 mm to about 400 mm, or any ranges therebetween. In one example, the height H of the OCS Kidney 9000 is about 365 mm. In one example, the width, length and height of the OCS Kidney 9000 is 395 mm, 395 mm, and 365 mm, respectively. In some embodiments, the width W equals length L.

FIGS. 44B and 44C illustrate the perfusion module 9100 and the components of the perfusion module 9100. The perfusion module 9100 comprises an organ chamber 9110 for containing an organ (e.g., kidney) during perfusion; a top deck assembly 9120 for securing the organ chamber 9110 in place when connected to the console 9200; a pump head assembly 9130 for circulating perfusion fluid through a perfusion circuit during perfusion; a front panel assembly 9140 for mounting tubing and sensors; a mid-plate assembly 9150 for mounting the oxygenator 9152 and the urine reservoir 9740; a solution delivery system 9160 for circulating the perfusion fluid; a sensor assembly 9101 for measuring urine properties; and a warmer assembly 9170 to keep the perfusion fluid at a desired temperature (e.g., about 37 °C).

FIGS. 44D and 44E illustrate the console 9200 and the components of the console 9200. The console 9200 comprises a gas management system 9220 for providing and balancing the oxygen (O₂) and carbon dioxide (CO₂) in the perfusion fluid; a pump actuator 9240 for modulating pump mechanism and controlling flow of the perfusion fluid; a solution distribution system module 9260; and a console chassis 9280 for electronics of the OCS Kidney.

FIGS. 43 to 44E are for illustrative purposes only and may not include all parts of the perfusion module 9100 and the console 9200. For example, the solution delivery system 9160 may further include one or more pump heads that are not illustrated in FIG. 44C. The parts of the perfusion module 9100 and the console 9200 mentioned above are explained in detail below.

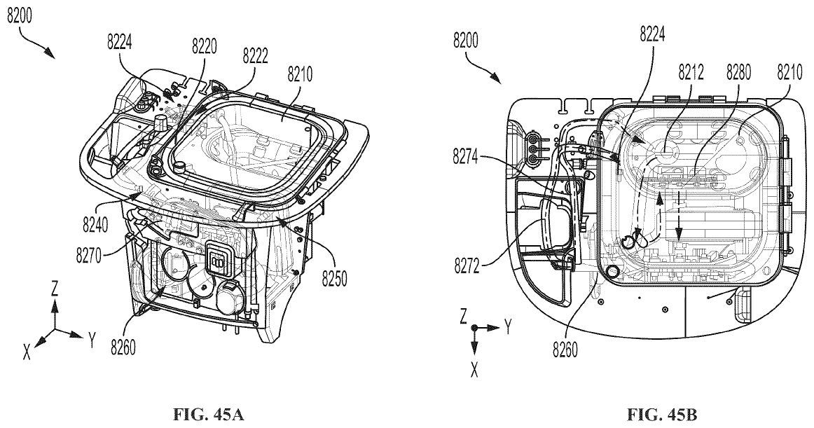

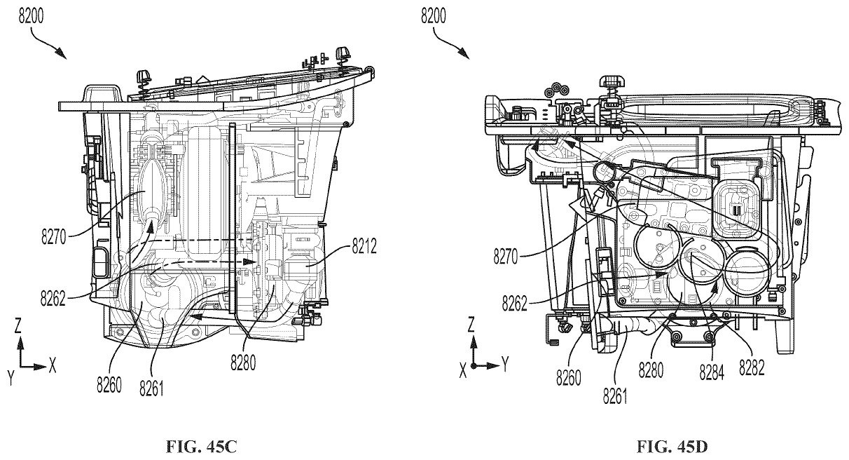

FIGS. 45A-45D illustrates the perfusion circuit of an OCS Kidney 8200. As shown in FIG. 45A, the perfusion circuit comprises an organ chamber 8210, a renal artery port 8220, a de-airing port 8222, a sample port 8224, a pump 8260, a blood warmer 8270, and an oxygenator 8250. In some embodiments, the perfusion circuit is used to perfuse a perfusion fluid containing a PDE3 inhibitor.

As shown in FIGS. 45B and 45C, a pump 8260 circulates the perfusion fluid from the harvested kidney through a ball valve 8212 at the bottom of the organ chamber 8210. The perfusion fluid flows into the pump 8260 from an inlet port 8261 at the bottom of the pump 8260 and flows out of the pump 8260 from an outlet port 8262 at the top of the pump 8260. In some embodiments, the pump is a dual-piston positive displacement pump. In some embodiments, the pump 8260 circulates the perfusion fluid in a pulsatile manner.

As shown in FIGS. 45C and 45D, the perfusion fluid enters a compliance chamber 8280 and flows therein through a path 8282 along a perimeter of the compliance chamber 8280 to reduce the pulsatility of the perfusion fluid. From the outlet 8284 of the compliance chamber 8280, the perfusion fluid flows into a blood warmer 8270. The blood warmer 8270 maintains the perfusion fluid at a suitable temperature for normothermic machine perfusion. In one example the blood warmer 8270 maintains the perfusion fluid at a temperature in a range of about 35 °C to about 38 °C.

Referring back to FIG. 45B, the blood warmer 8270 comprises a renal artery line 8272 for connecting to the perfusion circuit including the kidney; a bypass line 8274 separated from the renal artery line 8272; a biosensor line (not shown); and a sampling port 8224. In some embodiments, from an outlet 8272 of the blood warmer 8270, the perfusion fluid circles back to the harvested kidney contained in the organ chamber 8210. In some embodiments, the bypass line 8274 connects the perfusion fluid circuit directly to the ball valve 8212 at the bottom of the organ chamber 8210, bypassing the harvested kidney. The bypass line 8274 bypasses the kidney and is used for warming up the perfusion fluid during the conditioning of the perfusion circuit prior to receiving the harvested kidney.

### PDE3 Inhibitors for Ex-Vivo Organ Preservation

A PDE3 inhibitor can be administered to an ex-vivo organ to improve organ preservation using an ex-vivo organ care system.

Without intending to be bound by any theory, phosphordiesterase-3 (PDE3) inhibitors can modulate vascular tone and improve microcirculatory perfusion within the tissue of ex-vivo organ (e.g., heart, lung, liver, kidney). The PDE3 inhibitor can increase intracellular cyclic adenosine monophosphate (cAMP) levels, thereby promoting smooth muscle relaxation and vasodilation within arterial, venous, or microvascular structures of an ex-vivo organ (e.g., heart, lung, liver, kidney). The PDE3 inhibitor can improve oxygen and nutrient delivery by reducing vascular resistance and enhancing capillary flow. The PDE3 inhibitor can reduce ischemia-reperfusion injury by attenuating endothelial dysfunction and inflammatory signaling pathways. The PDE3 inhibitor can preserve organ function by mitigating edema formation, cellular hypoxia, or metabolic stress during ex-vivo perfusion. The PDE3 inhibitor can improve suitability of the organ for transplantation.

Without intending to be bound by any theory, phosphordiesterase-3 (PDE3) inhibitors improve the ex-vivo heart's ability to pump blood and improve contractility of the ex-vivo heart muscle by increasing cyclic adenosine monophosphate (cAMP). Besides its direct impact on heart function, increased cAMP may also prevent ischemia-reperfusion injury by reducing vascular resistance and improving microvascular permeability. PDE3 inhibitors can play a supportive role in improving the overall function of the ex-vivo heart (including following ischemic injury to the ex-vivo heart), which can help mitigate some of the damage and facilitate recovery.

Although milrinone and other PDE3 inhibitors have been used previously in-vivo for treatment of heart failure, reduced heart function or pulmonary hypertension, this use has been limited by the undesired effects of the PDE3/milrinone on the peripheral vascular system causing unwanted hemodynamic instability and significant vasoplegia. Prior applications of PDE3 inhibitors have been limited to low doses (e.g., administered at about 0.03 mg/min in a 75 kg person with kidney actively clearing 2-5% every minute, or about 0.025 mg/kg/hour), incapable of realizing the full benefits of functional improvement and reduction in ischemia-reperfusion injury. For the first time, described herein are systems and methods of using PDE3 inhibitors in ex-vivo organ care systems, including using PDE3 inhibitors in doses previously considered harmful to an organ such as the heart.

In embodiments described herein, a PDE3 inhibitor may be administered to an ex-vivo organ, such as a heart, a lung, a liver, or a kidney. It has been surprisingly discovered that the compositions described herein containing a PDE3 inhibitor improve ex-vivo organ preservation and overall functionality. It was unexpected that an ex-vivo organ would benefit from the administration of PDE3 inhibitors, especially at dosages that would be harmful for a patient if administered to an in-vivo organ.

In some embodiments, the compositions described herein containing a PDE3 inhibitor maintain or improve an ex-vivo heart's overall functionality. In some embodiments, the compositions described herein containing a PDE3 inhibitor better maintain or improve an ex-vivo heart's overall functionality compared to organ preservation methods without the use of a PDE3 inhibitor. In some embodiments, the compositions described herein containing a PDE3 inhibitor are used as inotropes for an ex-vivo heart. In some embodiments, the compositions described herein containing a PDE3 inhibitor maintain or increase the strength of heart muscles of an ex-vivo heart. In some embodiments, the compositions described herein containing a PDE3 inhibitor maintain or improve an ex-vivo heart's contractility.

In some embodiments, the compositions described herein containing a PDE3 inhibitor act as a vasodilator. In some embodiments, the compositions described herein containing a PDE3 inhibitor widen blood vessels, alleviating high perfusion pressure during ex-vivo perfusion. In some embodiments, the compositions described herein containing a PDE3 inhibitor reduce Pulmonary Vascular Resistance (PVR). In some embodiments, the compositions described herein containing a PDE3 inhibitor reduce pulmonary artery pressure. In some embodiments, the compositions described herein containing a PDE3 inhibitor reduce pulmonary capillary wedge pressure. In some embodiments, the compositions described herein containing a PDE3 inhibitor increase cardiac output.

In some embodiments, the compositions described herein containing a PDE3 inhibitor allow safe preservation of an ex-vivo heart for at least 30 minutes. In some embodiments, the compositions described herein containing a PDE3 inhibitor allow safe preservation of an ex-vivo heart for at least 1 hour. In some embodiments, the compositions described herein containing a PDE3 inhibitor allow safe preservation of an ex-vivo heart for at least 3 hours. In some embodiments, the compositions described herein containing a PDE3 inhibitor allow safe preservation of an ex-vivo heart for at least 6 hours. In some embodiments, the compositions described herein containing a PDE3 inhibitor allow safe preservation of an ex-vivo heart for at least 18 hours. In some embodiments, the compositions described herein containing a PDE3 inhibitor allow safe preservation of an ex-vivo heart for at least 24 hours.

In some embodiments, the compositions described herein containing a PDE3 inhibitor protect against ischemia-reperfusion injury. In some embodiments, the compositions described herein containing a PDE3 inhibitor treat ischemia-reperfusion injury.

In some embodiments, the compositions described herein containing a PDE3 inhibitor increase left ventricular pressure of an ex-vivo heart. In some embodiments, the compositions described herein containing a PDE3 inhibitor increase the dP/dt value (mmHg/s) of an ex-vivo heart. In some embodiments, the compositions described herein containing a PDE3 inhibitor decrease the Tau value (ms) of an ex-vivo heart. In some embodiments, the compositions described herein containing a PDE3 inhibitor provide a positive inotropic effect from direct myocardial stimulation.

In some embodiments, the PDE3 inhibitor is a compound that inhibits the action of an enzyme called phosphodiesterase type 3 (PDE3). In some embodiments, the administered PDE3 inhibitor inhibits the degradation of cyclic adenosine monophosphate (cAMP) and thereby increases the concentration of CAMP, which enhances myocardial contractility and promotes myocardial relaxation. In some embodiments, the PDE3 inhibitor is enoximone, milrinone (Primacor), amrinone/inamrinone, cilostamide, cilostazol (Pletal), anagrelide, trequinsin, or pharmaceutically acceptable salts thereof. In one embodiment, the PDE3 inhibitor is milrinone or a pharmaceutically acceptable salt thereof. In another embodiment, the PDE3 inhibitor is 6-methyl-2-oxo-5-pyridin-4-yl-1H-pyridine-3-carbonitrile. In some embodiments, the PDE3 inhibitor has the following chemical structure:

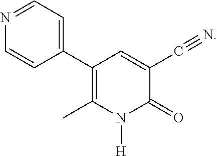 [SMILES: Cc1[nH]c(=O)c(C#N)cc1-c1ccncc1]

In some embodiments, the PDE3 inhibitor is added in one or more of fluids/solution 108, 116 and/or 118 in an ex-vivo organ care system. In some embodiments, the PDE3 inhibitor is used in a priming solution, a perfusion solution (e.g., perfusion fluid 108), a nutritional/compound supplement solution, a preservative solution, a maintenance solution, or a combination thereof. In some embodiments, a PDE3 inhibitor is included in a solution that is infused into a perfusion fluid during perfusion of an ex-vivo organ (e.g., heart, lung, liver, kidney) connected to an ex-vivo organ care system. In some embodiments, the PDE3 inhibitor (e.g., milrinone) is added to a priming solution prior to instrumenting the organ (e.g., a heart) to an organ care system. In some embodiments, the PDE3 inhibitor (e.g., milrinone) is added to a perfusion solution (e.g., perfusion fluid 108) prior to instrumenting the organ (e.g., a heart) to an organ care system. In some embodiments, the PDE3 inhibitor (e.g., milrinone) is infused into a perfusion solution (e.g., perfusion fluid 108) after instrumenting the organ (e.g., a heart) to an organ care system.

In some embodiments, a PDE3 inhibitor (e.g., milrinone) can be used in combination with one or more energy-rich components described above (e.g., glucose), with another PDE3 inhibitor, or with another pharmaceutical compound in one or more of fluids/solution 108, 116 and or 118 in an ex-vivo organ care system. In some embodiments, the PDE3 inhibitor is an inhibitor of PDE3A, PDE3B, or both. In some embodiments, the PDE3 inhibitor is enoximone, milrinone (Primacor), amrinone/inamrinone, cilostamide, cilostazol (Pletal), anagrelide, trequinsin, their pharmaceutically acceptable salts, or combinations thereof. In some embodiments, the PDE3 inhibitor is used in fluids/solution 108, 116, and/or 118 in combination with glucose, lactate, one or more amino acids, glycogen, one or more fatty acids, phosphocreatine, and/or one or more triglycerides, or a combination thereof.

In some embodiments, a concentration of a PDE3 inhibitor in one or more solutions described herein (e.g., 108, 116, and/or 118) and/or the rate of infusion of any of the solutions described herein are selected such that a target blood level concentration of the PDE3 inhibitor in an ex-vivo organ (e.g., heart, lung, liver, kidney) is achieved. In some embodiments, the target blood level concentration is determined by assessing the physiological state of the organ, the metabolic uptake of the organ, and the amount of ischemic injury to the organ that occurred prior to ex-vivo perfusion. In some embodiments, the organ specific metabolic activity is monitored and balanced with the uptake of a PDE3 inhibitor. In some embodiments, one or more of the solutions containing a PDE3 inhibitor is filtered by the organ care system such that the PDE3 inhibitor needs to be replenished during perfusion. In some embodiments, the PDE3 inhibitor is replenished by infusing the PDE3 inhibitor into the perfusion fluid 108. For example, solutions 116 and/or 118 can be infused into the perfusion fluid 108.

In some embodiments, system 100 includes one or more PDE3 inhibitor sensors for measuring the levels in the blood of the PDE3 inhibitor (e.g., PDE3 inhibitor level in the perfusion fluid 108). For example, one or more PDE3 inhibitor sensors could be located at or near aorta interface 163 and/or at near pulmonary artery interface 166. For example, one or more PDE3 inhibitor sensors could be located at or near a pulmonary artery of a lung and/or at or near a pulmonary vein of a lung. For example, one or more PDE3 inhibitor sensors could be located at or near a hepatic artery of a liver and/or at or near a portal vein of a liver and/or at or near a hepatic vein of a liver. For example, one or more PDE3 inhibitor sensors could be located at or near a renal artery of a kidney and/or at or near a renal vein of a kidney. In some embodiments, the system includes a processor configured to receive one or more PDE3 inhibitor level measurements from the one or more PDE3 inhibitor sensors. In some embodiments, the PDE3 inhibitor level is measured using a standard blood chemistry analyzer. In some embodiments, the PDE3 inhibitor level is measured using a PDE3 inhibitor meter. In some embodiments, the PDE3 inhibitor meter is used to measure the PDE3 inhibitor level by accessing a part of the perfusion fluid, for example, by taking a sample of perfusion fluid from the reservoir.

In some embodiments, a dose of a PDE3 inhibitor (e.g., milrinone) administered to the organ (e.g., a heart, a lung, a liver, a kidney) is between about 0.01 mg per 100 g of organ tissue and about 1 mg per 100 g of organ tissue. In some embodiments, a dose of a PDE3 inhibitor (e.g., milrinone) administered to the organ (e.g., a heart, a lung, a liver, a kidney) is between about 0.05 mg per 100 g of organ tissue and about 1 mg per 100 g of organ tissue. In some embodiments, a dose of a PDE3 inhibitor (e.g., milrinone) administered to the organ (e.g., a heart, a lung, a liver, a kidney) is between about 0.1 mg per 100 g of organ tissue and about 1 mg per 100 g of organ tissue. In some embodiments, a dose of a PDE3 inhibitor (e.g., milrinone) administered to the organ (e.g., a heart, a lung, a liver, a kidney) is between about 0.2 mg per 100 g of organ tissue and about 1 mg per 100 g of organ tissue. In some embodiments, a dose of a PDE3 inhibitor (e.g., milrinone) administered to the organ (e.g., a heart, a lung, a liver, a kidney) is between about 0.3 mg per 100 g of organ tissue and about 1 mg per 100 g of organ tissue. In some embodiments, a dose of a PDE3 inhibitor (e.g., milrinone) administered to the organ (e.g., a heart, a lung, a liver, a kidney) is between about 0.3 mg per 100 g of organ tissue and about 1.5 mg per 100 g of organ tissue. In some embodiments, a dose of a PDE3 inhibitor (e.g., milrinone) administered to the organ (e.g., a heart, a lung, a liver, a kidney) is between about 0.3 mg per 100 g of organ tissue and about 3 mg per 100 g of organ tissue. In some embodiments, a dose of a PDE3 inhibitor (e.g., milrinone) administered to the organ (e.g., a heart, a lung, a liver, a kidney) is between about 0.3 mg per 100 g of organ tissue and about 5 mg per 100 g of organ tissue.

In some embodiments, a concentration of a PDE3 inhibitor in one or more solutions described herein (e.g., 108, 116, and/or 118) is between about 0.01 mg/L and about 1.5 mg/L. In some embodiments, a concentration of a PDE3 inhibitor in one or more solutions described herein (e.g., 108, 116, and/or 118) is between about 0.05 mg/L and about 1.5 mg/L. In some embodiments, a concentration of a PDE3 inhibitor in one or more solutions described herein (e.g., 108, 116, and/or 118) is between about 0.25 mg/L and about 1.5 mg/L. In some embodiments, a concentration of a PDE3 inhibitor in one or more solutions described herein (e.g., 108, 116, and/or 118) is between about 0.5 mg/L and about 1.5 mg/L. In some embodiments, a concentration of a PDE3 inhibitor in one or more solutions described herein (e.g., 108, 116, and/or 118) is between about 0.5 mg/L and about 3 mg/L. In some embodiments, a concentration of a PDE3 inhibitor in one or more solutions described herein (e.g., 108, 116, and/or 118) is between about 0.5 mg/L and about 5 mg/L. In some embodiments, a concentration of a PDE3 inhibitor in one or more solutions described herein (e.g., 108, 116, and/or 118) is about 1 mg/L.

In some embodiments, a solution that comprises a PDE3 inhibitor is infused into the perfusion circuit of an ex-vivo organ care system at an infusion rate between about 0.001 mg/min and about 0.015 mg/min. In some embodiments, a solution that comprises a PDE3 inhibitor is infused into the perfusion circuit of an ex-vivo organ care system at an infusion rate between about 0.005 mg/min and about 0.015 mg/min. In some embodiments, a solution that comprises a PDE3 inhibitor is infused into the perfusion circuit of an ex-vivo organ care system at an infusion rate between about 0.005 mg/min and about 0.03 mg/min. In some embodiments, a solution that comprises a PDE3 inhibitor is infused into the perfusion circuit of an ex-vivo organ care system at an infusion rate between about 0.005 mg/min and about 0.05 mg/min. In some embodiments, a solution that comprises a PDE3 inhibitor is infused into the perfusion circuit of an ex-vivo organ care system at an infusion rate between about 0.005 mg/min and about 0.1 mg/min.

In some embodiments, a solution that comprises a PDE3 inhibitor is infused into the perfusion circuit of an ex-vivo organ care system at an infusion rate between about 0.05 mL/hr and about 0.67 mL/hr. In some embodiments, a solution that comprises a PDE3 inhibitor is infused into the perfusion circuit of an ex-vivo organ care system at an infusion rate between about 0.1 mL/hr and about 0.67 mL/hr. In some embodiments, a solution that comprises a PDE3 inhibitor is infused into the perfusion circuit of an ex-vivo organ care system at an infusion rate between about 0.125 mL/hr and about 0.67 mL/hr. In some embodiments, a solution that comprises a PDE3 inhibitor is infused into the perfusion circuit of an ex-vivo organ care system at an infusion rate between about 0.125 mL/hr and about 0.75 mL/hr. In some embodiments, a solution that comprises a PDE3 inhibitor is infused into the perfusion circuit of an ex-vivo organ care system at an infusion rate between about 0.125 mL/hr and about 1 mL/hr.

In some embodiments, the target blood level concentration of a PDE3 inhibitor (e.g., milrinone) during perfusion or infusion of one or more solutions containing a PDE3 inhibitor is between about 0.01 mg/L and about 1.5 mg/L. In some embodiments, the target blood level concentration of a PDE3 inhibitor (e.g., milrinone) during perfusion or infusion of one or more solutions containing a PDE3 inhibitor is between about 0.05 mg/L and about 1.5 mg/L. In some embodiments, the target blood level concentration of a PDE3 inhibitor (e.g., milrinone) during perfusion or infusion of one or more solutions containing a PDE3 inhibitor is between about 0.25 mg/L and about 1.5 mg/L. In some embodiments, the target blood level concentration of a PDE3 inhibitor (e.g., milrinone) during perfusion or infusion of one or more solutions containing a PDE3 inhibitor is between about 0.5 mg/L and about 1.5 mg/L. In some embodiments, the target blood level concentration of a PDE3 inhibitor (e.g., milrinone) during perfusion or infusion of one or more solutions containing a PDE3 inhibitor is between about 0.75 mg/L and about 1.25 mg/L. In some embodiments, the target blood level concentration of a PDE3 inhibitor (e.g., milrinone) during perfusion or infusion of one or more solutions containing a PDE3 inhibitor is between about 0.5 mg/L and about 3 mg/L. In some embodiments, the target blood level concentration of a PDE3 inhibitor (e.g., milrinone) during perfusion or infusion of one or more solutions containing a PDE3 inhibitor is between about 0.5 mg/L and about 5 mg/L. In some embodiments, the target blood level concentration of a PDE3 inhibitor (e.g., milrinone) during perfusion or infusion of one or more solutions containing a PDE3 inhibitor is about 1 mg/L.

In some embodiments, the target mean aortic pressure (AOP) in an ex-vivo heart during infusion/perfusion of one or more solutions containing a PDE3 inhibitor (e.g., milrinone) is between about 25 mmHg and 100 mmHg. In some embodiments, the target AOP in an ex-vivo heart during infusion/perfusion of one or more solutions containing a PDE3 inhibitor (e.g., milrinone) is between about 30 mmHg and 60 mmHg. In some embodiments, the target AOP in an ex-vivo heart during infusion/perfusion of one or more solutions containing a PDE3 inhibitor (e.g., milrinone) is between about 20 mmHg and 40 mmHg. In some embodiments, the target AOP in an ex-vivo heart during infusion/perfusion of one or more solutions containing a PDE3 inhibitor (e.g., milrinone) is between about 10 mmHg and 40 mmHg. In some embodiments, the target AOP in an ex-vivo heart during infusion/perfusion of one or more solutions containing a PDE3 inhibitor (e.g., milrinone) is between about 10 mmHg and 30 mmHg. In some embodiments, the target AOP in an ex-vivo heart during infusion/perfusion of one or more solutions containing a PDE3 inhibitor (e.g., milrinone) is less than about 40 mmHg.

In some embodiments, the target coronary flow rate (CF) in an ex-vivo heart during infusion/perfusion of one or more solutions containing a PDE3 inhibitor (e.g., milrinone) is between about 100 mL/min and about 900 mL/min. In some embodiments, the target coronary flow rate (CF) in an ex-vivo heart during infusion/perfusion of one or more solutions containing a PDE3 inhibitor (e.g., milrinone) is between about 700 mL/min and about 900 mL/min. In some embodiments, the target coronary flow rate (CF) in an ex-vivo heart during infusion/perfusion of one or more solutions containing a PDE3 inhibitor (e.g., milrinone) is between about 200 mL/min and about 700 mL/min. In some embodiments, the target coronary flow rate (CF) in an ex-vivo heart during infusion/perfusion of one or more solutions containing a PDE3 inhibitor (e.g., milrinone) is between about 300 mL/min and about 600 mL/min. In some embodiments, the target coronary flow rate (CF) in an ex-vivo heart during infusion/perfusion of one or more solutions containing a PDE3 inhibitor (e.g., milrinone) is between about 400 mL/min and about 600 mL/min. In some embodiments, the target coronary flow rate (CF) in an ex-vivo heart during infusion/perfusion of one or more solutions containing a PDE3 inhibitor (e.g., milrinone) is between about 400 mL/min and about 500 mL/min.

In some embodiments, perfusion of an ex vivo organ (e.g., heart) using a perfusion fluid containing a PDE3 inhibitor (e.g., milrinone) increases the dP/dt max value (mmHg/s) of the organ compared to using a perfusion fluid that does not contain a PDE3 inhibitor. In some embodiments, the dP/dt max value of an ex vivo organ (e.g., heart) during perfusion with a PDE3 inhibitor (e.g., milrinone) is between about 1000 mmHg/s and about 4000 mmHg/s. In some embodiments, the dP/dt max value of an ex vivo organ (e.g., heart) during perfusion with a PDE3 inhibitor (e.g., milrinone) is between about 1250 mmHg/s and about 3000 mmHg/s. In some embodiments, the dP/dt max value of an ex vivo organ (e.g., heart) during perfusion with a PDE3 inhibitor (e.g., milrinone) is between about 1500 mmHg/s and about 3500 mmHg/s. In some embodiments, the dP/dt max value of an ex vivo organ (e.g., heart) during perfusion with a PDE3 inhibitor (e.g., milrinone) is between about 1500 mmHg/s and about 3000 mmHg/s. In some embodiments, the dP/dt max value of an ex vivo organ (e.g., heart) during perfusion with a PDE3 inhibitor (e.g., milrinone) is between about 1750 mmHg/s and about 3000 mmHg/s. In some embodiments, the dP/dt max value of an ex vivo organ (e.g., heart) during perfusion with a PDE3 inhibitor (e.g., milrinone) is between about 2000 mmHg/s and about 3000 mmHg/s. In some embodiments, the dP/dt max value of an ex vivo organ (e.g., heart) during perfusion with a PDE3 inhibitor (e.g., milrinone) is between about 2000 mmHg/s and about 3250 mmHg/s. In some embodiments, the dP/dt max value of an ex vivo organ (e.g., heart) during perfusion with a PDE3 inhibitor (e.g., milrinone) is between about 2000 mmHg/s and about 3500 mmHg/s. In some embodiments, the dP/dt max value of an ex vivo organ (e.g., heart) during perfusion with a PDE3 inhibitor (e.g., milrinone) is between about 2000 mmHg/s and about 3500 mmHg/s. In some embodiments, the dP/dt max value of an ex vivo organ (e.g., heart) during perfusion with a PDE3 inhibitor (e.g., milrinone) is between about 2000 mmHg/s and about 3750 mmHg/s. In some embodiments, the dP/dt max value of an ex vivo organ (e.g., heart) during perfusion with a PDE3 inhibitor (e.g., milrinone) is between about 2000 mmHg/s and about 4000 mmHg/s. In some embodiments, the above described dP/dt max values are obtained after 0.5 hours of perfusion, after 1 hour of perfusion, after 2 hours of perfusion, 3 hours of perfusion, after 6 hours of perfusion, after 18 hours of perfusion, and/or after 24 hours of perfusion.

In some embodiments, perfusion of an ex vivo organ (e.g., heart) using a perfusion fluid containing a PDE3 inhibitor (e.g., milrinone) decreases the Tau (t) value of the organ compared to using a perfusion fluid that does not contain a PDE3 inhibitor. In some embodiments, perfusion of an ex vivo organ (e.g., heart) using a perfusion fluid containing a PDE3 inhibitor (e.g., milrinone) results in a measured Tau value (ms) of between about 5 ms and about 60 ms. In some embodiments, perfusion of an ex vivo organ (e.g., heart) using a perfusion fluid containing a PDE3 inhibitor (e.g., milrinone) results in a measured Tau value (ms) of between about 10 ms and about 50 ms. In some embodiments, perfusion of an ex vivo organ (e.g., heart) using a perfusion fluid containing a PDE3 inhibitor (e.g., milrinone) results in a measured Tau value (ms) of between about 15 ms and about 40 ms. In some embodiments, perfusion of an ex vivo organ (e.g., heart) using a perfusion fluid containing a PDE3 inhibitor (e.g., milrinone) results in a measured Tau value (ms) of between about 20 ms and about 40 ms. In some embodiments, perfusion of an ex vivo organ (e.g., heart) using a perfusion fluid containing a PDE3 inhibitor (e.g., milrinone) results in a measured Tau value (ms) of between about 20 ms and about 50 ms. In some embodiments, perfusion of an ex vivo organ (e.g., heart) using a perfusion fluid containing a PDE3 inhibitor (e.g., milrinone) results in a measured Tau value (ms) of between about 20 ms and about 60 ms. In some embodiments, perfusion of an ex vivo organ (e.g., heart) using a perfusion fluid containing a PDE3 inhibitor (e.g., milrinone) results in a measured Tau value (ms) of between about 20 ms and about 70 ms. In some embodiments, perfusion of an ex vivo organ (e.g., heart) using a perfusion fluid containing a PDE3 inhibitor (e.g., milrinone) results in a measured Tau value (ms) of between about 20 ms and about 80 ms. In some embodiments, one or more of the above-described Tau values (ms) may be obtained after about 0.5 hours of perfusion, after about 1 hour of perfusion, after about 2 hours of perfusion, after about 3 hours of perfusion, after about 6 hours of perfusion, after about 18 hours of perfusion, and/or after about 24 hours of perfusion.

In some embodiments, the target pulmonary artery pressure (PAP) in an ex-vivo lung during infusion/perfusion of one or more solutions containing a PDE3 inhibitor is between about mmHg to about 100 mmHg. In some embodiments, the target pulmonary artery pressure (PAP) in an ex-vivo lung during infusion/perfusion of one or more solutions containing a PDE3 inhibitor is between about 5 mmHg to about 80 mmHg. In some embodiments, the target pulmonary artery pressure (PAP) in an ex-vivo lung during infusion/perfusion of one or more solutions containing a PDE3 inhibitor is between about 5 mmHg to about 60 mmHg. In some embodiments, the target pulmonary artery pressure (PAP) in an ex-vivo lung during infusion/perfusion of one or more solutions containing a a PDE3 inhibitor is between about 5 mmHg to about 40 mmHg. In some embodiments, the target pulmonary artery pressure (PAP) in an ex-vivo lung during infusion/perfusion of one or more solutions containing a a PDE3 inhibitor is between about 5 mmHg to about 20 mmHg. In some embodiments, the target pulmonary artery pressure (PAP) in an ex-vivo lung during infusion/perfusion of one or more solutions containing a a PDE3 inhibitor is less than about 20 mmHg.

In some embodiments, the oncotic pressure in an ex-vivo liver during infusion/perfusion of one or more solutions containing a PDE3 inhibitor is between about 5 mmHg to about 35 mmHg. In some embodiments, the oncotic pressure in an ex-vivo liver during infusion/perfusion of one or more solutions containing a PDE3 inhibitor is between about mmHg to about 25 mmHg. In some embodiments, the oncotic pressure in an ex-vivo liver during infusion/perfusion of one or more solutions containing a PDE3 inhibitor is between about mmHg to about 25 mmHg.

In some embodiments, the target pressure in a hepatic artery of an ex-vivo liver during infusion/perfusion of one or more solutions containing a PDE3 inhibitor is between about 25 mmHg to about 150 mmHg. In some embodiments, the target pressure in a hepatic artery of an ex-vivo liver during infusion/perfusion of one or more solutions containing a PDE3 inhibitor is between about 30 mmHg to about 140 mmHg. In some embodiments, the target pressure in a hepatic artery of an ex-vivo liver during infusion/perfusion of one or more solutions containing a PDE3 inhibitor is between about 35 mmHg to about 130 mmHg. In some embodiments, the target pressure in a hepatic artery of an ex-vivo liver during infusion/perfusion of one or more solutions containing a PDE3 inhibitor is between about 40 mmHg to about 120 mmHg. In some embodiments, the target pressure in a hepatic artery of an ex-vivo liver during infusion/perfusion of one or more solutions containing a PDE3 inhibitor is between about 50 mmHg to about 120 mmHg.

In some embodiments, the target pressure in a portal vein of an ex-vivo liver during infusion/perfusion of one or more solutions containing a PDE3 inhibitor is between about 1 mmHg to about 25 mmHg. In some embodiments, the target pressure in a portal vein of an ex-vivo liver during infusion/perfusion of one or more solutions containing a PDE3 inhibitor is between about 3 mmHg to about 20 mmHg. In some embodiments, the target pressure in a portal vein of an ex-vivo liver during infusion/perfusion of one or more solutions containing a PDE3 inhibitor is between about 5 mmHg to about 15 mmHg.

In some embodiments, the target pressure in a renal artery of an ex-vivo kidney during infusion/perfusion of one or more solutions containing a PDE3 inhibitor is between about 25 mmHg to about 150 mmHg. In some embodiments, the target pressure in a renal artery of an ex-vivo kidney during infusion/perfusion of one or more solutions containing a PDE3 inhibitor is between about 30 mmHg to about 140 mmHg. In some embodiments, the target pressure in a renal artery of an ex-vivo kidney during infusion/perfusion of one or more solutions containing a PDE3 inhibitor is between about 35 mmHg to about 130 mmHg. In some embodiments, the target pressure in a renal artery of an ex-vivo kidney during infusion/perfusion of one or more solutions containing a PDE3 inhibitor is between about 40 mmHg to about 120 mmHg. In some embodiments, the target pressure in a renal artery of an ex-vivo kidney during infusion/perfusion of one or more solutions containing a PDE3 inhibitor is between about 45 mmHg to about 110 mmHg. In some embodiments, the target pressure in a renal artery of an ex-vivo kidney during infusion/perfusion of one or more solutions containing a PDE3 inhibitor is between about 50 mmHg to about 100 mmHg. In some embodiments, the target pressure in a renal artery of an ex-vivo kidney during infusion/perfusion of one or more solutions containing a PDE3 inhibitor is between about 55 mmHg to about 90 mmHg. In some embodiments, the target pressure in a renal artery of an ex-vivo kidney during infusion/perfusion of one or more solutions containing a PDE3 inhibitor is between about 60 mmHg to about 80 mmHg.

In some embodiments, a fluid or solution (e.g., 108, 116, and/or 118) containing a PDE3 inhibitor (e.g., milrinone) is infused into the perfusion fluid of an organ care system either continuously or intermittently. In some embodiments, the PDE3 inhibitor is infused at different doses throughout perfusion. For example, the PDE3 inhibitor can be infused at a given dose for a period of time during perfusion and then the dose can be increased or decreased for a second period of time during perfusion. In some embodiments, the duration of the first period of time is 5% of the duration of the entire perfusion. In some embodiments, the duration of the first period of time is 10% of the duration of the entire perfusion. In some embodiments, the duration of the first period of time is 15% of the duration of the entire perfusion. In some embodiments, the duration of the first period of time is 20% of the duration of the entire perfusion. In some embodiments, the duration of the first period of time is 25% of the duration of the entire perfusion. In some embodiments, the duration of the first period of time is 30% of the duration of the entire perfusion. In some embodiments, the duration of the first period of time is 50% of the duration of the entire perfusion. In some embodiments, the duration of the first period of time is 75% of the duration of the entire perfusion. In some embodiments, the duration of the first period of time is 80% of the duration of the entire perfusion. In some embodiments, the duration of the first period of time is 90% of the duration of the entire perfusion. In some embodiments, the duration of the first period of time is 95% of the duration of the entire perfusion.

In some embodiments, two or more different doses of the PDE3 inhibitor can be infused into the perfusion fluid throughout the duration of organ perfusion. In some embodiments, the dose of the PDE3 inhibitor is about 0.5%, about 1%, about 2%, about 5%, about 10%, about 15%, about 20%, about 50%, about 75%, about 100%, about 125%, about 150%, about 175%, about 200%, about 300%, about 500%, or about 1000% of the initial dose during perfusion.

In some embodiments a PDE3 inhibitor is administered for a period of time comprising a first subperiod and a second subperiod, wherein a first dose of PDE3 inhibitor is administered during the first subperiod and a second dose of PDE3 inhibitor is administered during the second subperiod. In some embodiments, the first dose of PDE3 inhibitor is the same or higher than the second dose of PDE3 inhibitor. In some embodiments, the first dose of PDE3 inhibitor is the same or lower than the second dose of PDE3 inhibitor. In some embodiments, the duration of the first subperiod is the same or longer than the duration of the second subperiod. In some embodiments, the duration of the first subperiod is the same or shorter than the duration of the second subperiod.

In some embodiments, perfusion is maintained at a given dose of the PDE3 inhibitor and prior to the end of perfusion, a higher dose is infused prior to disconnecting the organ from the organ care system for transplantation into a recipient. In some embodiments, providing a higher dose of the PDE3 inhibitor immediately prior to disconnecting the organ from the organ care system can provide advantages to organ function to the recipient.

It has been surprisingly found that infusing a PDE3 inhibitor (e.g., milrinone) according to an intermittent infusion schedule as described herein improves organ function.

In some embodiments, a fluid or solution (e.g., 108, 116, and/or 118) containing a PDE3 inhibitor (e.g., milrinone) is filtered during the prefusion of the fluid or solution in an organ care system. In some embodiments, a fluid or solution (e.g., 108, 116, and/or 118) containing a PDE3 inhibitor (e.g., milrinone) is filtered at a filtration of about 0.1 mL/min to about 15 mL/min. In some embodiments, a fluid or solution (e.g., 108, 116, and/or 118) containing a PDE3 inhibitor (e.g., milrinone) is filtered at a filtration of about 0.5 mL/min to about 15 mL/min. In some embodiments, a fluid or solution (e.g., 108, 116, and/or 118) containing a PDE3 inhibitor (e.g., milrinone) is filtered at a filtration of about 1 mL/min to about 15 mL/min. In some embodiments, a fluid or solution (e.g., 108, 116, and/or 118) containing a PDE3 inhibitor (e.g., milrinone) is filtered at a filtration of about 5 mL/min to about 15 mL/min. In some embodiments, a fluid or solution (e.g., 108, 116, and/or 118) containing a PDE3 inhibitor (e.g., milrinone) is filtered at a filtration of about 5 mL/min to about 20 mL/min. In some embodiments, a fluid or solution (e.g., 108, 116, and/or 118) containing a PDE3 inhibitor (e.g., milrinone) is filtered at a filtration of about 5 mL/min to about 25 mL/min. In some embodiments, a fluid or solution (e.g., 108, 116, and/or 118) containing a PDE3 inhibitor (e.g., milrinone) is filtered at a filtration of about 5 mL/min to about 30 mL/min. In some embodiments, the filtration rate is taken into account to determine the amount of the PDE3 inhibitor that needs to be infused into the perfusion fluid in order to maintain a target dose/concentration of the PDE3 inhibitor supplied to to organ. For example, if the filtration rate is 10 mL/min, the perfusion fluid/solution will be losing 0.01 mg/min of the PDE3 inhibitor and the infusion of the PDE3 inhibitor can be maintained at that rate (i.e., infusing 0.01 mg/min of the PDE3 inhibitor during perfusion).

In some embodiments, the physiological state of an organ is monitored during infusion of a PDE3 inhibitor. For example, lactate can be used as a biomarker of healthy tissue in organ preservation during administration of a PDE3 inhibitor. In some embodiments, an ex-vivo organ (e.g., heart, liver, kidney) metabolizes lactate leading to lower lactate, which indicates better ex-vivo preservation. As described herein, if a V-A lactate differential has a negative (−) value, the venous blood (coronary sinus) has less lactate than the arterial blood, which indicates that the heart is metabolizing lactate and is a sign of adequate perfusion and oxygen delivery to the myocardial cells. In some embodiments, administering a PDE3 inhibitor (e.g., milrinone) during perfusion improves the heart's ability to metabolize lactate as determined by measuring lactate differentials. In some embodiments, administering a PDE3 inhibitor results in a negative lactate differential during perfusion. In some embodiments, administering a PDE3 inhibitor results in a zero value for the lactate differential during perfusion. In some embodiments, the lactate differential is consistently at a zero or negative value during administration of the PDE3 inhibitor.

In some embodiments, the target blood level concentration of lactate of an ex-vivo organ (e.g., heart, liver, kidney) during infusion of one or more solutions containing a PDE3 inhibitor (e.g., milrinone) is between 0.5 mmol/L and 7.0 mmol/L. In some embodiments, the target blood level concentration of lactate of an ex-vivo organ (e.g., heart, liver, kidney) during infusion of one or more solutions containing a PDE3 inhibitor (e.g., milrinone) is between 1.0 mmol/L and 5.0 mmol/L. In some embodiments, the target blood level concentration of lactate of an ex-vivo organ (e.g., heart, liver, kidney) during infusion of one or more solutions containing a PDE3 inhibitor (e.g., milrinone) is between 1.0 mmol/L and 3.0 mmol/L. In some embodiments, the target blood level concentration of lactate of an ex-vivo organ (e.g., heart, liver, kidney) during infusion of one or more solutions containing a PDE3 inhibitor (e.g., milrinone) is between 0.5 mmol/L and 3.0 mmol/L.

### EXAMPLES

### Example 1: Preclinical Evaluation of Ex-Vivo Organ Care Using PDE3 Inhibition

Porcine hearts were harvested and connected to the TransMedics ex-vivo Organ Care System (OSC) for 6 hours. Each heart was perfused using a normothermic, near-physiologic perfusion solution either containing milrinone “w/MIL”) or without milrinone (“w/out MIL”). The hemodynamics of each heart were evaluated before the heart was explanted (In-situ), and at 30-minutes (0030 PT) and at 6 hours (0600 PT) after perfusion began. Specifically, the dP/dt max (mmHg/s) and the Tau values (ms) were calculated.

dP/dt max is a hemodynamic parameter that reflects the maximum rate of change in pressure within the heart's ventricles during the isovolumic contraction phase of the cardiac cycle (i.e., pressure over time, for example, mmHg/s). It serves as an indicator of myocardial contractility, which represents the heart muscle's ability to generate force during systole. To measure the dP/dt max, a pressure loop catheter was inserted into the left ventricle of each heart to record ventricular pressure continuously throughout each cardiac cycle. The steepest slope of the pressure curve during each isovolumic contraction phase was identified, and the median value across a 20-second interval was recorded as the dP/dt max value in mmHg/second.

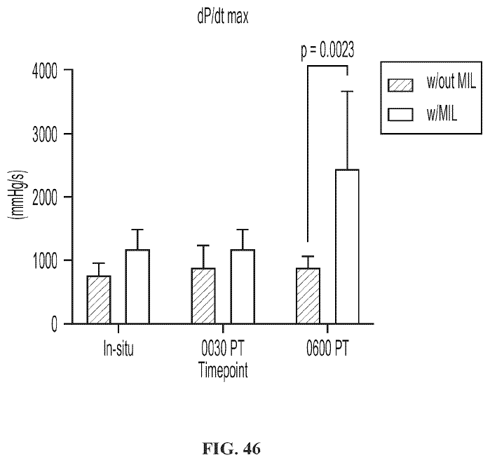

FIG. 46 shows the dP/dt max values (mmHg/s) for hearts that were perfused without a milrinone (“w/out MIL”) and with milrinone added into the perfusion fluid (“w/MIL”) at the start of perfusion, and at 30 minutes and at 6 hours of perfusion. There was a significant increase (p=0.023) in dP/dt max over 6 hours of preservation in the group using the next generation Organ Care System with milrinone (w/MIL). This shows that hearts using the next generation Organ Care System with milrinone added to the perfusion fluid demonstrated stronger myocardial contractility and a better ability to generate force during systole than those using the next generation Organ Care System without milrinone.

Tau value (τ) shows the time constant of the exponential decay of ventricular pressure during isovolumic relaxation. A lower Tau value indicates faster and better relaxation. To measure the Tau value, a pressure loop catheter was inserted into the left ventricle of each heart to record ventricular pressure continuously throughout each cardiac cycle. The pressure decay curve after the closure of the aortic valve is identified after each isovolumic relaxation phase of the cardiac cycle. The pressure decay curve was then fit to the following exponential function where P(t) is the pressure at time t during isovolumic relaxation, P₀ is the pressure at t=0 (start of relaxation), τ is Tau value (time constant of isovolumic relaxation), and P_{∞} is the asymptotic pressure.

$$P ( t ) = {P}_{0} \cdot {e}^{- \frac{t}{τ}} + {P}_{∞}$$

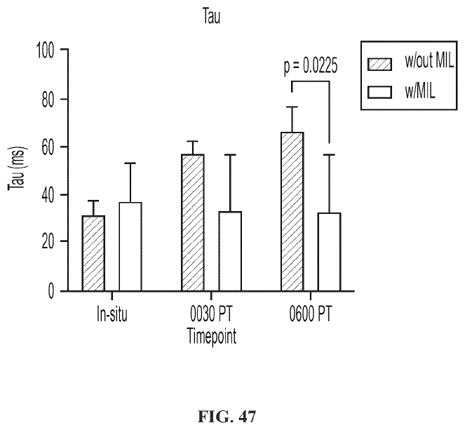

FIG. 47 shows the Tau values (ms) for hearts that were perfused without a milrinone (“w/out MIL”) and with milrinone added into the perfusion fluid (“w/MIL”) at the start of perfusion, and at 30 minutes and at 6 hours of perfusion. Tau measurements were significantly lower (p=0.0225) at 6 hours for the group that received milrinone (“w/MIL”) compared to the group that did not (“w/out MIL”). These results shows that hearts using the next generation Organ Care System with milrinone demonstrated quicker relaxation of the left ventricle during diastole. This suggests efficient ventricular filling, which indicates a sign of better diastolic function, where the heart relaxes and accommodates blood effectively between beats.

Overall, these results demonstrate that using a PDE3 inhibitor (e.g., milrinone) during ex-vivo organ care perfusion (e.g., using OCS) results in significantly improved myocardial contractility, better ability to generate force during systole, quicker relaxation of the left ventricle during diastole, and more efficient ventricular filling. The clinical implications of these findings include enhancing function of donation after brain death (DBD) and donation after circulatory death (DCD) hearts on OCS beyond preservation, safe preservation and broader access to national DBD and DCD donors, enabling morning hour heart transplant and better or time management, and driving significant growth of heart transplant to help patients in need.

It is to be understood that while the invention has been described in conjunction with the various illustrative embodiments, the foregoing description is intended to illustrate and not limit the scope of the invention, which is defined by the scope of the appended claims. For example, a variety of systems and/or methods may be implemented based on the disclosure and still fall within the scope of the invention. Other aspects, advantages, and modifications are within the scope of the following claims. All references cited herein are incorporated by reference in their entirety and made part of this application.

### REFERENCES

Colucci WS. Myocardial and vascular actions of milrinone. Eur Heart J. 1989 August; 10 Suppl C: 32-8. doi: 10.1093/eurheartj/10.suppl_c.32. PMID: 2680495.
Pamboukian SV, Carere RG, Webb JG, Cook RC, D′yachkova Y, Abel JG, Ignaszewski AP. The use of milrinone in pre-transplant assessment of patients with congestive heart failure and pulmonary hypertension. J Heart Lung Transplant. 1999 April; 18 (4): 367-71. doi: 10.1016/s1053-2498 (98) 00070-9. PMID: 10226902.
Rettig GF, Schieffer HJ. Acute effects of intravenous milrinone in heart failure. Eur Heart J. 1989 August; 10 Suppl C: 39-43. doi: 10.1093/eurheartj/10.suppl_c.39. PMID: 2680496.

What is claimed:

1. An organ care system comprising:
a perfusion circuit comprising:
a pump configured to pump a perfusion fluid through an ex-vivo organ;
a first interface configured to connect to a first vessel of the ex-vivo organ; and
a second interface configured to connect to a second vessel of the ex-vivo organ,
wherein the perfusion fluid comprises a phosphordiesterase-3 (PDE3) inhibitor.

2. The organ care system of claim 1, wherein the ex-vivo organ is an ex-vivo lung, an ex-vivo liver, or an ex-vivo kidney.

3. The organ care system of claim 1, wherein the PDE3 inhibitor is enoximone, milrinone, amrinone, cilostamide, cilostazol, anagrelide, trequinsin, an acid thereof, a salt thereof, or a combination thereof.

4. The organ care system of claim 1, wherein the PDE3 inhibitor is milrinone.

5. The organ care system of claim 1, wherein the perfusion fluid comprises the PDE3 inhibitor in an effect amount configured to maintain a concentration of the PDE3 inhibitor at between about 0.3 mg per 100 g of tissue of the ex-vivo organ and about 1 mg per 100 g of tissue of the ex-vivo organ.

6. The organ care system of claim 1, wherein a concentration of the PDE3 inhibitor in the perfusion fluid is between about 0.5 mg/L and about 1.5 mg/L.

7. The organ care system of claim 1, wherein the organ care system further comprises:
a first lactate sensor configured to measure a first lactate value at the first interface;
a second lactate sensor configured to measure a second lactate value at the second interface; and
a processor configured to:
calculate a lactate differential using the first lactate value and the second lactate value; and
obtain a plurality of lactate differentials by calculating the lactate differential at two different times,
wherein the organ care system is configured to use the plurality of lactate differentials to determine a suitability of the ex-vivo organ for transplantation.

8. The organ care system of claim 7, wherein the processor is configured to calculate the lactate differential by subtracting the first lactate value from the second lactate value.

9. The organ care system of claim 1, wherein the organ care system is configured to maintain a target blood level of the PDE3 inhibitor in the ex-vivo organ.

10. The organ care system of claim 9, wherein the target blood level of the PDE3 inhibitor is between about 0.25 mg/mL and about 1.5 mg/mL.

11. A method of perfusing an ex-vivo organ using an organ care system, the method comprising:
placing an ex-vivo organ in an organ chamber assembly;
connecting a first vessel of the ex-vivo organ to a first interface of a perfusion circuit;
connecting a second vessel of the ex-vivo organ to a second interface of a perfusion circuit;
pumping a perfusion fluid comprising a PDE3 inhibitor through the perfusion circuit.

12. The method of claim 11, wherein the ex-vivo organ is an ex-vivo lung, an ex-vivo liver, or an ex-vivo kidney.

13. The method of claim 11, wherein the PDE3 inhibitor is enoximone, milrinone, amrinone, cilostamide, cilostazol, anagrelide, trequinsin, an acid thereof, a salt thereof, or a combination thereof.

14. The method of claim 13, wherein the PDE3 inhibitor is milrinone.

15. The method of claim 11, wherein the perfusion fluid comprises the PDE3 inhibitor in an effect amount configured to maintain a concentration of the PDE3 inhibitor at between about 0.3 mg per 100 g of tissue of the ex-vivo organ and about 1 mg per 100 g of tissue of the ex-vivo organ.

16. The method of claim 11, wherein a concentration of the PDE3 inhibitor in the perfusion fluid is between about 0.5 mg/L and about 1.5 mg/L.

17. The method of claim 11, further comprising:
measuring a first lactate value using a first lactate sensor located at the first interface;
measuring a second lactate value using a second lactate sensor located at the second interface;
calculating, using a processor, a lactate differential based on the first lactate value and the second lactate value;
obtaining a plurality of lactate differentials by calculating the lactate differential at two different times; and
determining a suitability of the ex-vivo organ for transplantation using the plurality of lactate differentials.

18. The method of claim 11, wherein the organ care system is configured to maintain a target blood level of the PDE3 inhibitor in the ex-vivo organ.

19. The method of claim 18, wherein the target blood level of the PDE3 inhibitor is between about 0.5 mg/L and about 1.5 mg/L.

20. The method of claim 19, wherein the target blood level of the PDE3 inhibitor is between about 0.25 mg/mL and about 1.5 mg/mL.
